(19) United States
(12) Patent Application Publication
(10) Pub. No.: US 2010/0321927 A1
(43) Pub. Date: Dec. 23, 2010

(54) LAMP HOLDER, ILLUMINATING DEVICE, DISPLAY DEVICE, AND TELEVISION RECEIVER

(75) Inventor: Takahiro Yoshikawa, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/866,929

(22) PCT Filed: Feb. 2, 2009
(86) PCT No.: PCT/JP2009/051712

§ 371 Date: Aug. 10, 2010

(30) Foreign Application Priority Data
Feb. 27, 2008 (JP) 2008-046795

(51) Int. Cl. G02F 1/13357; F21V 19/00; G09F 13/04

(52) U.S. Cl. 362/97.2; 362/382; 362/97.1

(57) ABSTRACT

The present invention comprises: a main body 27 that is mounted on a chassis 14; a lamp gripping portion 28 that is provided in a main body 27 to be able to grip a cold-cathode tube 17; and mounting portions 30 and 31 that include base portions 30a and 31a projected from the main body 27 toward the side of the chassis 14 and extending portions 30b and 31b projected from the base portions 30a and 31a in the direction along the main body 27, the mounting portions 30 and 31 being slid in the direction along the main body 27 from the state in which the mounting portions 30 and 31 are inserted in mounting holes 32 and 33 provided in the chassis 14, thereby enabling the peripheral edge portions of the mounting holes 32 and 33 to be retained while sandwiched between the extending portions 30b and 31b and the main body 27, wherein a reinforcement portion 44 that continues to at least two of the main body 27 and the base portion 30a and extending portion 30b, which constitute the first mounting portion 30, is formed.

### TECHNICAL FIELD

The present invention relates to a lamp holder, an illuminating device, a display device, and a television receiver.

### BACKGROUND ART

For example, a liquid crystal panel that is used in liquid crystal display devices such as a liquid crystal television does not emit light by itself, and it is therefore necessary to separately provide a backlight device as an illuminating device. The backlight device is configured to be placed on the backside (side opposite to s display surface) of the liquid crystal panel. The backlight device includes a metal or resin chassis in which a surface on the liquid crystal panel side is opened, a plurality of fluorescent tubes (such as cold-cathode tubes) that are accommodated as the lamp in the chassis, a plurality of optical members (such as diffuser sheets) that are disposed in the opening portion of the chassis to efficiently send the light emitted from the cold-cathode tube onto the liquid crystal panel side, and a lamp clip that supports an intermediate portion of the elongated cold-cathode tube.

For example, a lamp clip disclosed in Patent Document 1 is well known as the lamp clip for use in the liquid crystal display device having the above-described configuration. The lamp clip disclosed in Patent Document 1 comprises a main body and a mounting portion for the chassis. The main body includes a lamp gripping portion that can grip the lamp. The mounting portion includes a base portion projected from the main body toward the chassis side and an extending portion projected from the base portion in a direction along the main body. In order to mount the lamp clip on the chassis, the lamp clip is slid while the mounting portion is inserted in amounting hole of the chassis. Therefore, a peripheral edge portion of the mounting hole is retained while sandwiched between the extending portion and the main body, thereby maintaining the lamp clip in the mounted state.

Patent Document 1: Japanese Patent Publication Laid-Open No. 2007-73527

### Problem to be Solved by the Invention

In mounting the lamp clip on the chassis, the mounting portion is not always smoothly inserted in the mounting hole, and possibly the mounting portion hits a wall surface of the chassis and the like. At this point, when an excessive force acts on the mounting portion, there is a risk of breakage of the mounting portion. In such cases, it is necessary to replace the lamp clip with new one. However, when a worker mounts the lamp clip on the chassis without noticing the breakage of the mounting portion, the liquid crystal display device is left while a retaining function of the lamp clip lacks or degrades. Therefore, the lamp cannot properly be retained by the lamp clip, which possibly results in a problem with display performance of the liquid crystal display device.

### DISCLOSURE OF THE INVENTION

The present invention has been accomplished in view of the foregoing, and an object of the invention is to make it difficult to break the mounting portion.

### Means for Solving the Problems

A lamp holder according to the present invention includes a main body, a lamp gripping portion, a mounting portion and a reinforcement portion. The main body is to be mounted to a mounting member. The lamp gripping portion is provided in the main body so as to grip a lamp. The mounting portion includes a base portion that projects from the main body toward a side corresponding to amounting member side and a extending portion that extends from the base portion in a direction along the main body. The mounting portion is configured to be inserted in the mounting hole provided in the mounting member such that an edge portion of the mounting hole is sandwiched between the extending portion and the main body when the lamp holder is slid in a direction along the main body. The reinforcement portion continues to at least two of the main body, the base portion, and the extending portion.

Therefore, the reinforcement of the mounting portion is achieved by the reinforcement portion that continues to at least two of the main body, the base portion and the extending portion. Accordingly, the breakage of the mounting portion is hardly generated even if the mounting portion interferes in another component such as the mounting member in association with the mounting of the lamp holder to the mounting member.

### BRIEF DESCRIPTION OF DRAWINGS

FIG. 1 is an exploded perspective view illustrating a schematic configuration of a television receiver according to a first embodiment of the invention.

FIG. 2 is an exploded perspective view illustrating a schematic configuration of a liquid crystal display device.

FIG. 3 is a sectional view illustrating a state in which the liquid crystal display device is cut along a short-side direction.

FIG. 4 is a sectional view illustrating a state in which the liquid crystal display device is cut along a long-side direction.

FIG. 5 is a plan view of a lamp clip.

FIG. 6 is a side view of the lamp clip.

FIG. 7 is a sectional view of the lamp clip taken along a line A-A of FIG. 6.

FIG. 8 is a plan view illustrating a state in which each lamp and each lamp clip are mounted on a chassis.

FIG. 9 is a plan view of the chassis.

FIG. 10 is an enlarged plan view of mounting holes in the chassis.

FIG. 11 is a sectional view taken along a line B-B of FIG. 6 and illustrating a state in which the lamp clip is mounted in the liquid crystal display device.

FIG. 12 is a sectional view taken along a line C-C of FIG. 6 and illustrating the state in which the lamp clip is mounted in the liquid crystal display device.

FIG. 13 is a sectional view taken along the line A-A of FIG. 6 and illustrating the state in which the lamp clip is mounted.

FIG. 14 is a sectional view taken along the line B-B of FIG. 6 and illustrating a state in which a main body is inclined in the process of mounting the lamp clip.

FIG. 15 is a sectional view taken along the line B-B of FIG. 6 and illustrating a state before the main body is slid in the process of mounting the lamp clip.

FIG. 16 is a sectional view taken along the line C-C of FIG. 6 and illustrating the state before the main body is slid in the process of mounting the lamp clip.

FIG. 17 is a sectional view taken along the line A-A of FIG. 6 and illustrating the state before the main body is slid in the process of mounting the lamp clip.

FIG. 18 is a front view of a lamp clip according to a second embodiment of the invention.

FIG. 19 is an enlarged plan view of mounting holes in a chassis.

FIG. 20 is a horizontal sectional view of a lamp clip according to a third embodiment of the invention.

FIG. 21 is a horizontal sectional view illustrating a state before a main body is slid in the process of mounting the lamp clip.

FIG. 22 is a horizontal sectional view illustrating a state in which the lamp clip is mounted.

FIG. 23 is a horizontal sectional view of a lamp clip according to a fourth embodiment of the invention.

FIG. 24 is a horizontal sectional view illustrating a state before a main body is slid in the process of mounting the lamp clip.

FIG. 25 is a horizontal sectional view illustrating a state in which the lamp clip is mounted.

FIG. 26 is a sectional view of a lamp clip according to a fifth embodiment of the invention.

FIG. 27 is an enlarged plan view of mounting holes in a chassis.

FIG. 28 is a sectional view illustrating a state before a main body is slid in the process of mounting the lamp clip.

FIG. 29 is a sectional view illustrating a state in which the lamp clip is mounted.

FIG. 30 is a front view of a lamp clip according to a sixth embodiment of the invention.

FIG. 31 is a bottom view of the lamp clip.

FIG. 32 is an enlarged plan view of mounting holes in a chassis.

FIG. 33 is a sectional view illustrating an operation to push the lamp clip in a first state into the chassis.

FIG. 34 is a horizontal sectional view illustrating a state before a main body is slid in the process of mounting the lamp clip in the first state.

FIG. 35 is a horizontal sectional view illustrating a state in which the lamp clip in the first state is mounted.

FIG. 36 is a sectional view illustrating a state in which a lamp clip reinforcement portion in a second state interferes in a peripheral edge portion of a second mounting hole.

FIG. 37 is a horizontal sectional view illustrating the state in which the lamp clip reinforcement portion in the second state interferes in the peripheral edge portion of the second mounting hole.

FIG. 38 is a front view of a lamp clip according to a seventh embodiment of the invention.

FIG. 39 is a bottom view of the lamp clip.

FIG. 40 is an enlarged plan view of mounting holes in a chassis.

FIG. 41 is a sectional view illustrating a state in which each lamp clip reinforcement portion in the second state interferes in a peripheral edge portion of each mounting hole.

FIG. 42 is a horizontal sectional view illustrating the state in which each lamp clip reinforcement portion in the second state interferes in the peripheral edge portion of each mounting hole.

FIG. 43 is a front view of a lamp clip according to an eighth embodiment of the invention.

FIG. 44 is a horizontal sectional view of the lamp clip.

FIG. 45 is an enlarged plan view of mounting holes in a chassis.

FIG. 46 is a sectional view illustrating a state before a main body is slid in the process of mounting the lamp clip in the first state.

FIG. 47 is a horizontal sectional view illustrating the state before the main body is slid in the process of mounting the lamp clip in the first state.

FIG. 48 is a sectional view illustrating a state in which the lamp clip in the first state is mounted.

FIG. 49 is a horizontal sectional view illustrating the state in which the lamp clip in the first state is mounted.

FIG. 50 is a sectional view illustrating a state in which a lamp clip reinforcement portion in the second state interferes in a peripheral edge portion of a second mounting hole.

FIG. 51 is a horizontal sectional view illustrating the state in which the lamp clip reinforcement portion in the second state interferes in the peripheral edge portion of the second mounting hole.

FIG. 52 is a partially sectional view of a lamp clip according to another embodiment (3) of the invention.

FIG. 53 is a partially sectional view of a lamp clip according to another embodiment (4) of the invention.

FIG. 54 is a partially sectional view of a lamp clip according to another embodiment (5) of the invention.

### BEST MODES FOR CARRYING OUT THE INVENTION

### First Embodiment

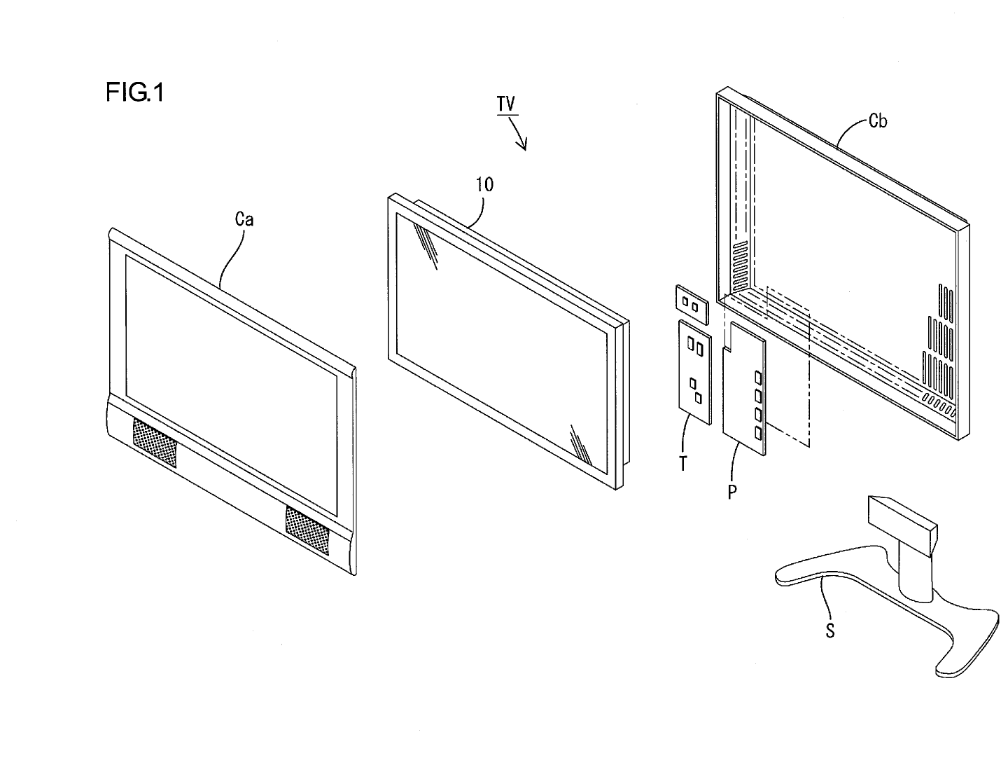

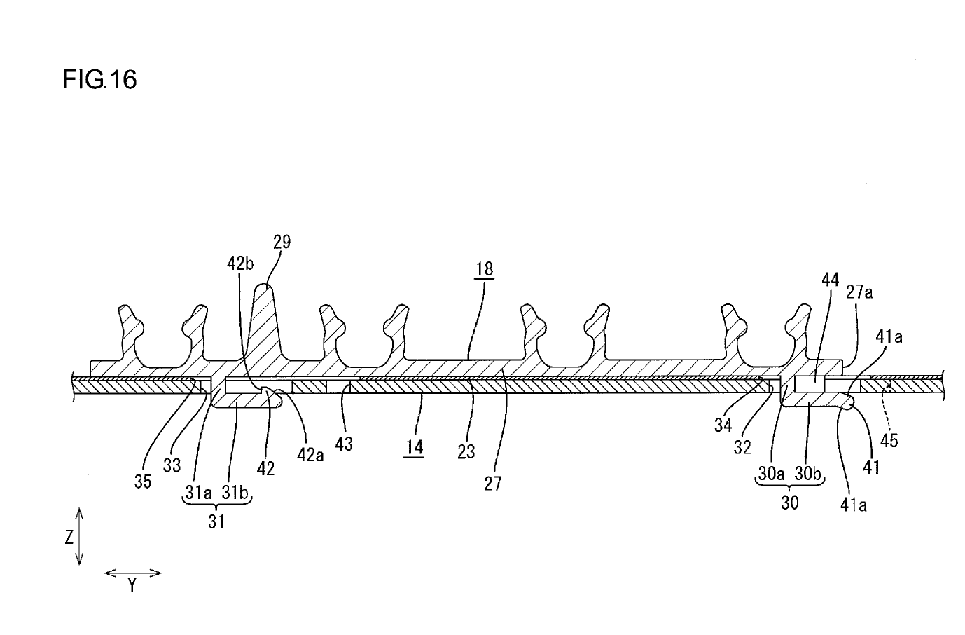

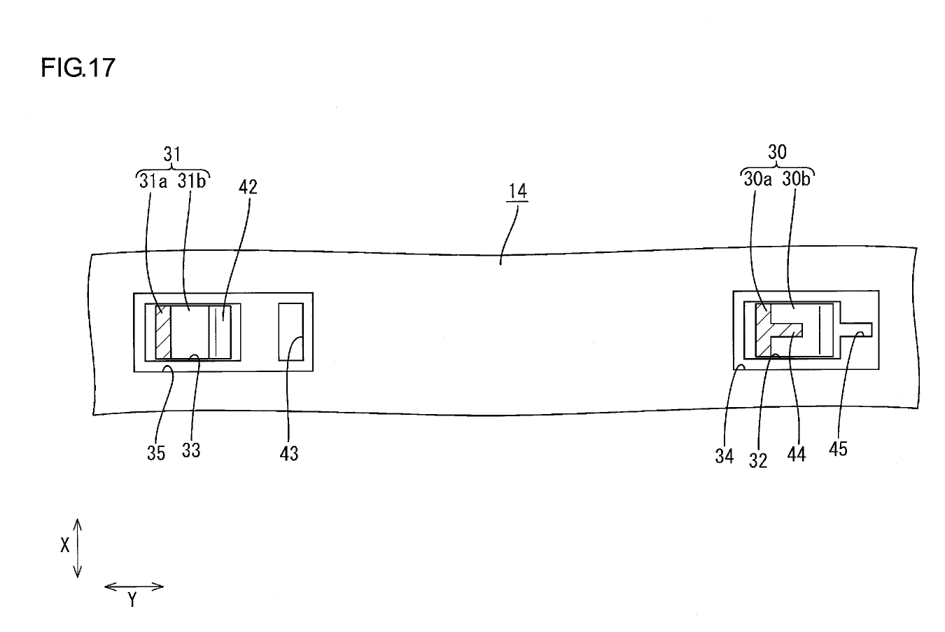

A first embodiment of the invention will be described with reference to FIGS. 1 to 17.

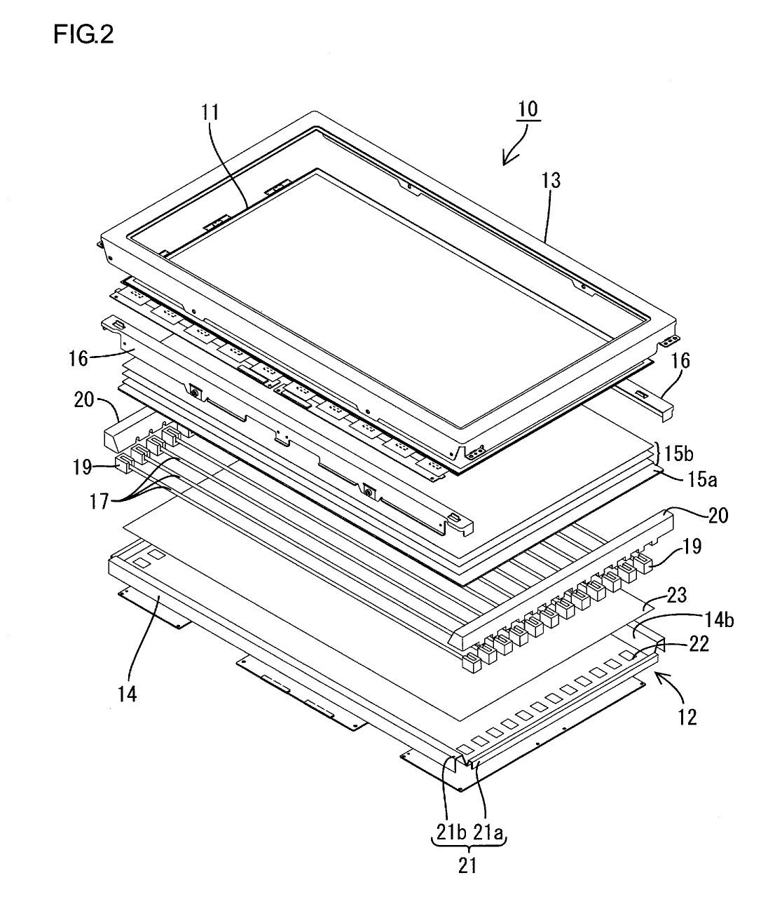

As illustrated in FIG. 1, a television receiver TV of the first embodiment is configured to include a liquid crystal display device 10, front and back cabinets Ca and Cb that accommodate the liquid crystal display device 10 so as to sandwich therebetween, a power supply P, a tuner T, and a stand S. The liquid crystal display device (display device) 10 is formed into a horizontally-long rectangular shape as a whole and accommodated in a vertically standing state. As illustrated in FIG. 2, the liquid crystal display device 10 includes a liquid crystal panel 11 that is of a display panel and a backlight device (illuminating device) 12 that is of an external light source, and the liquid crystal panel 11 and the backlight device 12 are configured to be integrally retained by a frame-like bezel 13. An X-axis, a Y-axis, and a Z-axis are illustrated in some drawings, and the drawings are made such that each axis direction becomes a direction illustrated in each drawing.

The liquid crystal panel 11 and the backlight device 12, which constitute the liquid crystal display device 10, will be described below (see FIGS. 2 to 4).

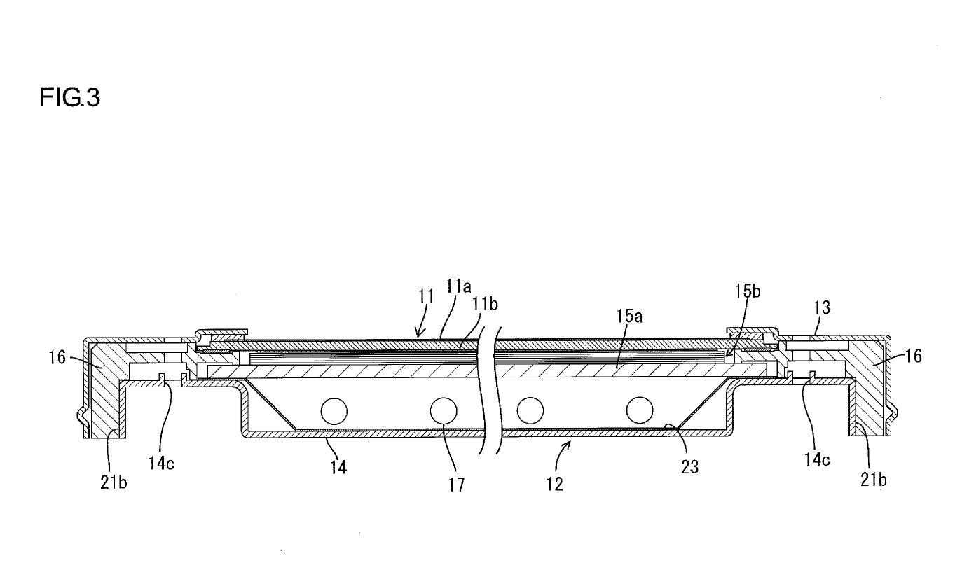

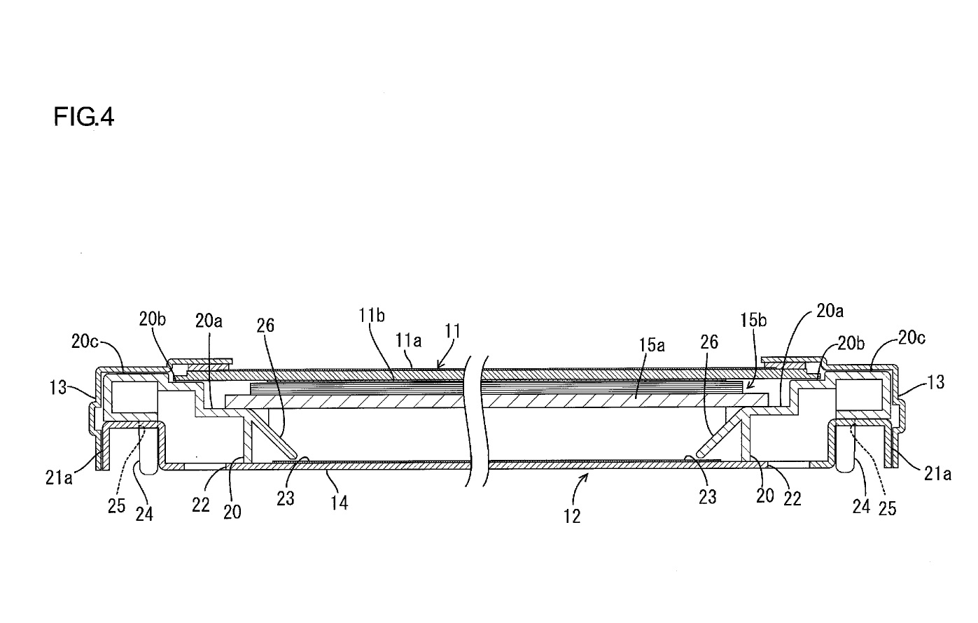

In a configuration of the liquid crystal panel (display panel) 11, a pair of glass substrates is bonded with a given gap, and liquid crystal is sealed between the glass substrates. One of the glass substrates is provided with switching elements (for example, TFT) connected to source interconnections and gate interconnections, which are perpendicular to each other, pixel electrodes connected to the switching elements, an oriented film, and the like. The other glass substrate is provided with a color filter in which colored portions such as R (red), G (green), and B (blue) are arrayed in a given matrix shape, a counter electrode, an oriented film, and the like. Polarizing plates 11a and 11b are disposed outside the substrates (see FIGS. 3 and 4).

As illustrated in FIG. 2, the backlight device 12 includes a substantially box-shaped chassis 14 that is opened onto a light outgoing surface side (side of the liquid crystal panel 11), a diffuser plate 15a that is disposed so as to cover an opening 14b of the chassis 14, plural optical sheets 15b that are disposed between the diffuser plate 15a and the liquid crystal panel 11, and frames 16 that are disposed along long sides of the chassis 14 and retain long-side edge portions of the diffuser plate 15a while the long-side edge portions are sandwiched between the frames 16 and the chassis 14. The chassis 14 further includes cold-cathode tubes (light sources) 17, lamp clips 18 that are used to mount the cold-cathode tube 17 on the chassis 14, relay connectors 19 that relay electric connection in each end portion of the cold-cathode tube 17, and holders 20 that collectively covers end portions of a group of the cold-cathode tubes 17 and a group of the relay connectors 19. In the backlight device 12, the diffuser plate 15a is located closer to the light outgoing side than the cold-cathode tube 17. In FIGS. 2 to 4, the lamp clips 18 are not illustrated.

The chassis 14 is made of metal and formed in a shallow substantially box shape through sheet-metal processing. The chassis 14 includes a rectangular bottom plate and a folded outer edge portion (a folded outer edge portion 21a in a short-side direction and a folded outer edge portion 21b in a long-side direction) that is vertically folded in a substantially U-shape from each side. Plural mounting holes 22 are made in both end portions in a long-side direction of the bottom plate of the chassis 14 to mount the relay connectors 19. As illustrated in FIG. 3, a fixing hole 14c is made in an upper surface of the folded outer edge portion 21b of the chassis 14, and the bezel 13, the frame 16, the chassis 14 and the like can be integrated by, for example, a screw.

A reflecting sheet 23 is provided on an inner surface side (the side of the surface opposite to the cold-cathode tube 17 or the diffuser plate 15a, surface side) of the bottom plate of the chassis 14. The reflecting sheet 23 is made of a synthetic resin, the surface of the reflecting sheet 23 is colored in white that is excellent in reflectivity, and the reflecting sheet 23 is spread along the inside of the bottom plate surface of the chassis 14 so as to cover the substantially whole area of the bottom plate surface. The reflecting sheet 23 constitutes a reflecting plane that reflects the light emitted from the cold-cathode tube 17 in the chassis 14 toward the side of the diffuser plate 15a. As illustrated in FIG. 3, the long-side edge portion of the reflecting sheet 23 rises so as to cover the folded outer edge portion 21b of the chassis 14, and is sandwiched between the chassis 14 and the diffuser plate 15a. The reflecting sheet 23 allows the light emitted from the cold-cathode tube 17 to be reflected toward the side of the diffuser plate 15a.

The cold-cathode tube 17 is formed in an elongated tubular shape. A plurality of cold-cathode tubes 17 is in parallel with one another to be accommodated in the chassis 14 while length directions (axial direction) of the cold-cathode tubes 17 are aligned with the long-side direction of the chassis 14 (see FIG. 2). The cold-cathode tube 17 floats slightly from the bottom plate (reflecting sheet 23) of the chassis 14, and the end portions of the cold-cathode tube 17 are fitted in the relay connector 19. The holder 20 is mounted so as to cover the relay connector 19.

The holder 20 is made of a white synthetic resin. The holder 20 covers the end portion of the cold-cathode tube 17 and has an elongated substantially box shape extending along the short-side direction of the chassis 14. As illustrated in FIG. 4, the holder 20 has a stepwise surface of which the diffuser plate 15a and the liquid crystal panel 11 can be placed unevenly on the surface side, and the holder 20 is provided while partially overlapping the folded outer edge portion 21a in the short-side direction of the chassis 14. The holder 20 and the folded outer edge portion 21a constitute a sidewall of the backlight device 12. An insertion pin 24 is projected from a surface of the holder 20 opposite to the folded outer edge portion 21a of the chassis 14. The insertion pin 24 is inserted in an insertion hole 25 made in an upper surface of the folded outer edge portion 21a of the chassis 14, thereby mounting the holder 20 on the chassis 14.

The stepwise surface of the holder 20 includes three surfaces that are parallel to the bottom plate surface of the chassis 14, and the short-side edge portion of the diffuser plate 15a is placed on a first surface 20a that is located at the lowest position. An inclined cover 26 that is inclined toward the bottom plate surface of the chassis 14 extends from the first surface 20a. The short-side edge portion of the liquid crystal panel 11 is placed on a second surface 20b in the stepwise surface of the holder 20. A third surface 20c that is located at the highest position in the stepwise surface of the holder 20 is provided at a position at which the third surface 20c overlaps the folded outer edge portion 21a of the chassis 14, and the third surface 20c is in contact with the bezel 13.

The diffuser plate 15a is formed by a synthetic-resin plate-like member in which light scattering particles are blended in a dispersed manner. The diffuser plate 15a has a function of diffusing linear light emitted from the cold-cathode tube 17 that is of the tubular light source. As described above, the short-side edge portion of the diffuser plate 15a is placed on the first surface 20a of the holder 20, and is not subjected to a constraint force in a vertical direction. On the other hand, as illustrated in FIG. 3, the long-side edge portion of the diffuser plate 15a is fixed while sandwiched between the chassis 14 (reflecting sheet 23) and the frame 16.

The optical sheet 15b disposed on the diffuser plate 15a is constituted such that a diffuser sheet, a lens sheet, and a reflection type polarizing plate are sequentially stacked from the side of the diffuser plate 15a. The optical sheet 15b has a function of shaping the light, which is emitted from the cold-cathode tube 17 to pass through the diffuser plate 15a, into planar light. The liquid crystal panel 11 is placed on the upper surface side of the optical sheet 15b, and the optical sheet 15b is retained while sandwiched between the diffuser plate 15a and the liquid crystal panel 11.

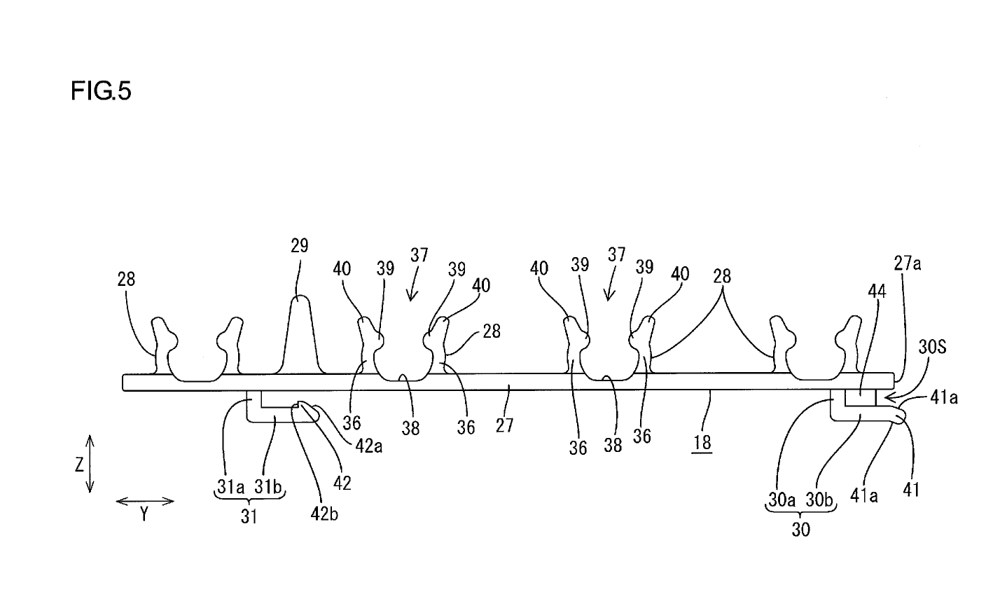

The lamp clip 18 will be described in detail. The lamp clip 18 is made of a synthetic resin (for example, polycarbonate), and the surface of the lamp clip 18 is colored in white that is excellent in reflectivity. As illustrated in FIGS. 5 to 7, the lamp clip 18 includes a main body 27 (mounting plate, base portion) that is formed in a substantially plate-like shape along the bottom plates of the chassis 14 and reflecting sheet 23. The main body 27 has a substantially rectangular shape when viewed from above. The lamp clip 18 is mounted on the chassis 14 while the length direction (long-side direction) of the main body 27 is provided (oriented) along the Y-axis direction and in substantially parallel with the short-side direction of the chassis 14. In other words, the lamp clip 18 is mounted on the chassis 14 while the length direction of the main body 27 is provided in substantially parallel with the direction perpendicular to the axial direction (length direction, X-axis direction) of the cold-cathode tube 17. In the following description, for the Z-axis direction, the upper side illustrated in FIG. 5 is set to a front side and the lower side is set to the backside.

A lamp gripping portion 28 that supports the cold-cathode tube 17 at a predetermined height position and a support pin 29 that supports the diffuser plate 15a at a position higher than that of the cold-cathode tube 17 are provided in a surface (surface opposite to the diffuser plate 15a and cold-cathode tube 17, the surface on the side opposite to the side of the chassis 14) on the front side in the main body 27. Plural (in the first embodiment, four) lamp gripping portions 28 are provided in parallel in the length direction of the main body 27 while separated from one another, to grip the different cold-cathode tubes 17. Pitches between the lamp gripping portions 28 are substantially equal to one another, and the pitch between the lamp gripping portions 28 is substantially matched with a pitch between the cold-cathode tubes 17 arrayed in the chassis 14. The lamp gripping portions 28 are point-symmetrically provided with respect to the center of the main body 27, in particular, a central position in the long-side direction (length direction, Y-axis direction) of the main body 27 and a central position in the short-side direction (width direction, X-axis direction). Each lamp gripping portion 28 is provided while deviating from the center of the main body 27 by a predetermined distance. The support pin 29 is disposed at a position that slants (deviates) from the above-described center of the main body 27, that is, an eccentric position. The support pin 29 is disposed in a substantially middle position between a lamp gripping portion 28 that is located closest to the end of the main body 27 and a lamp gripping portion 28 that is adjacent to the lamp gripping portion 28 located closest to the end of the main body 27. On the other hand, mounting portions 30 and 31 are provided in the surface (surface opposite to the chassis 14 and reflecting sheet 23, the surface on the side opposite to the sides of the diffuser plate 15a and cold-cathode tube 17) on the backside of the main body 27. The mounting portions 30 and 31 maintain the lamp clip 18 in the state of being mounted on the chassis 14. The mounting portions 30 and 31 are disposed while separated from each other in the long-side direction of the main body 27. In order to distinguish the mounting portions 30 and 31 from each other, the mounting portions 30 and 31 are sequentially referred to as a first mounting portion 30 and a second mounting portion 31 from the left of FIG. 5.

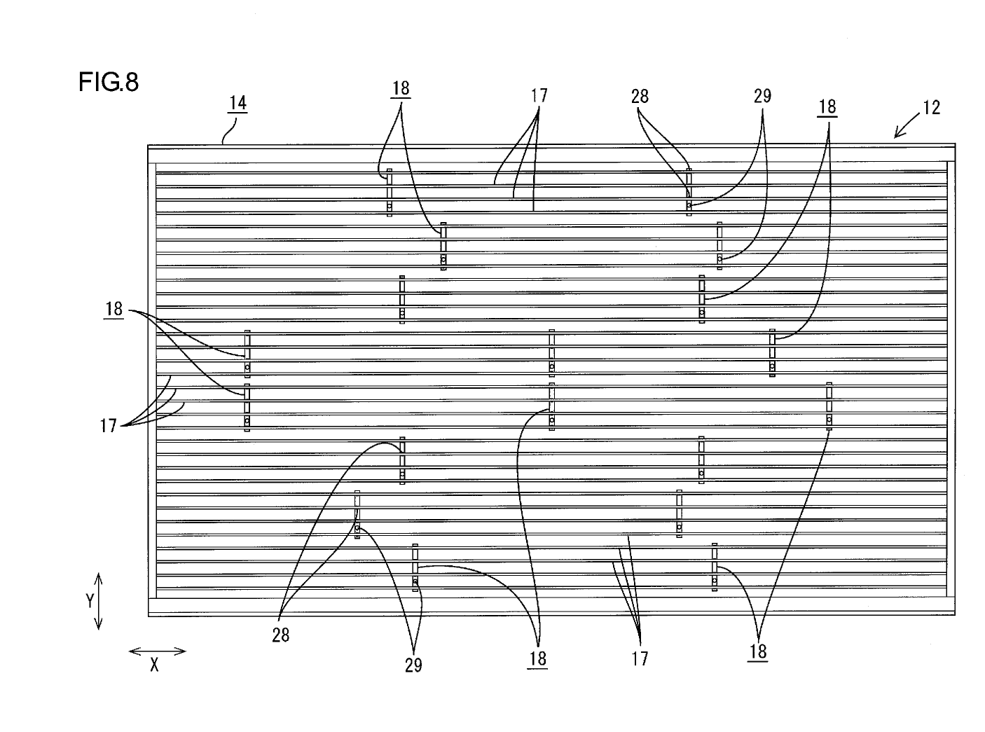

As illustrated in FIG. 8, the plural lamp clips 18 are placed at dispersed positions in the inner surface of the bottom plates of the chassis 14 and reflecting sheet 23. The arrangement of the lamp clips 18 will be described below. The lamp clips 18 are placed in parallel at plural positions that are separated from one another in the long-side directions (X-axis directions) of the chassis 14 and reflecting sheet 23. Therefore, the cold-cathode tube 17 can be gripped at plural positions that are separated from one another in the axial direction. In the bottom plates of the chassis 14 and reflecting sheet 23, the number of lamp clips 18 placed on the central side in the short-side direction (Y-axis direction) is larger than the number of lamp clips 18 placed on the end side. Specifically, each three lamp clips 18 are placed on the central side in the short-side directions of the chassis 14 and reflecting sheet 23 while separated from one another in the long-side direction, and the each two lamp clips 18 are placed close to both ends in the short-side direction from the six central-side lamp clips 18 while separated from one another in the long-side direction. Therefore, the number of lamp gripping portions 28 on the central side in the short-side directions of the chassis 14 and reflecting sheet 23 is larger than the number of lamp gripping portions 28 on the end side, that is, the number of points that support the cold-cathode tube 17 on the central side is larger than the number of points that support the cold-cathode tube 17 on end side. In addition, the number of support pins 29 on the central side is larger than the number of support pins 29 on end side, that is, the number of points that support the diffuser plate 15a on the central side is larger than the number of points that support the diffuser plate 15a on end side.

Each two lamp clips 18 (lamp clips 18 disposed on both the end sides in the short-side direction with respect to the central side) arrayed in the long-side directions of the chassis 14 and reflecting sheet 23 are disposed at positions that deviate in the long-side direction with respect to the lamp clips 18 adjacent to each other in the short-side direction. Accordingly, compared with the case in which the lamp clips 18 are arrayed in line along the short-side direction, a shadow of the lamp clip 18 is hardly visible because of a human eye characteristic since the lamp clips 18 are disposed in the dispersed manner in the bottom plate surface of the reflecting sheet 23. Assuming that the number of lamp clips 18 is equal, the shadow is easily visible because of the human eye characteristic when the lamp clips 18 are disposed linearly or collectively, while the luminance unevenness is hardly generated in the backlight device 12 by disposing the lamp clips 18 in the dispersed manner like the present embodiment even if the reflecting sheet 23 differs from the lamp clip 18 in reflectance.

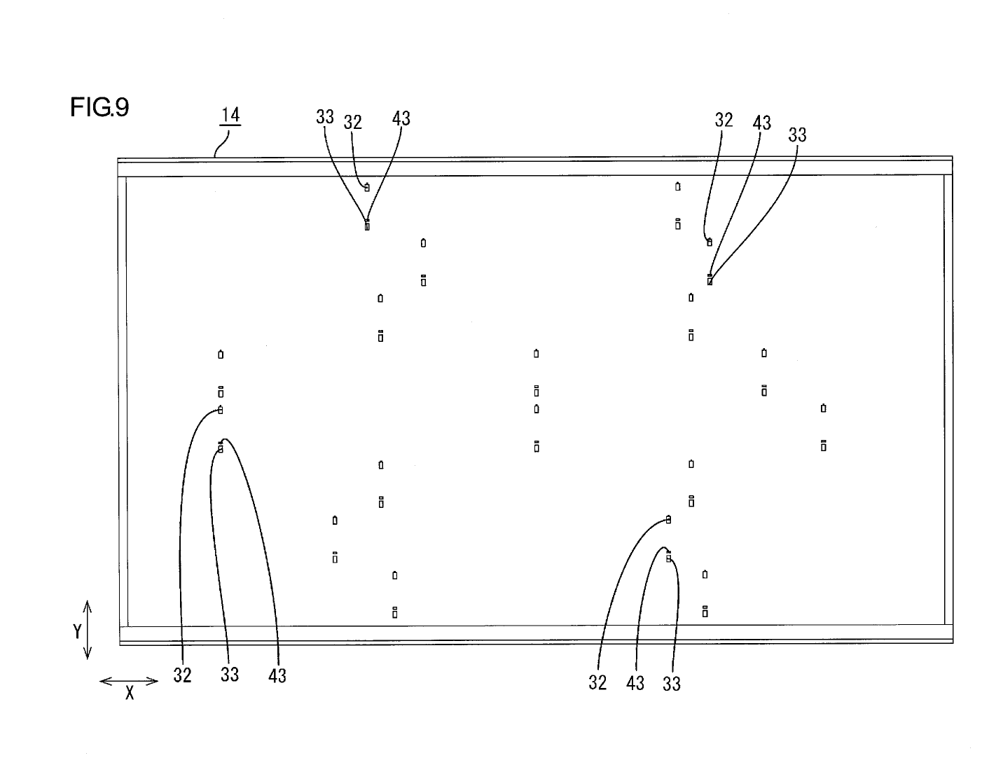

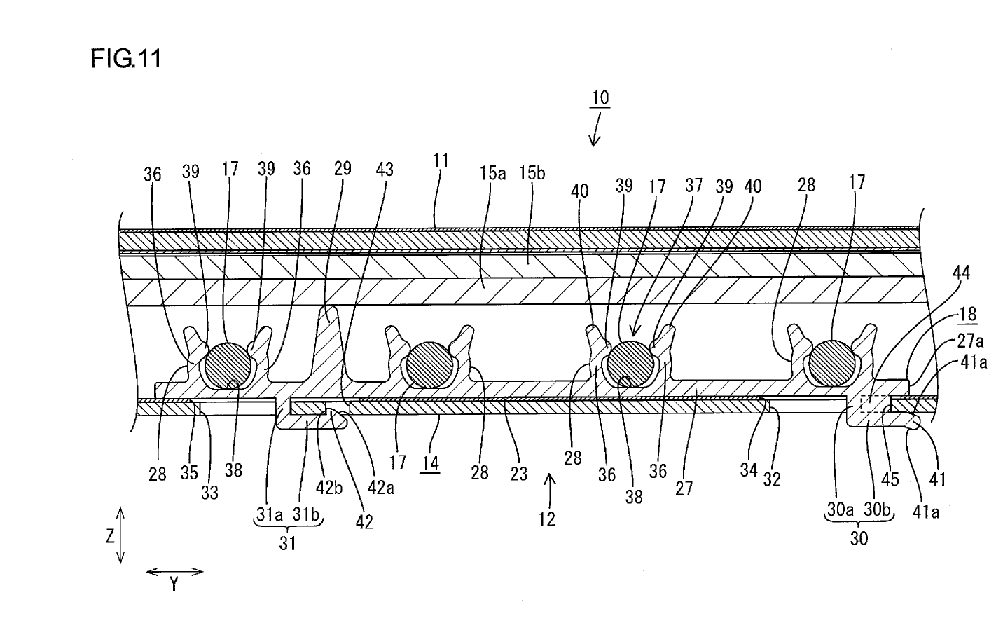

As illustrated in FIG. 9, each two mounting holes 32 and 33 and each two insertion holes 34 and 35 are made in the inner surfaces of the bottom plates of the chassis 14 and reflecting sheet 23 while piercing the bottom plates in a thickness direction. The mounting holes 32 and 33 and the insertion holes 34 and 35 are used to insert the mounting portions 30 and 31 in the positions at which the lamp clips 18 should be mounted. In order to distinguish the mounting holes 32 and 23 and insertion holes 34 and 35 from each other, the mounting holes 32 and 33 and insertion holes 34 and 35 are sequentially referred to as a first mounting hole 32, a first insertion hole 34, a second mounting hole 33, and a second insertion hole 35 from the left illustrated in FIG. 11. The mounting portions 30 and 31, the mounting holes 32 and 33, and the insertion holes 34 and 35 are described in detail later.

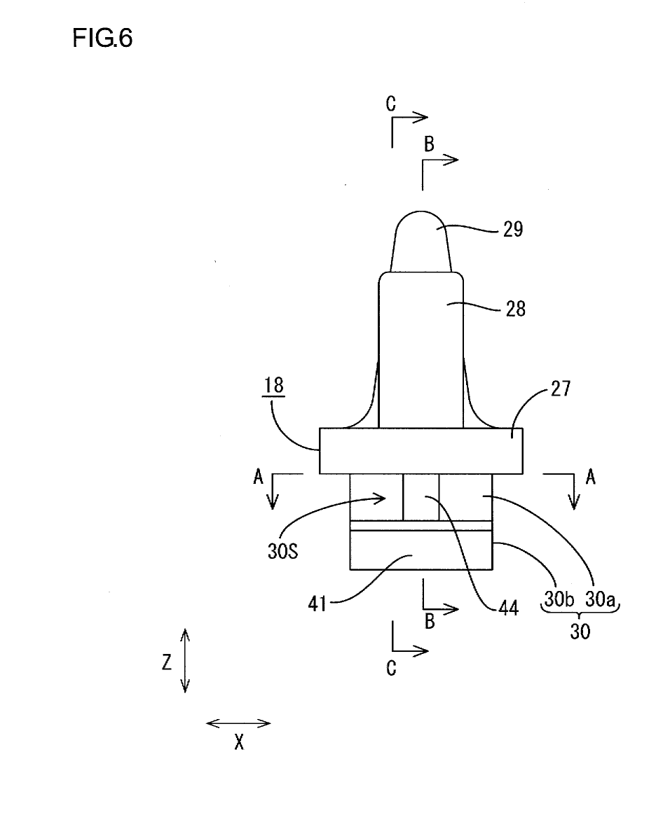

The lamp gripping portion 28 constituting a support structure for the cold-cathode tube 17 will be described in detail. As illustrated in FIG. 6, the lamp gripping portion 28 can support an intermediate portion between both end portions in which the electrodes are placed in the cold-cathode tube 17, that is, a light emitting portion from the backside at a height position that floats slightly from the reflecting sheet 23. The lamp gripping portion 28 has an annular shape with end, which is opened to the front side, as a whole. The lamp gripping portion 28 includes a pair of arm portions 36 that is opposite to each other. An opening 37 is secured between distal end portions of arm portions 36 to permit the cold-cathode tube 17 to pass therethrough. The cold-cathode tube 17 is mounted/removed along the Z-axis direction (thickness directions of the bottom plates of the chassis 14 and reflecting sheet 23). The arm portions 36 are formed in cantilever shapes that rise up from the position separated from each other in the length direction (Y-axis direction) in the surface on the front side of the main body 27, and the arm portion 36 is curved in a substantial arc shape. The inner circumference surfaces of the arm portions 36 are formed in arc shapes along the outer circumference surface of the cold-cathode tube 17 to be mounted. The arm portions 36 are symmetrically formed in relation to a symmetrical axis along the Z-axis direction, and the symmetrical axis passes through the central position in the Y-axis direction of the lamp gripping portion 28. The arm portions 36 can elastically be deformed along a width direction while a rising base end portion from the main body 27 is used as a fulcrum point. The width dimension of the arm portion 36 is smaller than the width dimension of the main body 27.

As described above, because a pair of the arm portions 36 constituting the lamp gripping portion 28 is disposed at the positions separated from each other in the length direction in the surface on the front side of the main body 27, the bottom surface located between the arm portions 36 in the inner circumference surface (surface opposite to the cold-cathode tube 17) of the lamp gripping portion 28 is formed by part of the surface on the front side of the main body 27. In the bottom surface, the recess 38 is formed below an outside portion 27a of each lamp gripping portion 28 in the surface on the front side of the main body 27, that is, a distance from the diffuser plate 15a increases in the recess 38. Accordingly, it is said that the main body 27 is partially thinned in the portion (point at which the recess 38 is formed) corresponding to each lamp gripping portion 28. The recess 38 is formed over the whole range in the width direction of the main body 27.

A retaining projection 39 is provided in the inner surface (inner circumferential surface opposite to the cold-cathode tube 17) in a distal end portion of the arm portion 36 in order to retain the cold-cathode tube 17, and the opening 37 described above is secured between the retaining projections 39. The width of the opening 37 is set slightly narrower than an outside diameter dimension of the cold-cathode tube 17. Accordingly, in mounting or removing the cold-cathode tube 17 through the opening 37, the cold-cathode tube 17 presses the arm portions 36, whereby the arm portions 36 are elastically deformed and expanded. The retaining projection 39 hangs over inward (toward a center axis line side of the cold-cathode tube 17) from the inner surface in the distal end portion of the arm portion 36. The retaining projection 39 is located at a position at which the cold-cathode tube 17 is covered from the front side (light outgoing side), that is, the retaining projection 39 is located on the side in the direction in which the cold-cathode tube 17 drops out of. In the mounted state, the cold-cathode tube 17 is supported at three points, that is, a central first support point located immediately below the center of the cold-cathode tube 17 in the bottom surface of the lamp gripping portion 28 and second and third support points located at inner ends of the retaining projections 39. Between the support points, a slight gap (clearance) extending in the circumferential direction is provided between the outer circumference surface of the cold-cathode tube 17 and the inner circumference surface of the lamp gripping portion 28 (FIG. 11).

Guide portions 40 are provided in the outer surfaces in the distal end portions of the arm portions 36 in order to guide the operation to mount the cold-cathode tube 17. Each guide portion 40 is formed in a tapered shape while rising obliquely outward from the arm portion 36. The guide portions 40 have gradients from projection base ends to projection distal ends so as to be separated from each other. In addition, in the guide portions 40, the inner surfaces opposite to the cold-cathode tube 17 are formed in inclined surfaces having the similar gradients. Accordingly, a gap between the inner surfaces that are of surfaces opposite to each other in the guide portions 40 is gradually narrowed toward the side in the direction in which the cold-cathode tube 17 is mounted, and the gap is gradually widened toward the side in the direction in which the cold-cathode tube 17 is detached. Therefore, the operation to mount the cold-cathode tube 17 can smoothly be guided by the inner surfaces of the guide portions 40. The inner surface of the guide portion 40 continues directly and smoothly in the inner surface of the retaining projection 39.

Next, the support pin 29 constituting the support structure for the diffuser plate 15a will be described in detail. As illustrated in FIG. 11, the support pin 29 supports a portion of the diffuser plate 15a, which is located closer onto the screen central side than an outer peripheral edge portion supported by the holder 20 and the like, from the backside. This allows the diffuser plate 15a to be controlled so as not to bend or warp onto the side of the cold-cathode tube 17. The support pin 29 has a circular section when being cut along the horizontal direction, and is formed in a tapered shape in which a diameter dimension decreases gradually toward the distal end side from the root side. That is, the support pin 29 is formed in a substantially conical shape. An R surface is formed to round the support pin 29 in the distal end portion of the support pin 29 that can abut on the diffuser plate 15a. A projection height of the support pin 29 from the main body 27 is set higher than the lamp gripping portion 28, whereby the support pin 29 becomes a region projected to the highest position in the lamp clip 18. Accordingly, in mounting/removing the lamp clip 18 on/from the chassis 14, a worker can perform the work while gripping the support pin 29, and the support pin 29 can also act as manipulating portion during the mounting/removing operation.

Then the mounting portions 30 and 31 constituting the retaining structure of the lamp clip 18 for the chassis 14 will be described in detail along with the mounting holes 32 and 33 in the chassis 14 and the insertion holes 34 and 35 in the reflecting sheet 23. First the retaining structure will briefly be described. As illustrated in FIG. 5, the mounting portions 30 and 31 are formed in hook shapes along the rear surface (plate surface) of the main body 27, and the mounting portions 30 and 31 are inserted in the mounting holes 32 and 33 of the chassis 14 and the insertion holes 34 and 35 of the reflecting sheet 23 and projected to the backside of the chassis 14. At this point, the lamp clip 18 is slid along the length direction (Y-axis direction, direction of the bottom plate surfaces of the reflecting sheet 23 and chassis 14) of the main body 27. As a result, the chassis 14 and the reflecting sheet 23 are sandwiched between the mounting portions 30 and 31 and the main body 27. Thus, the direction in which the lamp clip 18 is slid to the chassis 14 is aligned with the Y-axis direction.

The first mounting portion 30 and the second mounting portion 31 have a common structure. The common structure will be described below. The first mounting portion 30 and the second mounting portion 31 have rectangular shapes when viewed from above. The first mounting portion 30 is substantially equal to the second mounting portion 31 in the width dimension and the length dimension. The width dimensions of the first and second mounting portions 30 and 31 are smaller than the short-side dimension of the main body 27, and the length dimensions of the first and second mounting portions 30 and 31 are smaller than the long-side dimension of the main body 27. The first mounting portion 30 and the second mounting portion 31 are placed at the substantially central position in the width direction of the main body 27.

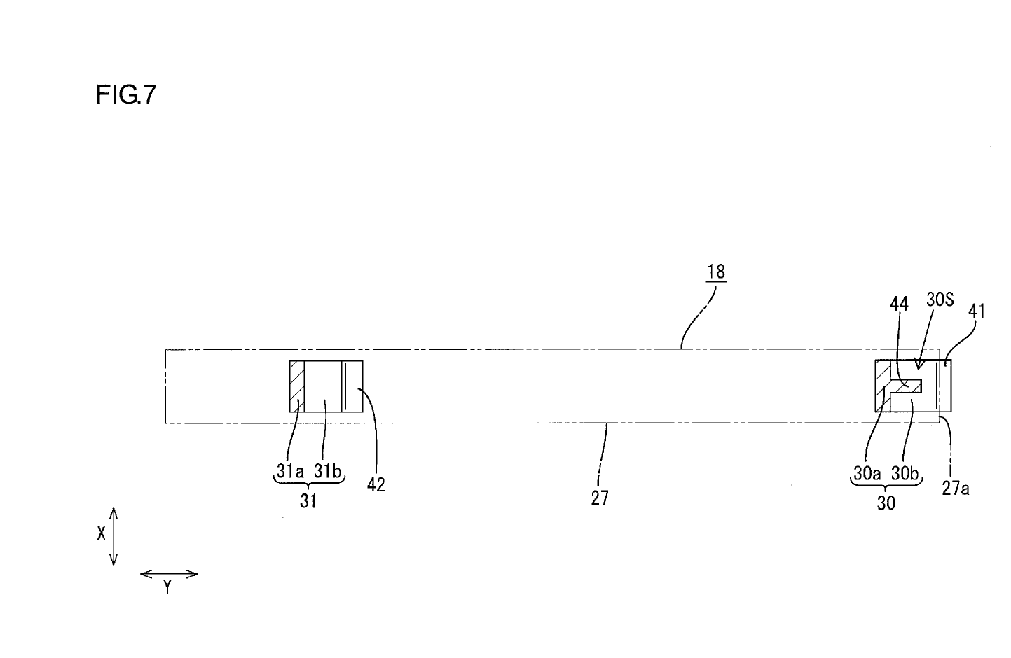

In particular, the first mounting portion 30 and the second mounting portion 31 include base portions 30a and 31a that are projected from the rear surface of the main body 27 to the backside (side of the chassis 14) and extending portions 30b and 31b that are projected along the main body 27 from the distal ends of the base portions 30a and 31a, respectively. The first mounting portion 30 and the second mounting portion 31 are formed in a substantially L-shape when viewed from the front side. The base portions 30a and 31a are projected from the main body 27 toward the Z-axis direction, that is, the direction perpendicular to the plate surface of the main body 27. In other words, the base portions 30a and 31a rise substantially perpendicularly from the main body 27. As illustrated in FIG. 7, the base portions 30a and 31a have the rectangular sections when being cut along the main body 27, the short-side directions of the base portions 30a and 31a are aligned with the Y-axis direction (slide direction), and the long-side directions of the base portions 30a and 31a are aligned with the X-axis direction.

As illustrated in FIGS. 5 and 7, the extending portions 30b and 31b have cantilever shapes that are projected (extended) from the distal end portions of the base portions 30a and 31a along the long-side direction of the main body 27, that is, the Y-axis direction in which the lamp clip 18 is slid to the chassis 14. In other words, the extending portions 30b and 31b are bent at a substantially right angle from the distal end portions of the base portions 30a and 31a, and the extending portions 30b and 31b are extended in parallel with the main body 27 while being opposite to the main body 27. The extending portions 30b and 31b is elastically deformable in the Z-axis direction, that is, the direction intersecting the direction in which the extending portions 30b and 31b extends from the base portions 30a and 31a. Proximal ends of the extending portions 30b and 31b that continue to the base portions 30a and 31a are the fulcrum point. With the elastic deformation, the extending portions 30b and 31b are displaced so as to come into contact with and separate from the main body 27. The gap between each of the extending portions 30b and 31b and the main body 27 is substantially equal to or larger than a size obtained by adding the thickness of the chassis 14 and the thickness of the reflecting sheet 23. The extending portions 30b and 31b are formed in the rectangular shapes when viewed from above. The long-side directions of the extending portions 30b and 31b are aligned with the Y-axis direction (slide direction), and the short-side directions of the extending portions 30b and 31b are aligned with the X-axis direction. The dimensions in the X-axis directions (dimensions in the directions perpendicular to the extending directions) of the extending portions 30b and 31b are smaller than the dimensions in the Y-axis directions (dimensions in the extending directions). The dimensions in the X-axis directions of the extending portions 30b and 31b and base portions 30a and 31a (short-side dimensions (width dimensions) of the mounting portions 30 and 31) are substantially equal to each other.

A difference of the structure between the first mounting portion 30 and the second mounting portion 31 will be described below. The base portion 30a constituting the first mounting portion 30 is located on the backside of the lamp gripping portion 28 that is placed in the end portion of the main body 27 on the side opposite to the side of the support pin 29 in relation to the length direction. More specifically, the base portion 30a is disposed at the position that is substantially identical to the base end position of the end-side arm portion 36 constituting the lamp gripping portion 28. The extending portion 30b constituting the first mounting portion 30 is formed in the cantilever shape that extends from the base portion 30a toward the side opposite to the side of the support pin 29, and a distal end portion of the extending portion 30b has a length that is further laterally projected from the end portion (front end portion in the slide direction) of the main body 27 on the side opposite to the support pin 29. In other words, the distal end portion (including a guide portion 41) of the extending portion 30b is projected outward from the outer end 27a of the main body 27 when viewed from above.

The guide portion 41 that can guide the operation to mount the lamp clip 18 on the chassis 14 is provided at distal end of the extending portion 30b of the first mounting portion 30. The guide portion 41 is bent such that an obtuse angle is formed with respect to the extending portion 30b, and the guide portion 41 is formed with a gradient that is away from the main body 27 toward the distal end side. In other words, the guide portion 41 is configured such that the gap between the guide portion 41 and the main body 27 increases gradually toward the distal end side. The thickness dimension of the guide portion 41 is kept constant over the total length, whereby the front and rear surfaces of the guide portion 41 constitute guide surfaces 41a. The base end portion of the guide portion 41 is disposed at the position that is substantially identical to that of the outer end 27a of the main body 27 on the side in the direction in which the extending portion 30b is projected. The distal end portion of the guide portion 41 is disposed at the position that is projected outward from the outer end 27a of the main body 27, whereby the substantially whole area of the guide portion 41 is projected outward from the outer end 27a of the main body 27 when viewed from above.

On the other hand, the base portion 31a constituting the second mounting portion 31 is disposed substantially in the middle between the support pin 29 and the lamp gripping portion 28 that is disposed in the end portion of the main body 27 on the side of the support pin 29 in the length direction. That is, the second mounting portion 31 is disposed on the side of the support pin 29 opposite to the first mounting portion 30 in the length direction of the main body 27. The extending portion 31b constituting the second mounting portion 31 extends from the base portion 31a toward the side of the support pin 29, and the distal end portion of the extending portion 31b is disposed substantially immediately rear side of the support pin 29. A latching projection 42 that is projected toward the side of the main body 27 is provided at the distal end of the extending portion 31b of the second mounting portion 31. A tapered surface 42a is formed in a surface of the latching projection 42 opposite to the main body 27. A surface of the latching projection 42 opposite to the base portion 31a erects in substantially parallel with the outer surface of the base portion 31a and forms a substantially straight surface along the direction (Z-axis direction) perpendicular to the direction (Y-axis direction) in which the lamp clip 18 is slid to the chassis 14, thereby becoming a latching surface 42b for the chassis 14.

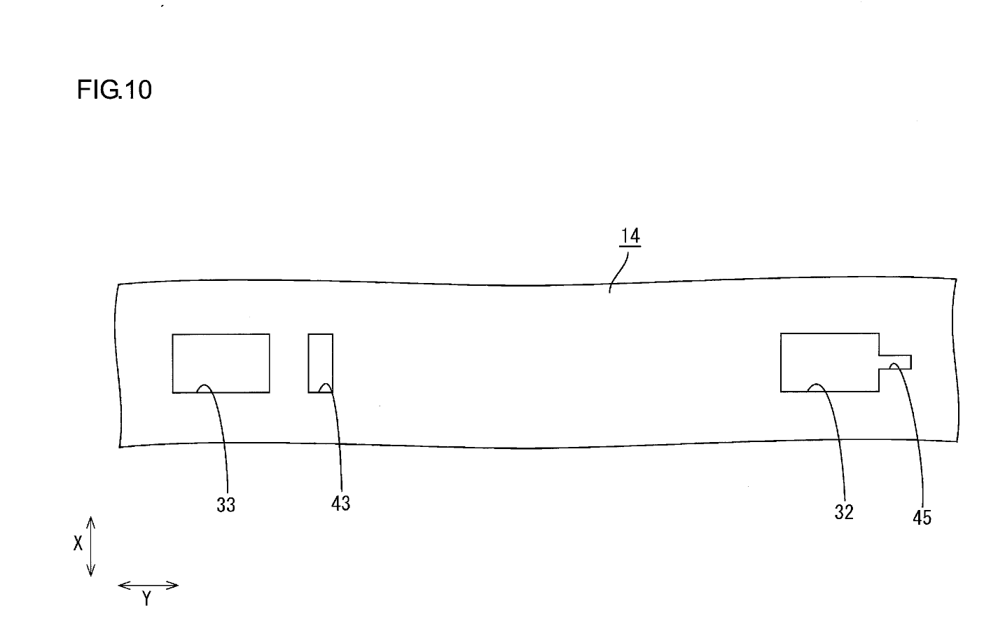

The first mounting hole 32 and the second mounting hole 33, which are provided in the chassis 14, will be described below. As illustrated in FIG. 10, the first mounting hole 32 and the second mounting hole 33 are formed in a size that permits insertion of the corresponding first mounting portion 30 and second mounting portion 31. More specifically, the first mounting hole 32 and the second mounting hole 33 are formed in rectangular shapes according to the first mounting portion 30 and the second mounting portion 31 when viewed from above, and the length dimensions and width dimensions of the first mounting hole 32 and second mounting hole 33 are smaller than those of the main body 27. Accordingly, with the lamp clip 18 being mounted, the first mounting hole 32 and the second mounting hole 33 are closed by the main body 27. A latching hole 43 in which the latching projection 42 can be latched is provided in the chassis 14 at the position adjacent to the second mounting hole 33. The latching hole 43 is provided on the right with respect to the second mounting hole 33 as illustrated in FIG. 10, that is, the latching hole 43 is provided at the position deviated in the direction in which the extending portion 31b extends (slide direction associated with the mounting). Similarly to the first mounting hole 32 and the second mounting hole 33, the size of the latching hole 43 is smaller than that of the main body 27 when viewed from above, and the latching hole 43 is closed by the main body 27 during the mounted state.

Next the first insertion hole 34 and the second insertion hole 35, which are provided in the reflecting sheet 23, will be described below. As illustrated in FIG. 11, the first insertion hole 34 is set larger than the first mounting hole 32. On the other hand, the second insertion hole 35 is provided in the size that can collectively surround the second mounting hole 33 and the latching hole 43. A difference in size between the first mounting hole 32 and the first insertion hole 34 and a difference in size between the second mounting hole 33 and latching hole 43, and the second insertion hole 35 are set equal to or larger than an assumed maximum value of an amount of position deviation that is generated between both sides when the reflecting sheet 23 is assembled in the chassis 14. As a consequence, the mounting holes 32 and 33 and the latching hole 43 are securely provided inside the insertion holes 34 and 35 to avoid the situation in which the mounting holes 32 and 33 or the latching hole 43 is covered with the reflecting sheet 23. The sizes of the insertion holes 34 and 35 are provided smaller than that of the main body 27 when viewed from above, and are closed by the main body 27 during the mounted state.

Of the mounting portions 30 and 31 of the lamp clip 18, the first mounting portion 30 is provided with a reinforcement portion 44 that reinforces the first mounting portion 30, as illustrated in FIGS. 5 to 7. The reinforcement portion 44 is formed in a shape that continues to the base portion 30a, the extending portion 30b, and the main body 27, and the reinforcement portion 44 is provided in a space 30S surrounded by the base portion 30a, the extending portion 30b, and the main body 27. That is, the reinforcement portion 44 is disposed within a range where the first mounting portion 30 is formed in the X-axis direction (direction perpendicular to the slide direction and along the main body 27) and the Y-axis direction (slide direction). The reinforcement portion 44 is not projected outward from the outer circumference end of the first mounting portion 30 when the first mounting portion 30 is viewed from above.

In particular, the reinforcement portion 44 continues to the surfaces opposite to each other in the main body 27 and extending portion 30b, which are opposite to each other, and the reinforcement portion 44 continues to the surface of the base portion 30a that is oriented toward the side in the direction in which the extending portion 30b is projected, whereby the reinforcement portion 44 is configured to continue to the main body 27, the base portion 30a, and the extending portion 30b in a seamless manner. In other words, the reinforcement portion 44 continues to a pair of the surfaces of the main body 27 and the extending portion 30b that retains the chassis 14 from both sides while sandwiching the chassis 14 therebetween during the mounted state, and the reinforcement portion 44 continues to the front surface of the base portion 30a in the slide direction associated with the mounting, whereby the reinforcement portion 44 is configured to continue to the reinforcement target regions 27, 30a, and 30b of the reinforcement portion 44 in a seamless manner. The reinforcement portion 44 is formed so as to continue to the main body 27 and base portion 30a, which continue to each other, and the base portion 30a and extending portion 30b, which continue to each other. The reinforcement portion 44 is disposed in front of the base portion 30a in the slide direction associated with the mounting. The reinforcement portion 44 is formed in an elongated substantially block shape along the slide direction associated with the mounting.

As illustrated in FIG. 6, the reinforcement portion 44 is disposed in the substantially center in the X-axis direction of the first mounting portion 30, that is, in the substantially center along the main body 27 and in the direction perpendicular to the slide direction. As illustrated in FIG. 7, the sectional shape of the reinforcement portion 44 is the elongated rectangular shape along the Y-axis direction (slide direction) when the reinforcement portion 44 is cut along the X-axis direction and the Y-axis direction, the short-side direction of the reinforcement portion 44 is aligned with the X-axis direction, and the long-side direction of the reinforcement portion 44 is aligned with the Y-axis direction. The dimension in the X-axis direction of the reinforcement portion 44, that is, the width dimension is kept constant over the total length. The width dimension of the reinforcement portion 44 is smaller than the dimensions in the X-axis directions of the base portion 30a and extending portion 30b, that is, the width dimension of the first mounting portion 30.

On the other hand, the dimension in the Y-axis direction of the reinforcement portion 44, that is, the length dimension is smaller than the dimension (projection dimension) in the Y-axis direction of the extending portion 30b, and is smaller than a distance between the base portion 30a and the outer end 27a on the side (front side of the slide direction associated with the mounting) in the direction in which the extending portion 30b is projected in the main body 27. That is, the end portion of the reinforcement portion 44 on the side opposite to the side of the base portion 30a is recessed toward the side of the base portion 30a from the outer end 27a of the main body 27 on the side in the direction in which the extending portion 30b is projected. Accordingly, the surface of the extending portion 30b that is opposite to the main body 27, that is, the surface of the extending portion 30b that abuts on the chassis 14 in mounting the lamp clip 18 on the chassis 14 is formed in a gate shape so as to stride over the reinforcement portion 44 when viewed from above. The reinforcement portion 44 in the Y-axis direction with respect to the extending portion 30b is formed in a range from the base portion 30a to the position that is closer to the base portion 31a than the base end portion (outer end 27a of the main body 27 on the side in the direction in which the extending portion 30b is projected) of the guide portion 41. The height dimension (dimension in the Z-axis direction) of the reinforcement portion 44 is matched with the height dimension of the base portion 30a and the gap between the main body 27 and the extending portion 30b.

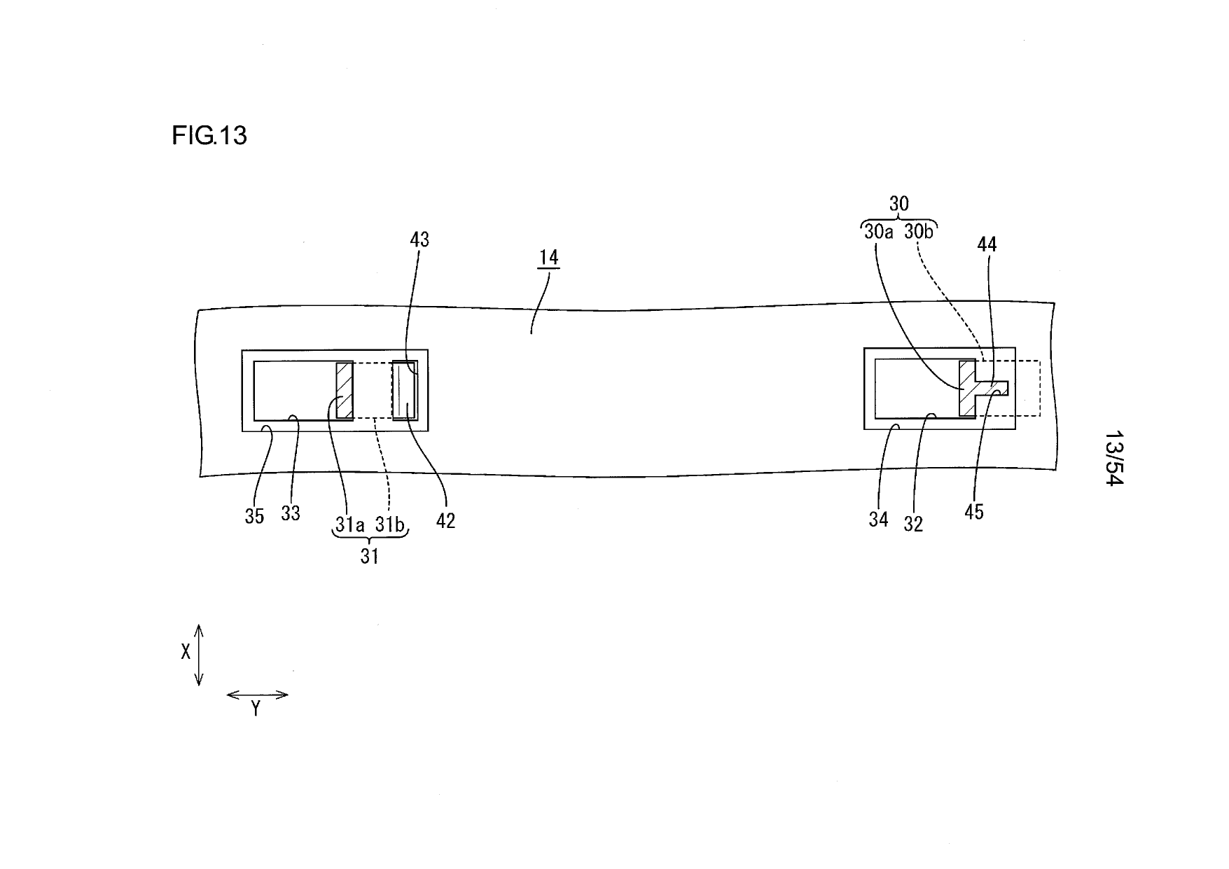

On the other hand, as illustrated in FIG. 10, a positioning hole 45 that accommodates the reinforcement portion 44 therein is provided in the chassis 14. The positioning hole 45 is provided in the peripheral edge portion of the first mounting hole 32 according to the reinforcement portion 44 provided in the first mounting portion 30. More specifically, in the peripheral edge portion of the first mounting hole 32, the positioning hole 45 is provided in a front-side portion (the right portion illustrated in FIG. 10) in the slide direction associated with the mounting of the lamp clip 18, that is, a portion that is retained while sandwiched between the main body 27 and the extending portion 30b of the first mounting portion 30 in the state in which the lamp clip 18 is mounted, and the positioning hole 45 is opened to (communicated with) the first mounting hole 32. When viewed from above, the positioning hole 45 is formed in a rectangular shape that is long and thin along the slide direction of the lamp clip 18 and suitable to the reinforcement portion 44. The short-side dimension and long-side dimension of the positioning hole 45 are equal to or slightly larger than those of the reinforcement portion 44. The positioning hole 45 is disposed at the substantially central position in the X-axis direction of the first mounting hole 32. Therefore, when the lamp clip 18 is slid for the purpose of mounting, the reinforcement portion 44 can intrude in the positioning hole 45 (FIG. 13). While opened to the peripheral edge portion of the first insertion hole 34, a notch that is larger than the positioning hole 45 is formed at the position of the reflecting sheet 23 matched with the positioning hole 45.

Action of the present embodiment having the above-described structure will be described below. The liquid crystal panel 11 and the backlight device 12 are separately produced and assembled in each other using the bezel 13 or the like, thereby producing the liquid crystal display device 10 shown in FIGS. 3 and 4. A detailed description will be given of the work that assembles the backlight device 12, particularly, the work that mounts the lamp clip 18 on the chassis 14.

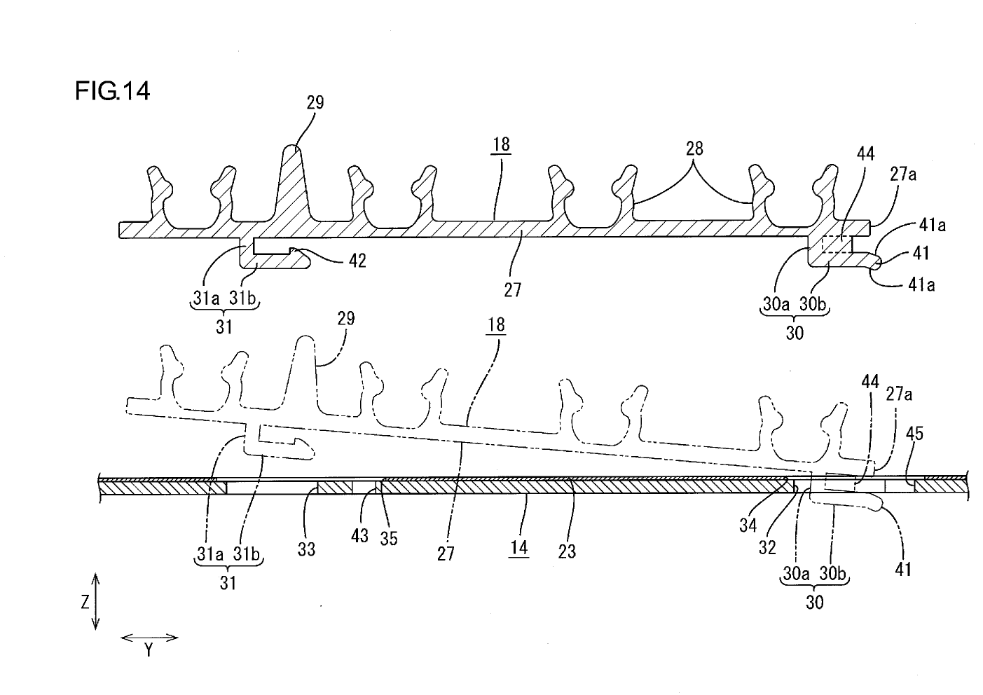

When the reflecting sheet 23 is spread inside the chassis 14, the mounting holes 32 and 33 and the latching hole 43 are positioned so as to face the corresponding insertion holes 34 and 35 and the work of mounting each lamp clip 18 on the chassis 14 is then performed. When the support pin 29 is gripped, the lamp clip 18 is moved in the Z-axis direction from the state illustrated by a solid line of FIG. 14 so as to come close to the side of the chassis 14. Then, the first mounting portion 30 projected forward in the mounting direction from the end portion is first inserted in the first insertion hole 34 and the first mounting hole 32 while the main body 27 is put into an attitude in which the end portion thereof on the side opposite to the side of the support pin 29 is lowered as illustrated by an alternate long and two short dashes line of FIG. 14. At this point, the guide surface 41a of the guide portion 41 formed in the distal end portion of the first mounting portion 30 is slid to the hole edge portion of the first mounting hole 32, thereby achieving the smooth insertion. The second mounting portion 31 is inserted in the second insertion hole 35 and the second mounting hole 33 while the main body 27 is displaced to an attitude in which the main body 27 becomes in parallel with the bottom plates of the chassis 14 and reflecting sheet 23. When the extending portion 30b of the first mounting portion 30 is projected to the backside of the chassis 14, the main body 27 may slightly be slid in the direction in which the extending portions 30b and 31b extend before the second mounting portion 31 is inserted.

In performing the work of first inserting the first mounting portion 30 in the first mounting hole 32, the first mounting portion 30 is not always smoothly inserted in the first mounting hole 32. For example, possibly the first mounting portion 30 interferes in the peripheral edge portion of the first mounting hole 32 in the chassis 14. At this point, the extending portion 30b constituting the first mounting portion 30 is formed in the cantilever shape and projected outward from the outer end of the main body 27, which results in a risk of breakage when a force acting on the extending portion 30b becomes excessive. However, the first mounting portion 30 is provided with the reinforcement portion 44 that continues to the main body 27, the base portion 30a and the extending portion 30b, and the reinforcement is achieved by the reinforcement portion 44. Consequently, the first mounting portion 30 is hardly broken even if the excessive force is acts on the extending portion 30b that interferes in another component such as the chassis 14. Additionally, the reinforcement portion 44 continues directly to the main body 27 and base portion 30a, in which stress concentration is easily generated, thereby achieving the high reinforcement effect. In addition, the reinforcement portion 44 also continues to the extending portion 30b in addition to the main body 27 and the base portion 30a, which contributes to effectively reducing the breakage that may occur between the base portion 30a and the extending portion 30b. Further, the reinforcement portion 44 continues to the main body 27, the base portion 30a, and the extending portion 30b in the seamless manner, which further contributes to effectively reducing the stress concentration in the regions 27, 30a, and 30b. A description will be given of another example of the case in which the first mounting portion 30 interferes in another component. In some cases, for example, a certain lamp clip 18 interferes in the first mounting portion 30 projected from the outer end of the main body 27 of another lamp clip 18 in a process of conveying many lamp clips 18 put into a bag from a production site to an assembly site of the backlight device 12. In such cases, the breakage of the first mounting portion 30 can be reduced since the first mounting portion 30 is reinforced by the reinforcement portion 44.

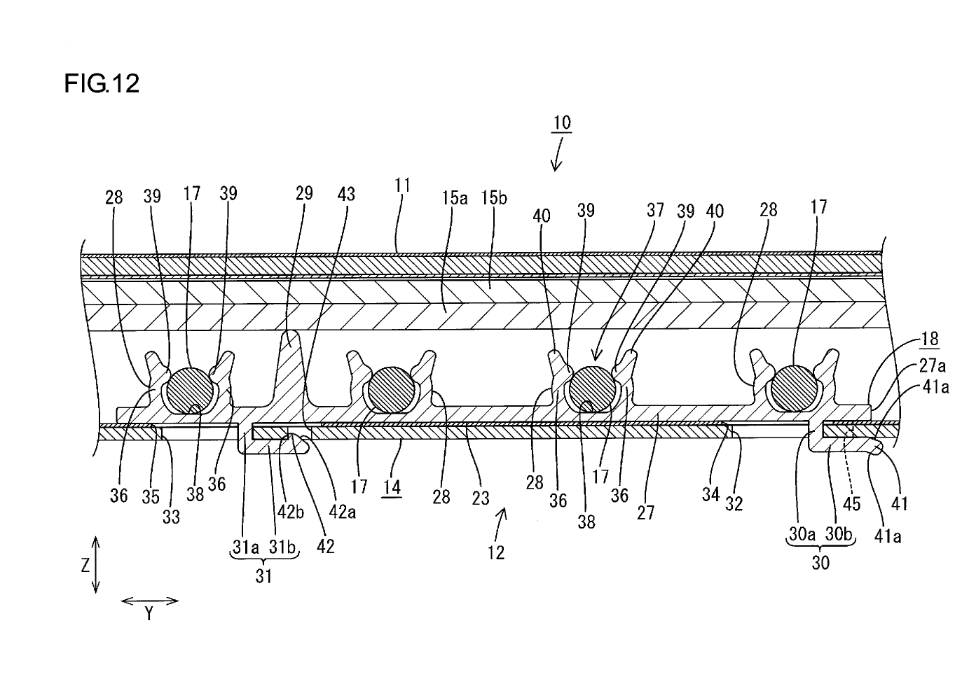

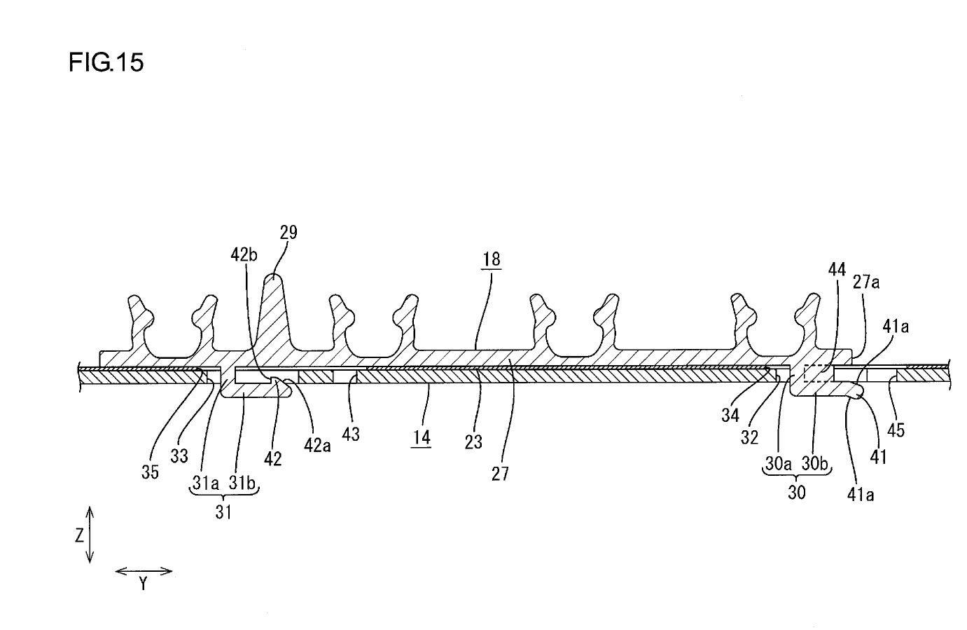

When the lamp clip 18 is pushed to the regular depth to abut the surface on the backside of the main body 27 on the surface of the reflecting sheet 23, the extending portions 30b and 31b of the first mounting portion 30 and second mounting portion 31 are projected to the backside of the chassis 14 through the first mounting hole 32 and the second mounting hole 33, and the reinforcement portion 44 is inserted in the first mounting hole 32, as illustrated in FIGS. 15 to 17. At this point, the main body 27 is slid in the direction (toward the right illustrated in FIGS. 15 to 17 along the Y-axis direction) in which the extending portions 30b and 31b are projected. Then, the extending portions 30b and 31b move in the lateral directions of the mounting holes 32 and 33 to face the backside of the front-side portion in the slide direction associated with the mounting in the peripheral edge portions of the mounting holes 32 and 33 (FIGS. 11 and 12). At this point, the reinforcement portion 44 moves in the lateral directions of the mounting hole 32 to be inserted in the positioning hole 45, and the circumferential surfaces of the reinforcement portion 44 and positioning hole 45 are abutted on each other (FIG. 13). As a consequence, the lamp clip 18 can be positioned in the direction (X-axis direction) perpendicular to the slide direction. When the sizes of the mounting holes 32 and 33 are designed to be sufficiently larger than those of the mounting portions 30 and 31, the mounting portions 30 and 31 are hardly hooked in the peripheral edge portions of the mounting holes 32 and 33 during the mounting to improve workability. However, a clearance between the mounting holes 32 and 33 and the mounting portions 30 and 31 increases to cause a risk of rattling the lamp clip 18. On the other hand, the positioning of the lamp clip 18 is achieved by the reinforcement portion 44 and the positioning hole 45, so that the rattling of the lamp clip 18 can be suppressed while the mounting workability of the lamp clip 18 is improved by taking in the above-described design.

In the process of sliding the lamp clip 18, the latching projection 42 of the second mounting portion 31 runs over the rear surface of the chassis 14, thereby tentatively generating the elastic deformation of the extending portion 31b. When the lamp clip 18 is slid to a predetermined distance, the extending portion 31b is elastically returned while the latching projection 42 is inserted in the latching hole 43, and the latching surface 42b of the latching projection 42 is latched in the wall of the latching hole 43, as illustrated in FIGS. 11 to 13. This restricts the lamp clip 18 from moving carelessly in the direction (removable direction, the left illustrated in FIGS. 11 to 13) opposite to the mounting direction. At this point, the extending portion 31b strikes on the rear surface of the chassis 14 while being restored, thereby generating sound. Therefore, the worker can obtain a strong click feeling to securely slide the lamp clip 18 to the regular mounting position (retaining position). The reinforcement portion 44 is disposed within the range where the first mounting portion 30 is formed in the direction perpendicular to the slide direction and along the main body 27 while disposed in the space 30S surrounded by the main body 27, the base portion 30a, and the extending portion 30b. Even if, for example, a force that reverses the extending portion 30b acts on the first mounting portion 30 in the process of sliding the lamp clip 18, the force can directly be received by the reinforcement portion 44, which effectively avoids the generation of the breakage of the first mounting portion 30.

In the mounted state, the peripheral edge portions of the mounting holes 32 and 33 and insertion holes 34 and 35 in the reflecting sheet 23 and chassis 14 are retained while sandwiched between the main body 27 and the extending portions 30b and 31b of the mounting portions 30 and 31, and therefore the lamp clip 18 is retained in the state of being mounted on the chassis 14. Even if, in such a state, a force that displaces the lamp clip 18 toward the front side along the Z-axis direction acts on the lamp clip 18 due to application of vibration and the like, the extending portions 30b and 31b of the mounting portions 30 and 31 engage the rear surface of the chassis 14 to control the displacement of the lamp clip 18 in the Z-axis direction. In the mounting portions 30 and 31, the extending portions 30b and 31b are formed in the cantilever shapes. Assuming that the extending portions are formed in flange shapes that spread from the base portion, the whole areas of the extending portions 30b and 31b can abut on the chassis 14 compared with the extending portion in which a portion corresponding to the mounting hole does not abut on the chassis, so that the abutment area is enlarged to obtain the high retaining force. A pair of the mounting portions 30 and 31 is inserted in the mounting holes 32 and 33, so that the rotation of the lamp clip 18 is stopped.

After the lamp clip 18 is mounted in the above-described way, the cold-cathode tube 17 is mounted on each lamp gripping portion 28, and the holder 20 is mounted. Then, when the diffuser plate 15a and the optical sheet 15b are placed while stacked, the liquid crystal panel 11 is placed from the front side, and the bezel 13 is assembled to assemble the liquid crystal display device 10.

As described above, according to the present embodiment, the lamp clip 18 comprises: the main body 27 that is mounted on the chassis 14; the lamp gripping portion 28 that is provided in the main body 27 to be able to grip the cold-cathode tube 17; and the mounting portions 30 and 31 that include the base portions 30a and 31a projected from the main body 27 toward the side of the chassis 14 and the extending portions 30b and 31b projected from the base portions 30a and 31a in the direction along the main body 27, the mounting portions 30 and 31 being slid in the direction along the main body 27 from the state in which the mounting portions 30 and 31 are inserted in the mounting holes 32 and 33 provided in the chassis 14, thereby enabling the peripheral edge portions of the mounting holes 32 and 33 to be retained while sandwiched between the extending portions 30b and 31b and the main body 27, wherein the reinforcement portion 44 that continues to at least two of the main body 27 and the base portion 30a and extending portion 30b, which constitute the first mounting portion 30, is formed. With this configuration, the reinforcement of the first mounting portion 30 is achieved by the reinforcement portion 44 that continues to at least two of the main body 27, the base portion 30a, and the extending portion 30b. Accordingly, the first mounting portion 30 is hardly broken even if the first mounting portion 30 interferes in another component such as the chassis 14 associated with the mounting of the lamp clip on the chassis 14.

The reinforcement portion 44 continues to the main body 27 and at least one of the base portion 30a and the extending portion 30b. This configuration achieves the reinforcement between the first mounting portion 30 and the main body 27. The stress concentration is easily generated between the first mounting portion 30 and the main body 27 compared with the stress concentration between the base portion 30a and extending portion 30b, which are of the constituents of the first mounting portion 30. The region between the first mounting portion 30 and the main body 27 is reinforced and thus the breakage of the first mounting portion 30 is effectively reduced.

The reinforcement portion 44 continues to at least two portions, that continue to each other, of the main body 27, the base portion 30a, and the extending portion 30b. Thus, the reinforcement portion 44 continues directly to at least two portions, that continue to each other, of the main body 27, the base portion 30a, and the extending portion 30b. Therefore, the high reinforcement effect is obtained and the breakage of the first mounting portion 30 is effectively reduced.

The reinforcement portion 44 continues to at least the base portion 30a and the main body 27. Though the stress concentration is easily particularly generated between the base portion 30a and the main body 27, the reinforcement portion 44 continues directly to the base portion 30a and the main body 27. Therefore, the high reinforcement effect is obtained and the breakage of the first mounting portion 30 is effectively reduced.

The reinforcement portion 44 continues to at least the base portion 30a and the extending portion 30b. Therefore, the base portion 30a and the extending portion 30b continue directly to each other by the reinforcement portion 44, which reduces the generation of the breakage between the base portion 30a and the extending portion 30b.

The reinforcement portion 44 continues to the main body 27, the base portion 30a, and the extending portion 30b. Therefore, the reinforcement can be achieved between the main body 27 and the first mounting portion 30 and between the base portion 30a and extending portion 30b, which are of the constituents of the first mounting portion 30. Accordingly, the breakage of the first mounting portion 30 is very effectively reduced.

The reinforcement portion 44 is formed so as to continue to the continuous target regions 27, 30a, and 30b in the seamless manner. With this configuration, the stress concentration is further hardly generated among the target regions 27, 30a, and 30b to which the reinforcement portion 44 continues, so that the high reinforcement effect can be obtained.

The extending portion 30b is formed in the cantilever shape. This allows the peripheral edge portion of the first mounting hole 32 to be retained while sandwiched between the main body 27 and the extending portion 30b formed in the cantilever shape, thereby obtaining the high retaining force. On the other hand, because the extending portion 30b is formed in the cantilever shape, the first mounting portion 30 is possibly broken when the distal end portion of the extending portion 30b interferes in another component. However, the reinforcement is achieved by the reinforcement portion 44, to thereby effectively suppress the generation of the breakage. Further, the reinforcement portion 44 continues to at least the extending portion 30b. Therefore, even if the distal end portion of the extending portion 30b formed in the cantilever shape interferes in another component, the force can be received by the reinforcement portion 44 that continues to at least the extending portion 30b, which results in more effective suppression of the generation of the breakage.

The extending portion 30b is formed while projected outward from the outer end 27a of the main body 27. This configuration is excellent in the workability because the portion (guide portion 41) projected outward from the outer end 27a of the main body 27 in the extending portion 30b can first be inserted in the first mounting hole 32 of the chassis 14. On the other hand, the extending portion 30b is possibly broken when the portion of the extending portion 30b projected outward from the outer end 27a of the main body 27 interferes in another component. However, the reinforcement is achieved by the reinforcement portion 44, resulting in effective suppression of the generation of the breakage.

The reinforcement portion 44 is disposed within the range where the first mounting portion 30 is formed in the direction perpendicular to the slide direction with respect to the chassis 14 and along the main body 27. Therefore, when the force is acts on the first mounting portion 30 according to the slide operation, the force can directly be received by the reinforcement portion 44, so that the breakage of the first mounting portion 30 is further effectively reduced. Additionally, because the reinforcement portion 44 is not projected out of the range where the first mounting portion 30 is formed in the direction perpendicular to the slide direction and along the main body 27, the structure is suitably simplified.

The reinforcement portion 44 is disposed in the center in the direction perpendicular to the slide direction and along the main body 27. This configuration further contributes to effectively reducing the breakage of the first mounting portion 30 because the force acting on the first mounting portion 30 can be received in the balanced manner by the reinforcement portion 44.

The reinforcement portion 44 is disposed in the space 30S surrounded by the main body 27, the base portion 30a, and the extending portion 30b. With this configuration, the reinforcement portion 44 is not projected out of the range where the first mounting portion 30 is formed in the direction along the main body 27, so that the structure is suitably simplified.

A pair of the mounting portions 30 and 31 is provided in the main body 27, and the mounting portions 30 and 31 constitute the first mounting portion 30 and the second mounting portion 31. The extending portion 30b constituting the first mounting portion 30 is provided with the guide portion 41 projected outward from the outer end 27a of the main body 27, the gap between the guide portion 41 and the main body 27 increasing gradually toward the distal end side. On the other hand, the extending portion 31b constituting the second mounting portion 31 is provided with the latching projection 42 projected toward the main body 27. The latching projection 42 is held to the wall of the latching hole 43 provided in the chassis 14. The reinforcement portion 44 is formed so as to continue to at least the first mounting portion 30. This configuration is excellent in the workability because the guide portion 41 of the first mounting portion 30 that is projected outward from the outer end 27a of the main body 27 can first be inserted in the first mounting hole 32 of the chassis 14. On the other hand, the breakage is possibly generated when the guide portion 41 interferes in another component. However, the reinforcement is achieved by the reinforcement portion 44, thereby reducing the breakage of the first mounting portion 30. In the mounted state, the latching projection 42 of the second mounting portion 31 can be latched in the circumferential surface of the latching hole 43 to obtain the high retaining force.

Further, the backlight device 12 of the present embodiment includes the lamp clip 18 having the above-described configuration, the cold-cathode tube 17 that is gripped by the lamp gripping portion 28, and the chassis having the mounting holes 32 and 33 in which the mounting portions 30 and 31 are inserted. According to the backlight device 12, the lamp clip 18 is properly mounted on the chassis 14, so that the cold-cathode tube 17 can properly be retained.

The positioning hole 45 opened to the first mounting hole 32 is provided in the portion, of the peripheral edge portion of the first mounting hole 32 in the chassis 14, that is retained and sandwiched between the extending portion 30b and the main body 27 while the lamp clip 18 is mounted, and the reinforcement portion 44 is formed so as to be inserted in the positioning hole 45 associated with the mounting. When the lamp clip 18 is slid to be mounted on the chassis 14 while the first mounting portion 30 is inserted in the first mounting hole 32, the peripheral edge portion of the mounting hole 32 is retained while sandwiched between the extending portion 30b and the main body 27, and the reinforcement portion 44 is inserted in the positioning hole 45. Therefore, the lamp clip 18 can be positioned in the direction intersecting the slide direction with respect to the chassis 14.

Additionally the liquid crystal display device 10 of the present embodiment includes the backlight device 12 having the above-described configuration and the liquid crystal panel 11 that is disposed on the front side of the backlight device 12. According to the liquid crystal display device 10, the lamp clip 18 that retains the cold-cathode tube 17 is properly mounted in the backlight device 12 that illuminates the liquid crystal panel 11. Therefore, troubles such as a display defect are less likely to occur.

In the cold-cathode tube 17 used in the present embodiment, the tube diameter is set to 4.0 mm, the distance between the cold-cathode tube 17 and the reflecting sheet 23 is set to 0.8 mm, the distance between the adjacent cold-cathode tubes 17 is set to 16.4 mm, and the distance between the cold-cathode tube 17 and the diffuser plate 15a is set to 2.7 mm. In the backlight device 12, the distance between the constituents decreases to achieve a thinner device, particularly the distance between the cold-cathode tube 17 and the diffuser plate 15a and the distance between the cold-cathode tube 17 and the reflecting sheet 23 decrease. Using the thinner backlight device 12, the thickness (that is, the thickness from the surface of the liquid crystal panel 11 to the rear surface of the backlight device 12) of the liquid crystal display device 10 can be set to 16 mm, and the thickness (that is, the thickness from the surface of the front-side cabinet Ca to the rear surface of the backside cabinet Cb) of the television receiver TV can be set to 34 mm, thereby implementing the flat-screen television receiver.

### Second Embodiment

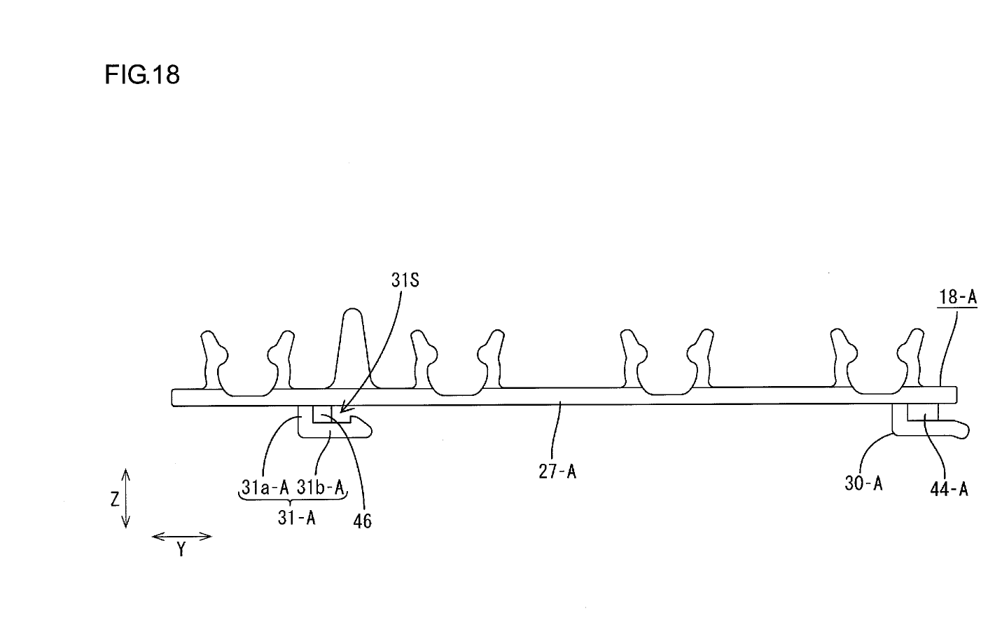

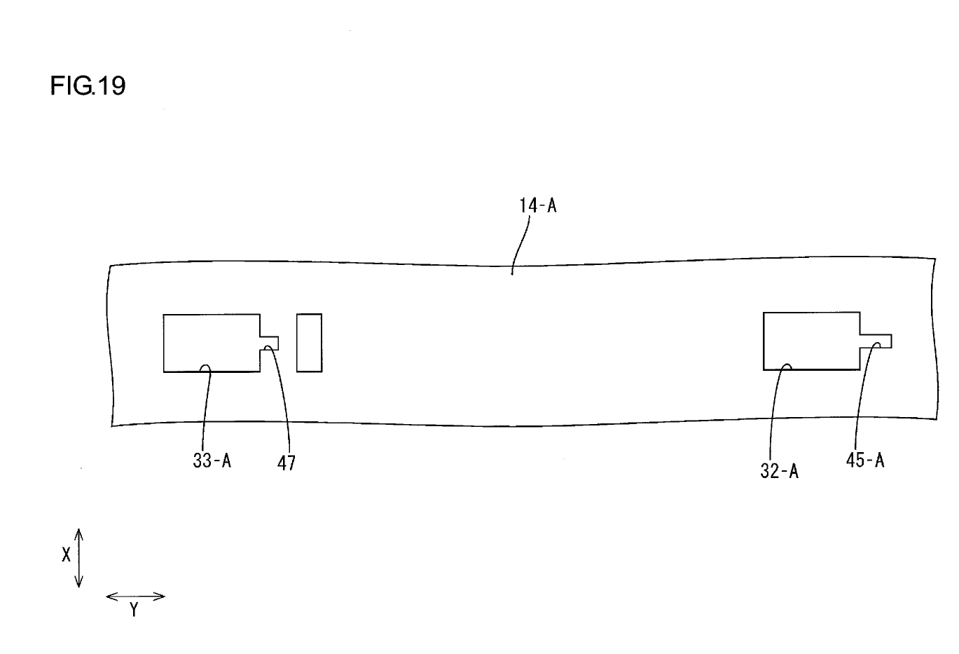

A second embodiment of the invention will be described with reference to FIGS. 18 and 19. In the second embodiment, a reinforcement portion 46 is also provided in a second mounting portion 31-A. In the second embodiment, the region having the same name as the first embodiment is designated by the same numeral, a suffix “-A” is added to the ending of the numeral, and overlapping descriptions of the structure, action, and effect are omitted.

As illustrated in FIG. 18, the second mounting portion 31-A is provided with the reinforcement portion 46 that reinforces the second mounting portion 31-A. The reinforcement portion 46 continues to a main body 27-A and a base portion 31a-A and a extending portion 31b-A, which constitute the second mounting portion 31-A, and is disposed in a space 31S surrounded by the main body 27-A, the base portion 31a-A, and the extending portion 31b-A. That is, the reinforcement portion 46 is disposed within a range where the second mounting portion 31-A is formed in the X-axis direction (direction perpendicular to the slide direction and along the main body 27-A) and the Y-axis direction (slide direction), and is not projected outward from the outer circumference end of the second mounting portion 31-A when the second mounting portion 31-A is viewed from above.

More specifically, the reinforcement portion 46 continues to the surfaces opposite to each other in the main body 27-A and extending portion 31b-A, which are opposite to each other, and the reinforcement portion 46 continues to the surface of the base portion 31a-A oriented toward the direction in which the extending portion 31b-A is projected, whereby the reinforcement portion 46 continues to the main body 27-A, the base portion 31a-A, and the extending portion 31b-A in the seamless manner. In other words, the reinforcement portion 46 continues to a pair of the surfaces of the main body 27-A and extending portion 31b-A that retain and sandwich the chassis 14-A from both sides in the mounted state, and the reinforcement portion 46 continues to the front surface of the base portion 31a-A in the slide direction associated with the mounting, whereby the reinforcement portion 46 continues to the reinforcement target regions 27-A, 31a-A, and 31b-A in the seamless manner. The reinforcement portion 46 is formed so as to continue to the main body 27-A and base portion 31a-A, which continue to each other, and so as to continue to the base portion 31a-A and extending portion 31b-A, which continue to each other. The reinforcement portion 46 is disposed in front of the base portion 31a-A in the slide direction associated with the mounting. The reinforcement portion 46 is formed in an elongated substantially block shape along the slide direction associated with the mounting.

The reinforcement portion 46 is disposed in the substantially center in the X-axis direction of the second mounting portion 31-A, that is, in the substantially center in the direction along the main body 27-A and perpendicular to the slide direction. The sectional shape of the reinforcement portion 46 is the elongated rectangular shape along the Y-axis direction (slide direction) when the reinforcement portion 46 is cut along the X-axis direction and the Y-axis direction. The short-side direction of the reinforcement portion 46 is aligned with the X-axis direction, and the long-side direction of the reinforcement portion 46 is aligned with the Y-axis direction. The dimension in the X-axis direction of the reinforcement portion 46, that is, the width dimension is kept constant over the total length. The width dimension of the reinforcement portion 46 is smaller than the dimensions in the X-axis directions of the base portion 31a-A and extending portion 31b-A, that is, the width dimension of the second mounting portion 31-A.

On the other hand, as illustrated in FIG. 19, the chassis 14-A is provided with a positioning hole 47 in which the reinforcement portion 46 is inserted. The positioning hole 47 is provided in the peripheral edge portion of the second mounting hole 33-A corresponding to the reinforcement portion 46 provided in the second mounting portion 31-A. More specifically, the positioning hole 47 is provided in the front-side portion (right portion illustrated in FIG. 19) in the slide direction associated with the mounting of the lamp clip 18-A in the peripheral edge portion of the second mounting hole 33-A, that is, the portion that is retained while sandwiched between the main body 27-A and the extending portion 31b-A of the second mounting portion 31-A in the state in which the lamp clip 18-A is mounted. The positioning hole 47 is opened to (communicated with) the second mounting hole 33-A. The positioning hole 47 is formed in the elongated rectangular shape corresponding to the reinforcement portion 46 along the slide direction of the lamp clip 18-A when viewed from above, and the short-side dimension and long-side dimension of the positioning hole 47 are substantially equal to or larger than those of the reinforcement portion 46. The positioning hole 47 is disposed at the substantially central position in the X-axis direction of the second mounting hole 33-A. Therefore, when the lamp clip 18-A is slid to be mounted, the reinforcement portion 46 is inserted in the positioning hole 47. The notch (not illustrated) corresponding to the positioning hole 47 is also formed in the reflecting sheet while opened to the peripheral edge portion of the second insertion hole.

In mounting the lamp clip 18-A having the above-described configuration on the chassis 14-A, when the lamp clip 18-A is slid from the state in which the mounting portions 30-A and 31-A are inserted in the mounting holes 32-A and 33-A, the reinforcement portions 44-A and 46 formed in the mounting portions 30-A and 31-A are inserted in the positioning holes 45-A and 47. Consequently, the lamp clip 18-A is positioned in the direction (X-axis direction) intersecting the slide direction by the reinforcement portions 44-A and 46 and positioning holes 45-A and 47, which are disposed at positions separated from each other in the slide direction.

As described above, according to the present embodiment, the reinforcement portion 46 is provided in the second mounting portion 31-A in addition to the first mounting portion 30-A, so that the reinforcement can also be achieved in the second mounting portion 31-A to reduce the breakage of the second mounting portion 31-A. Additionally, the lamp clip 18-A is more securely positioned because the positioning hole 47 in which the reinforcement portion 46 is inserted is provided in the chassis 14-A.

### Third Embodiment

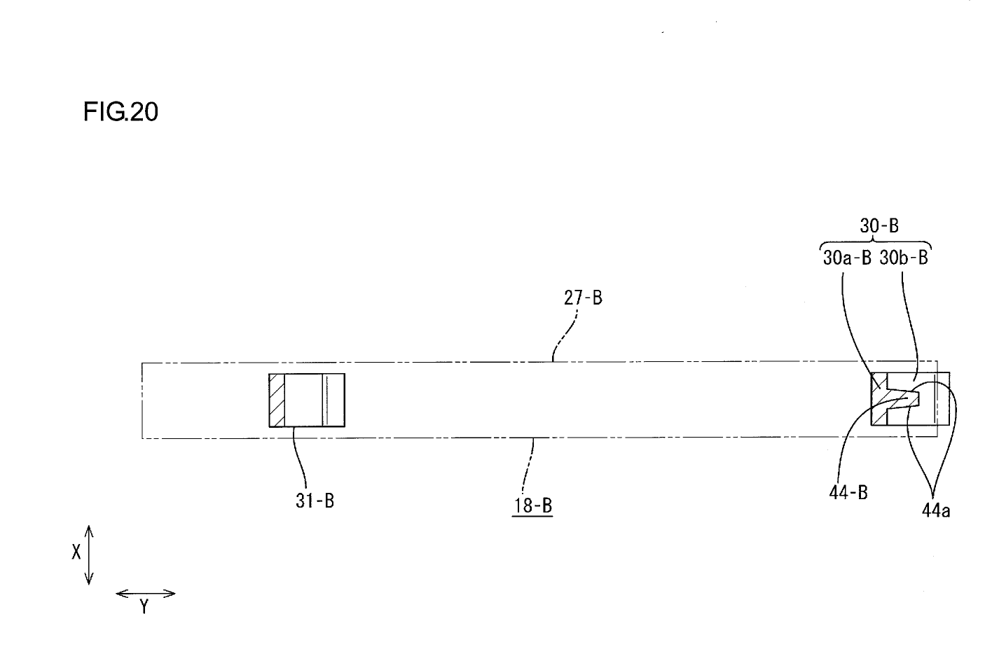

A third embodiment of the present invention will be described with reference to FIGS. 20 to 22. In the third embodiment, the structure of a reinforcement portion 44-B is changed. In the third embodiment, the region having the same name as the first embodiment is designated by the same numeral, a suffix “-B” is added to the ending of the numeral, and overlapping descriptions of the structure, action, and effect are omitted.

As illustrated in FIG. 20, the dimension in the X-axis direction (direction perpendicular to the slide direction and along a main body 27-B) of the reinforcement portion 44-B, that is, the width dimension is not kept constant, but the width dimension is formed so as to increase continuously and gradually toward the side of the base portion 30a-B. That is, the width dimension of the reinforcement portion 44-B decreases toward the end portion on the side in the direction (front side in the slide direction associated with the mounting) in which the extending portion 30b-B is projected, and the width dimension is increases toward the end portion on the side (rear side in the slide direction associated with the mounting) of the base portion 30a-B. In other words, the reinforcement portion 44-B is gradually thinned toward the distal end side of the extending portion 30b-B and gradually thickened toward the side of the base portion 30a. Both side surfaces of the reinforcement portion 44-B intersecting the surfaces of the main body 27-B and extending portion 30b-B, which are opposite to each other, become inclined surfaces 44a having gradients of obtuse angles with respect to the surface oriented toward the side (right illustrated in FIG. 20) of the base portion 30a-B in the direction in which the extending portion 30b-B is projected. The width dimension of the reinforcement portion 44-B is minimized in the end portion on the distal end side of the extending portion 30b-B and maximized in the end portion on the side of the base portion 30a-B.

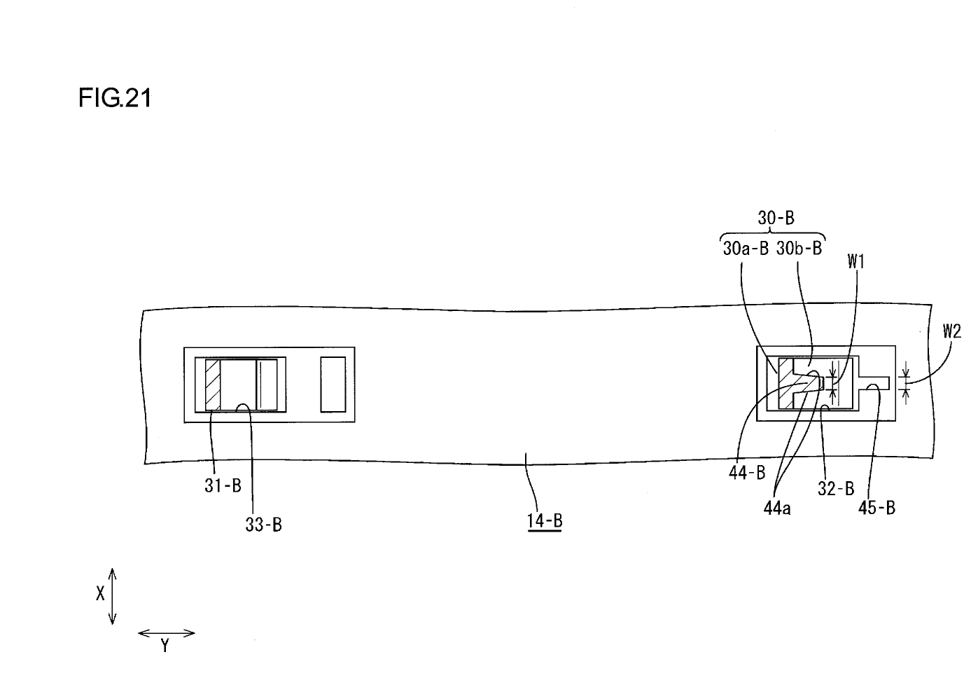

As illustrated in FIG. 21, a width dimension W1 of the reinforcement portion 44-B in the end portion on the side in the direction in which the extending portion 30b-B extends is substantially equal to or slightly smaller than the width W2 of the positioning hole 45-B that measures at a point where the positioning hole 45-B connects to the mounting hole 32-B. The width of the positioning hole 45-B is constant over the total length. Therefore, the reinforcement portion 44-B can be inserted in the positioning hole 45-B. Accordingly, the width dimension of the reinforcement portion 44-B is larger than the width W2 in the substantially whole area except the end portion on the side in the direction in which the extending portion 30b-B extends.

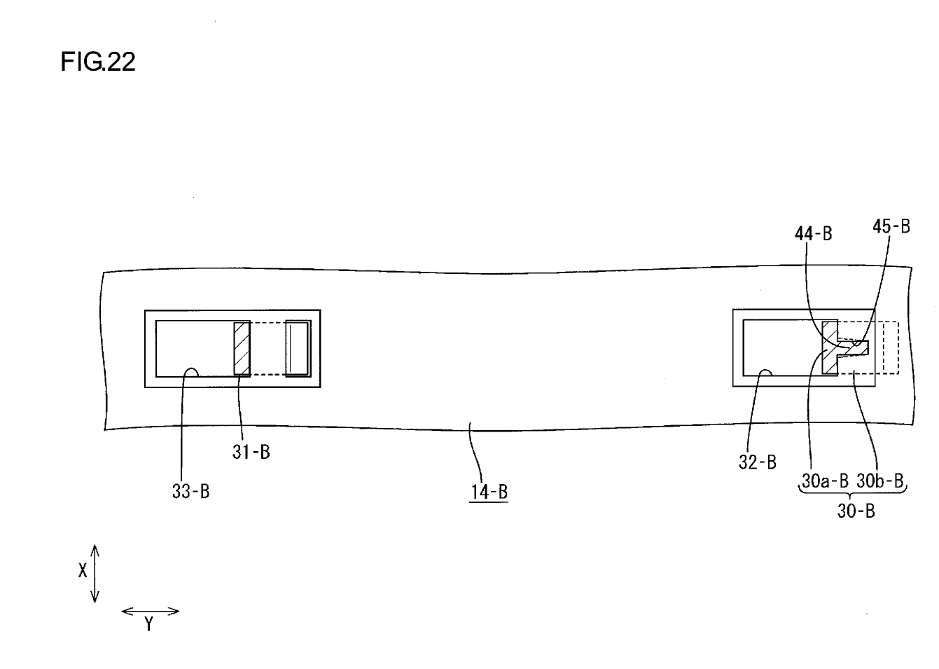

When, with the mounting of the lamp clip 18-B, the lamp clip 18-B is slid to the chassis 14-B from the state in which the mounting portion 30-B and 31-B are inserted in the mounting hole 32-B and 33-B as illustrated in FIG. 21, the reinforcement portion 44-B that continues to the first mounting portion 30-B is inserted in the positioning hole 45-B. At an initial stage of the sliding work, the end portion on the distal end side of the extending portion 30b-B in the reinforcement portion 44-B is inserted in the positioning hole 45-B with little resistance. Then, with the progress of the sliding work, the peripheral edge portion of the positioning hole 45-B starts to bite into the inclined surfaces 44a of the reinforcement portion 44-B. With the progress of the sliding work, a generated frictional resistance force increases continuously and gradually while a biting amount increases. Accordingly, the reinforcement portion 44-B is excellent in the workability. When the lamp clip 18-B is slid to the regular position, the peripheral edge portion of the positioning hole 45-B bites into the peripheral edge portion of the reinforcement portion 44-B as illustrated in FIG. 22, so that the force to retain the lamp clip 18-B can be improved by the frictional resistance force between the two sides.

As described above, according to the present embodiment, the reinforcement portion 44-B continues to the base portion 30a-B and at least one of the main body 27-B and the extending portion 30b-B, and the dimension of the reinforcement portion 44-B in the direction perpendicular to the slide direction with respect to the chassis 14-B and along the main body 27-B is formed so as to increase continuously and gradually toward the side of the base portion 30a-B. Therefore, the breakage of the first mounting portion 30-B is effectively reduced because the reinforcement portion 44-B that continues to the base portion 30a-B and at least one of the main body 27-B and the extending portion 30b-B is gradually thickened toward the side of the base portion 30a-B that continues to both the main body 27-B and the extending portion 30b-B.

The dimension of the reinforcement portion 44-B in the direction perpendicular to the slide direction with respect to the chassis 14-B and along the main body 27-B is formed larger than the width W2. When the lamp clip 18-B is slid to be mounted on the chassis 14-B while the first mounting portion 30-B is inserted in the first mounting hole 32-B, the peripheral edge portion of the positioning hole 45-B can bite into the reinforcement portion 44-B. Therefore, the lamp clip 18-B can be retained with the high retaining force.

The dimension of the reinforcement portion 44-B in the direction perpendicular to the slide direction with respect to the chassis 14-B and along the main body 27-B is formed so as to increase continuously and gradually toward the side of the base portion 30a-B. This configuration is excellent in the workability because the resistance force that is generated when the reinforcement portion 44-B bites into the peripheral edge portion of the positioning hole 45-B is small at the initial stage of the sliding work and tends to increase with the progress of the sliding work.

### Fourth Embodiment

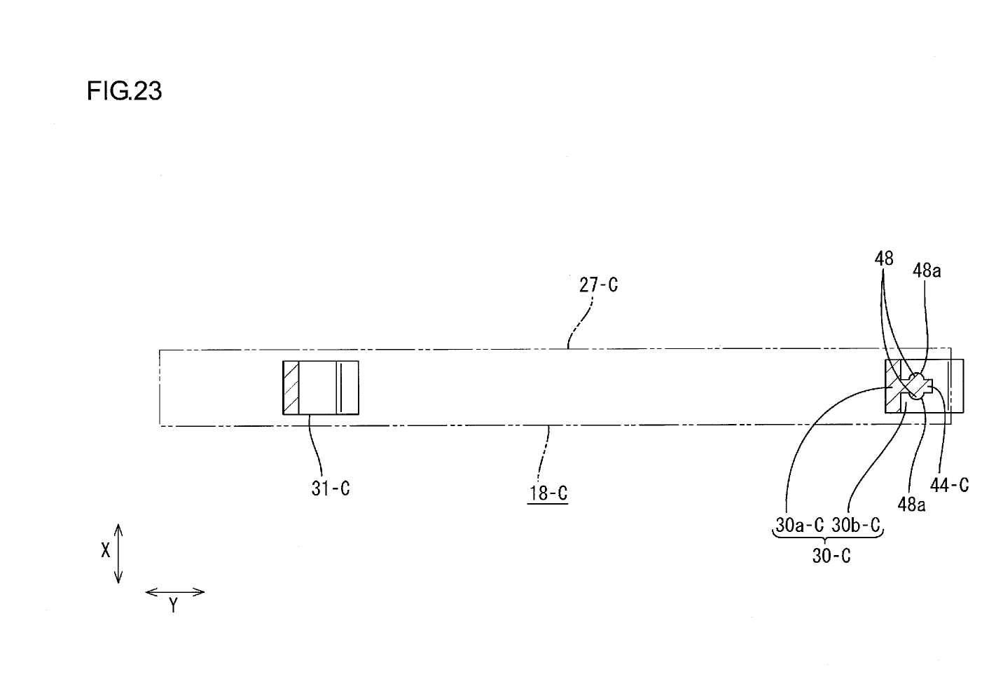

A fourth embodiment of the present invention will be described with reference to FIGS. 23 to 25. In the fourth embodiment, the structure of a reinforcement portion 44-C is further changed. In the fourth embodiment, the region having the same name as the first embodiment is designated by the same numeral, a suffix “-C” is added to the ending of the numeral, and overlapping descriptions of the structure, action, and effect are omitted.

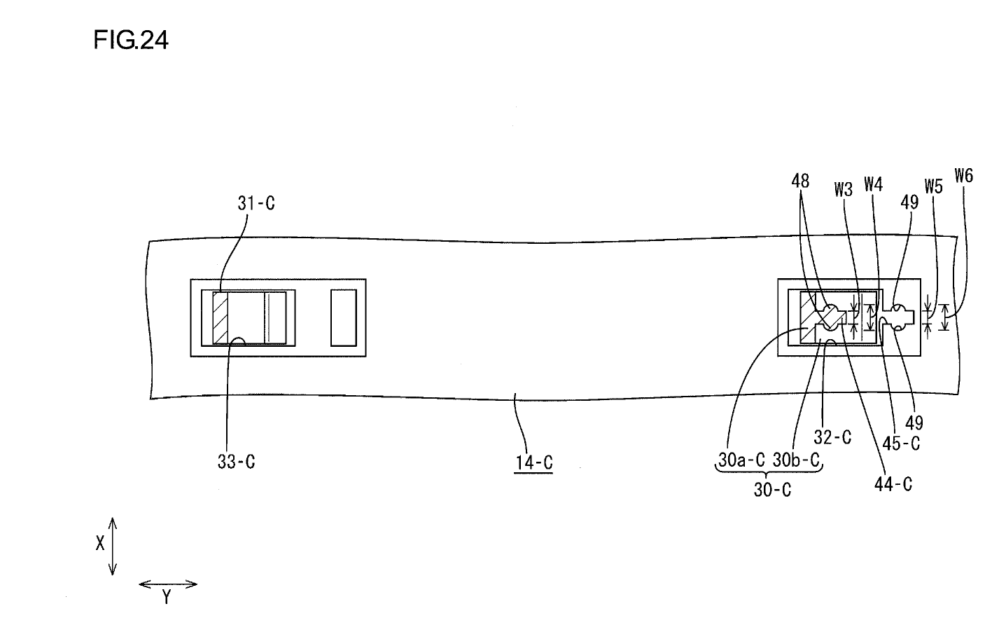

As illustrated in FIG. 23, the dimension of the reinforcement portion 44-C in the X-axis direction (direction perpendicular to the slide direction and along a main body 27-C), that is, the width dimension is not kept constant, but the reinforcement portion 44-C includes a latching rib 48 that is partially widened in midstream. A pair of the latching ribs 48 is formed so as to hang over in the X-axis direction from both side surfaces of the reinforcement portion that intersect the surfaces of the main body 27-B and extending portion 30b-B, which are opposite to each other. The latching ribs 48 are disposed at intermediate positions in the length direction of the reinforcement portion 44-C. Therefore, the reinforcement portion 44-C has the shape in which the reinforcement portion 44-C is partially widened at the intermediate position in the length direction. The sectional shape of each of the latching ribs 48 is a substantially semicircular shape when the latching rib 48 is cut in the X-axis direction and the Y-axis direction, and the circumferential surface of the latching rib 48 becomes an arc curved surface 48a. The latching ribs 48 also continue to the main body 27-C and the extending portion 30b-C. The width dimension of the reinforcement portion 44-C is kept constant and minimized to a width W3 out of the range where the latching ribs 48 are formed. On the other hand, within the range where the latching ribs 48 are formed, the width dimension of the reinforcement portion 44-C becomes the maximum width W4 at the central position while varying in the Y-axis direction (FIG. 24). In particular, within the range where the latching ribs 48 are formed, the width dimension of the reinforcement portion 44-C is minimized at both end positions in the Y-axis direction and tends to increase gradually toward the central position from the end position.

On the other hand, as illustrated in FIG. 24, a latching hole 49 in which the latching rib 48 is inserted is provided while not opened to the first mounting hole 32-C but opened only to the positioning hole 45-C in the portion (front-side portion in the slide direction associated with the mounting), of the peripheral edge portion of the first mounting hole 32-C, that is retained while sandwiched between the extending portion 30b-C and the main body 27-C in the state in which the lamp clip 18-C is mounted. A pair of the latching holes 49 is provided while opened to the surface along the Y-axis direction (slide direction) in the circumferential surface of the positioning hole 45-C. A width W6 between the latching holes 49 is larger than the width dimension of the positioning hole 45-C, which is kept constant, that is, the width W5 of the positioning hole 45-C that measures at a point where the positioning hole 45-C connects to the first mounting hole 32-C. The width W6 between the latching holes is substantially equal to or slightly smaller than the maximum value W4 of the width dimension in the reinforcement portion 44-C. The width W5 is substantially equal to or slightly smaller than the minimum value W3 of the width dimension in the reinforcement portion 44-C.

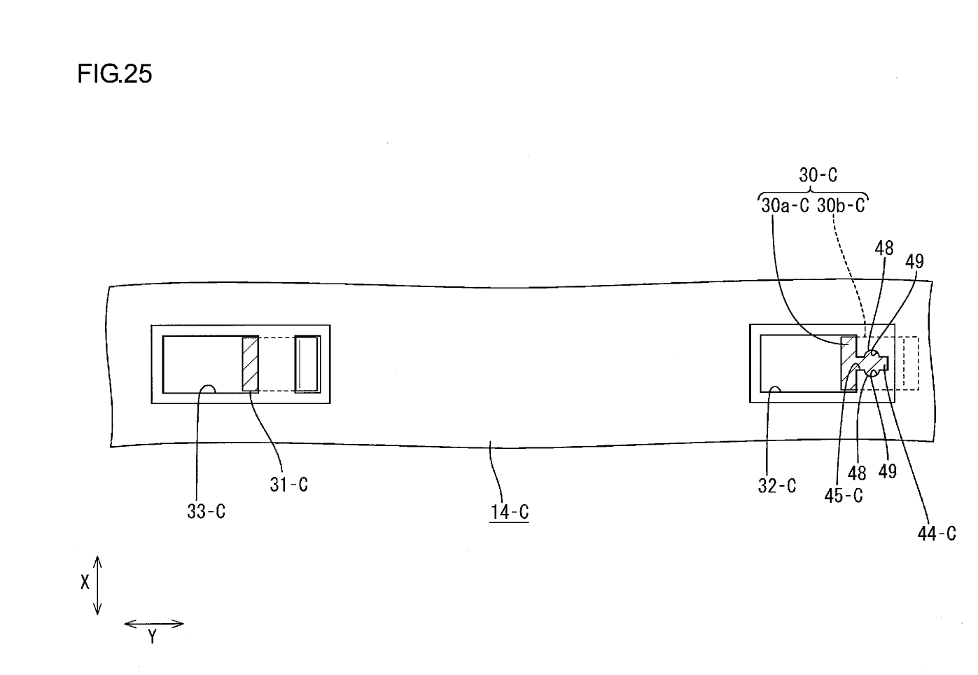

When, with the mounting of the lamp clip 18-C, the lamp clip 18-C is slid to the chassis 14-C from the state in which the mounting portion 30-C and 31-C are inserted in the mounting hole 32-C and 33-C as illustrated in FIG. 24, the reinforcement portion 44-C that continues to the first mounting portion 30-C is inserted in the positioning hole 45-C. At the initial stage of the sliding work, the end portion on the distal end side of the extending portion 30b-C in the reinforcement portion 44-C is inserted in the positioning hole 45-C with little resistance. When the latching ribs 48 pass through the opening to the first mounting hole 32-C in the positioning hole 45-C, the opening edge of the positioning hole 45-C bites into the latching ribs 48 to generate the frictional resistance force. At this point, the circumferential surfaces of the latching ribs 48 are formed by the curved surfaces 48a, so that the biting amount, that is, the frictional resistance tends to increase continuously and gradually with the progress of the work. Accordingly, the workability is made to be excellent. When the lamp clip 18-C is slid to the regular position, the circumferential surfaces of the latching ribs 48 and latching holes 49 are latched in each other while the latching ribs 48 are inserted in the latching holes 49 as illustrated in FIG. 25, so that the force to retain the lamp clip 18-C can be improved.

As described above, according to the present embodiment, the reinforcement portion 44-C is formed while continuing to at least the main body 27-C and the extending portion 30b-C, and the latching ribs 48 that continue to the main body 27-C and the extending portion 30b-C are provided while hanging over in the side surface of the reinforcement portion 44-C. Therefore, the further reinforcement of the first mounting portion 30-C can be achieved by the latching ribs 48 that continue to the main body 27-C and the extending portion 30b-C.

The latching hole 49 is provided in the edge portion of the first mounting hole 32-C of the chassis 14-C. It is provided in the edge portion that is sandwiched between the extending portion 30b-C and the main body 27-C when the lamp clip 18-C is mounted. It continues to the positioning hole 45-C and separated from the mounting hole 32-C. The reinforcement portion 44-C includes the latching rib 48 that is inserted in the latching hole 49 as the lamp clip 18-C is mounted to the chassis 14-C and held to the wall of the latching hole 49. With the mounting of the lamp clip 18-C, the latching rib 48 is inserted in the latching hole 49, and the latching rib 48 can be held to the wall of the latching hole 49. Therefore, the lamp clip 18-C can be retained with the higher retaining force.

### Fifth Embodiment

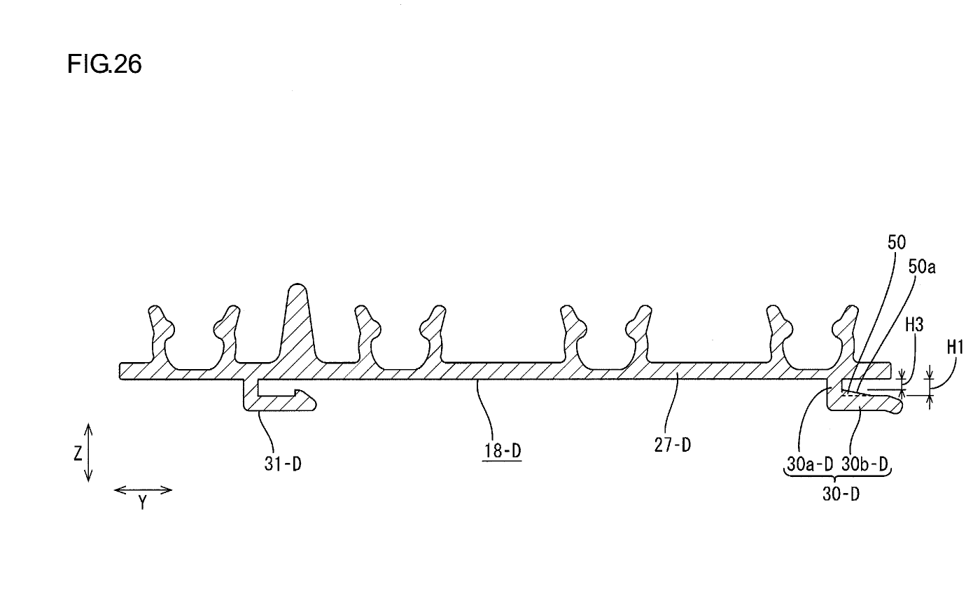

A fifth embodiment of the present invention will be described with reference to FIGS. 26 to 29. In the fifth embodiment, the positioning hole is removed while the disposition of a reinforcement portion 50 is changed. In the fifth embodiment, the region having the same name as the first embodiment is designated by the same numeral, a suffix “-D” is added to the ending of the numeral, and overlapping descriptions of the structure, action, and effect are omitted.

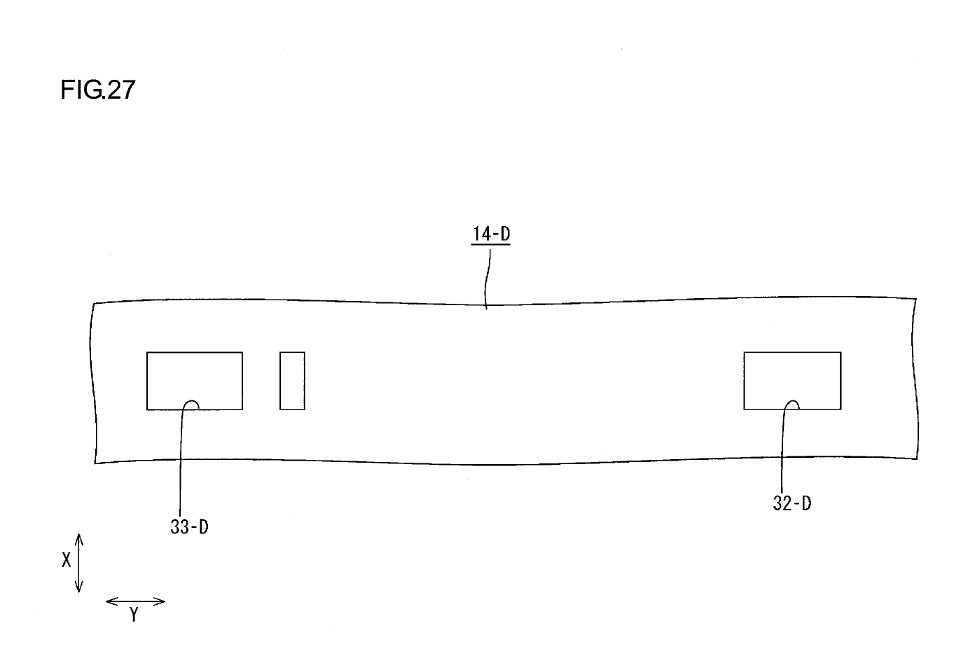

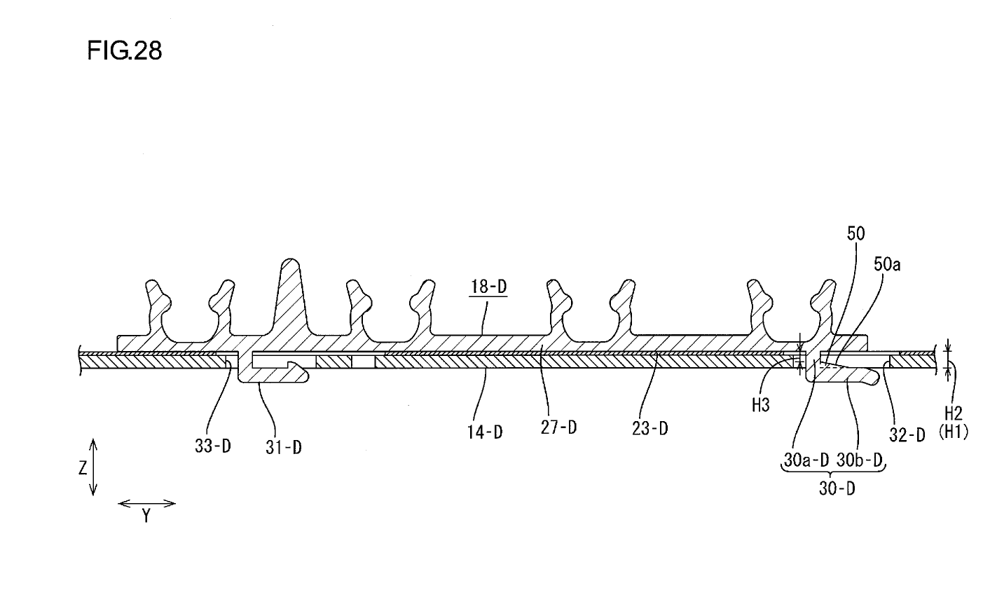

As illustrated in FIG. 26, the reinforcement portion 50 is configured not to continue to a main body 27-D but to continue only to the base portion 30a-D and the extending portion 30b-D in the first mounting portion. The reinforcement portion 50 is configured to continue to the surfaces of the base portion 30a-D and extending portion 30b-D, which intersect each other. More specifically, the reinforcement portion 50 continues to the surface of the base portion 30a-D oriented toward the direction in which the extending portion 30b-D is projected and the surface of the extending portion 30b-D that is opposite to the main body 27-D, and the reinforcement portion 50 continues to the base portion 30a-D and the extending portion 30b-D in the seamless manner. The sectional shape of the reinforcement portion 50 is a substantially triangular shape when the reinforcement portion 50 is cut along the Y-axis direction and the Z-axis direction, and the surface that is opposite to the main body 27-D is formed in an inclined surface 50a. The inclined surface 50a has a gradient of obtuse angle with respect to the surface of the base portion 30a-D oriented toward the side (right illustrated in FIG. 26) in the direction in which the extending portion 30b-D is projected. Accordingly, a gap between the reinforcement portion 50 and the main body 27-D increases continuously and gradually from the side of the base portion 30a-D toward the end portion side (front side in the slide direction associated with the mounting) in the direction in which the extending portion 30b-D is projected, and the gap decreases continuously and gradually toward the side of the base portion 30a-D from the end portion side in the direction in which the extending portion 30b-D is projected. A gap H1 between the main body 27-D and the extending portion 30b-D is substantially equal to a size H2 obtained by adding the thickness of the chassis 14-D and the thickness of the reflecting sheet 23-D. On the other hand, the gap between the reinforcement portion 50 and the main body 27-D is smaller than the size obtained by adding the thickness of the chassis 14-D and the thickness of the reflecting sheet 23-D, and the gap becomes the minimum value H3 in the end portion of the reinforcement portion 50 on the side of the base portion 30a-D (FIG. 28). On the other hand, as illustrated in FIG. 27, the positioning hole of the first embodiment is removed from the peripheral edge portion of the first mounting hole 32-D in the chassis 14-D.

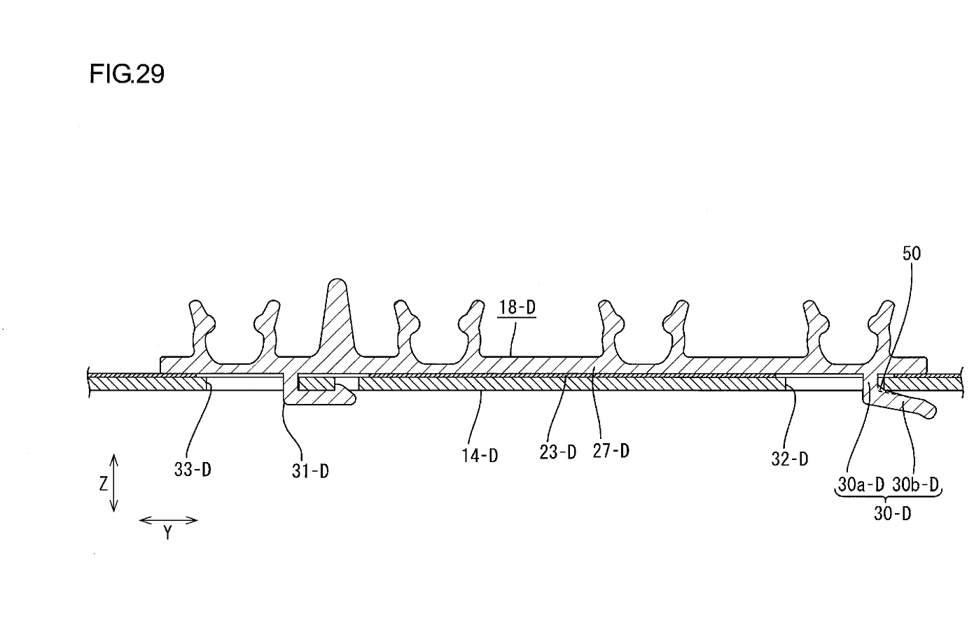

With the mounting of the lamp clip 18-D, the lamp clip 18-D is slid to the chassis 14-D from the state in which the mounting portion 30-D and 31-D are inserted in the mounting hole 32-D and 33-D as illustrated in FIG. 28. When the extending portion 30b-D of the first mounting portion 30-D proceeds in the backside of the peripheral edge portion of the first mounting hole 32-D by a predetermined length with little resistance, the peripheral edge portion of the first mounting hole 32-D starts to bite into the reinforcement portion 50. With the progress of the sliding work, the biting amount of the peripheral edge portion of the first mounting hole 32-D to the reinforcement portion 50 increases, and the generated frictional resistance force increases gradually. Accordingly, this configuration is excellent in the workability. During the process, the extending portion 30b-D is elastically deformed. When the lamp clip 18-D is slid to the regular position, the peripheral edge portion of the first mounting hole 32-D bites into the reinforcement portion 50, and the peripheral edge portion of the first mounting hole 32-D is retained while sandwiched between the elastically-deformed extending portion 30b-D and the main body 27-D as illustrated in FIG. 29, so that the high retaining force can be obtained.

As described above, according to the present embodiment, the reinforcement portion 50 continues to the base portion 30a-D and one of the main body 27-D and the extending portion 30b-D, and the reinforcement portion 50 abuts on the peripheral edge portion of the first mounting hole 32-D in the chassis 14-D while the lamp clip 18-D is mounted, and the gap H3 between the reinforcement portion 50 and the other side of the main body 27-D and the extending portion 30b-D is smaller than the thickness H1 of the chassis 14-D including the reflecting sheet 23-D. When the lamp clip 18-D is slid to be mounted on the chassis 14-D while the first mounting portion 30-D is inserted in the first mounting hole 32-D, the reinforcement portion 50 abuts on the peripheral edge portion of the first mounting hole 32-D, the first mounting portion 30-D or the main body 27-D is deformed, and the peripheral edge portion of the first mounting hole 32-D bites into the reinforcement portion 50. Therefore, the lamp clip 18-D can be retained with the high retaining force.

The reinforcement portion 50 is formed such that the gap between the reinforcement portion 50 and the other side of the main body 27-D and the extending portion 30b-D decreases continuously and gradually toward the side of the base portion 30a-D. This configuration is excellence in the workability because the resistance force that is generated when the reinforcement portion 50 bites into the peripheral edge portion of the first mounting hole 32-D tends to be small at the initial stage of the sliding work and tends to increase gradually associated with the progress of the sliding work.

The reinforcement portion 50 continues to at least two portions, which continue to each other, of the main body 27-D, the base portion 30a-D, and the extending portion 30b-D. The reinforcement portion 50 continues directly to at least two portions, which continue to each other, of the main body 27-D, the base portion 30a-D, and the extending portion 30b-D, which allows the high reinforcement effect to be obtained to effectively reduce the breakage of the first mounting portion 30-D.

The reinforcement portion 50 continues to at least the base portion 30a-D and the extending portion 30b-D. Therefore, the base portion 30a-D and the extending portion 30b-D continue directly to each other by the reinforcement portion 50, so that the breakage is less likely to occur between the base portion 30a-D and the extending portion 30b-D.

### Sixth Embodiment

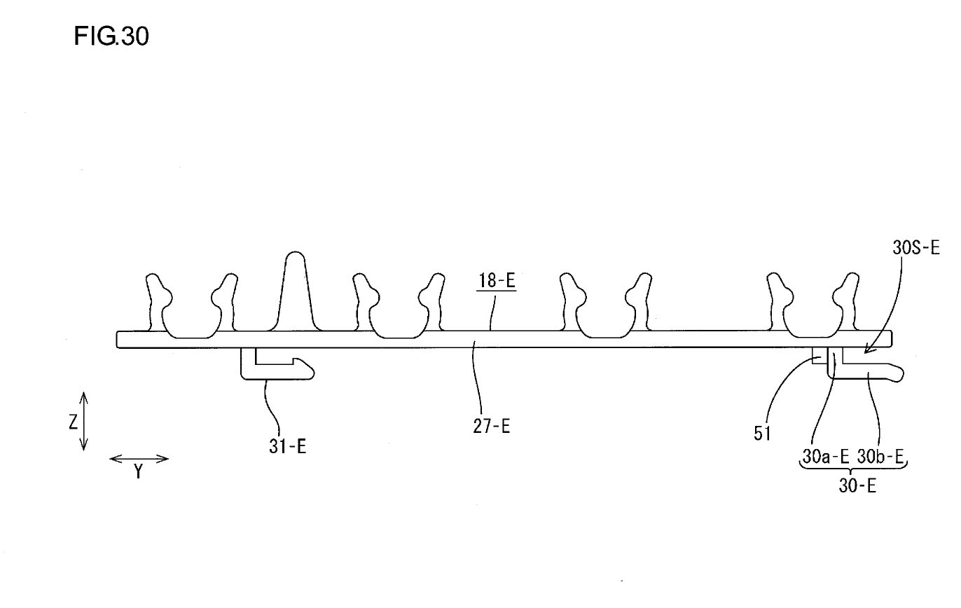

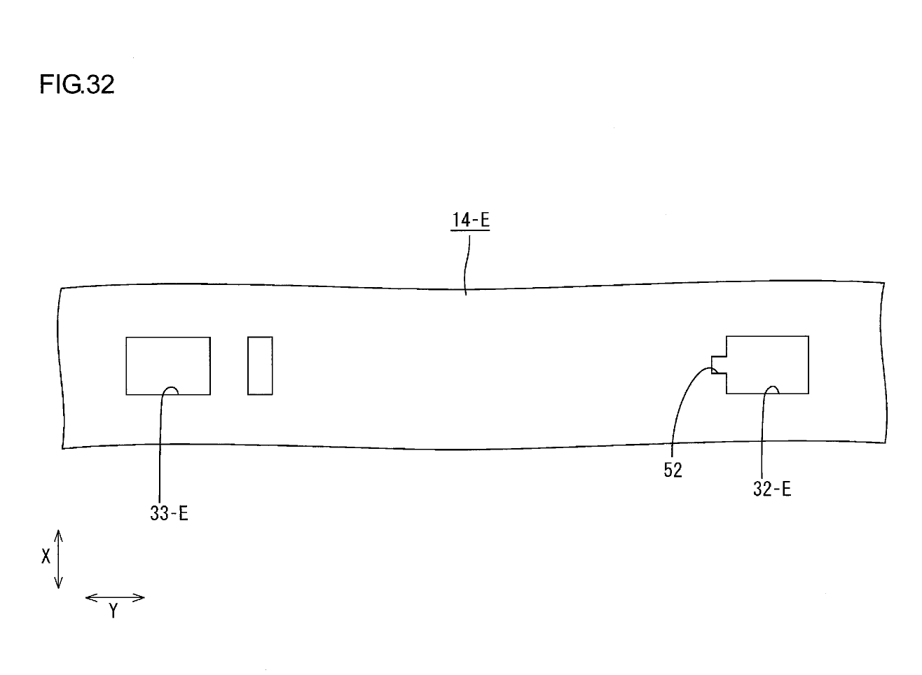

A sixth embodiment of the present invention will be described with reference to FIGS. 30 to 37. In the sixth embodiment, the disposition of a reinforcement portion 51 is changed. In the sixth embodiment, the region having the same name as the first embodiment is designated by the same numeral, a suffix “-E” is added to the ending of the numeral, and overlapping descriptions of the structure, action, and effect are omitted.

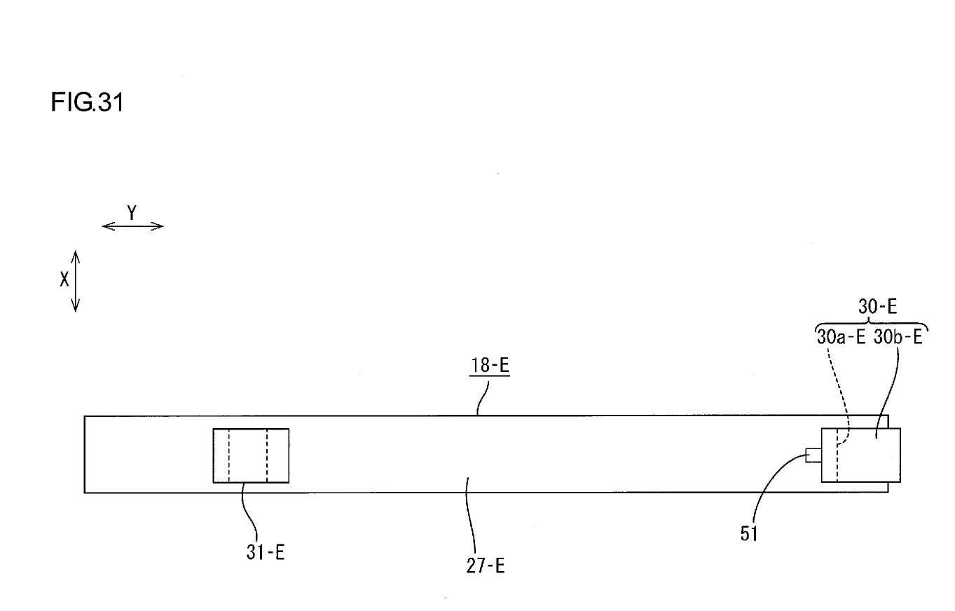

As illustrated in FIGS. 30 and 31, the reinforcement portion 51 continues not to an extending portion 30b-E constituting a first mounting portion 30-E, but to a base portion 30a-E and a main body 27-E. The reinforcement portion 51 is disposed out of the range where the first mounting portion 30-E is formed (out of a space 30S-E surrounded by the main body 27-E, the base portion 30a-E, and the extending portion 30b-E) in the X-axis direction (direction perpendicular to the slide direction and along the main body 27-E) and the Y-axis direction (slide direction). The reinforcement portion 51 is projected outward from the outer circumference end of the first mounting portion 30-E when viewed from above. More specifically, the reinforcement portion 51 is disposed on the side of the base portion 30a-E opposite to the extending portion 30b-E in the Y-axis direction, that is, at the position that is away from the extending portion 30b-E with an angle interval of 180 degrees. In other words, the reinforcement portion 51 is disposed on the rear side of the base portion 30a-E in the slide direction associated with the mounting. The reinforcement portion 51 continues to the surface of the base portion 30a-E oriented toward the side opposite to the side of the extending portion 30b-E and the surface on the backside in the main body 27-E, and the reinforcement portion 51 continues to the main body 27-E and the base portion 30a-E in the seamless manner. The reinforcement portion 51 continues to the main body 27-E and base portion 30a-E that continue to each other. The reinforcement portion 51 is formed in a substantially block shape and disposed at the central position of the first mounting portion 30-E in the X-axis direction. In the configuration according to the present embodiment, the reinforcement portion 51 does not exist between the extending portion 30b-E and the main body 27-E. The dimensions in the Y-axis directions of the first mounting portion 30-E and the second mounting portion 31-E are substantially equal to each other.

On the other hand, a reinforcement-portion insertion hole 52 is provided in the peripheral edge portion of the first mounting hole 32-E in the chassis 14-E. The reinforcement portion 51 can be inserted in the reinforcement-portion insertion hole 52 only when a lamp clip 18-E is placed in a predetermined orientation. More specifically, in the peripheral edge portion of the first mounting hole 32-E, the reinforcement-portion insertion hole 52 is provided on the side opposite to the portion that is retained while sandwiched between the extending portion 30b-E and the main body 27-E in the state in which the lamp clip 18-E is mounted, that is, the reinforcement-portion insertion hole 52 is provided at the position that is away from the portion with the angle interval of 180 degrees. The reinforcement-portion insertion hole 52 connects to the first mounting hole 32-E. In other words, the reinforcement-portion insertion hole 52 is provided in the rear-side portion in the slide direction associated with the mounting in the peripheral edge portion of the first mounting hole 32-E. The reinforcement-portion insertion hole 52 is formed in a quadrangular shape corresponding to the reinforcement portion when viewed from above, the dimensions in the X-axis direction and Y-axis direction of the reinforcement-portion insertion hole 52 are set substantially equal to or slightly larger than those of the reinforcement portion 51, which allows the reinforcement portion 51 to be inserted in the reinforcement-portion insertion hole 52. The dimensions in the Y-axis directions of the first mounting hole 32-E and second mounting hole 33-E are substantially equal to each other and substantially equal to those of the first mounting portion 30-E and second mounting portion 31-E.

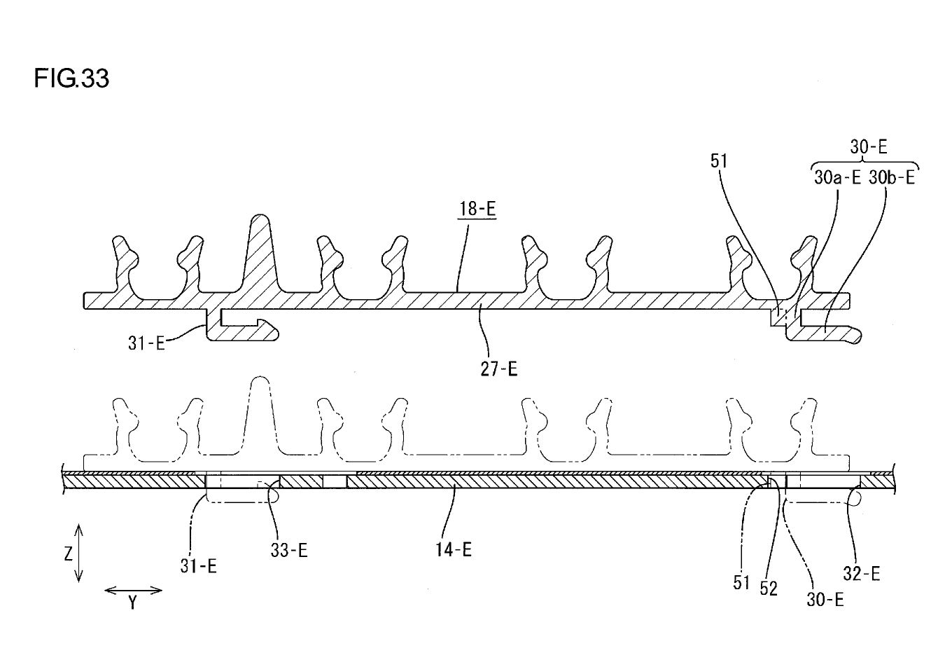

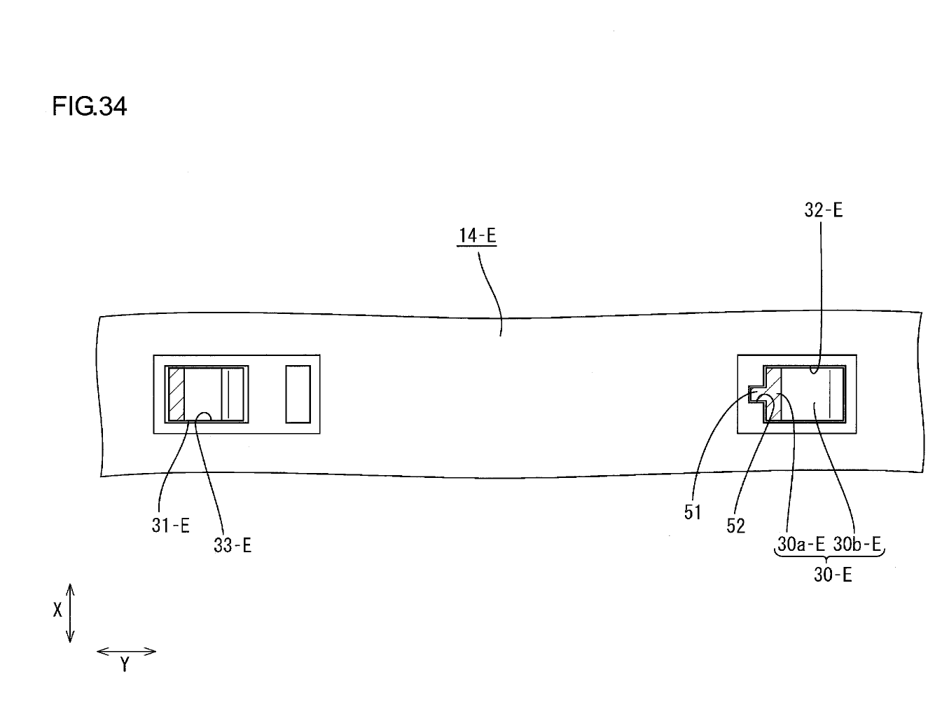

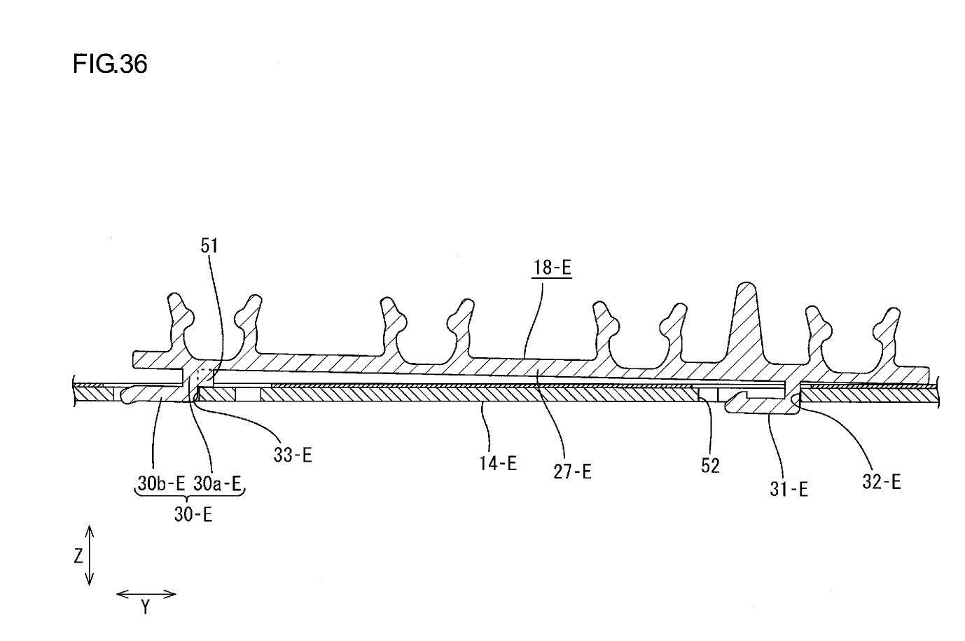

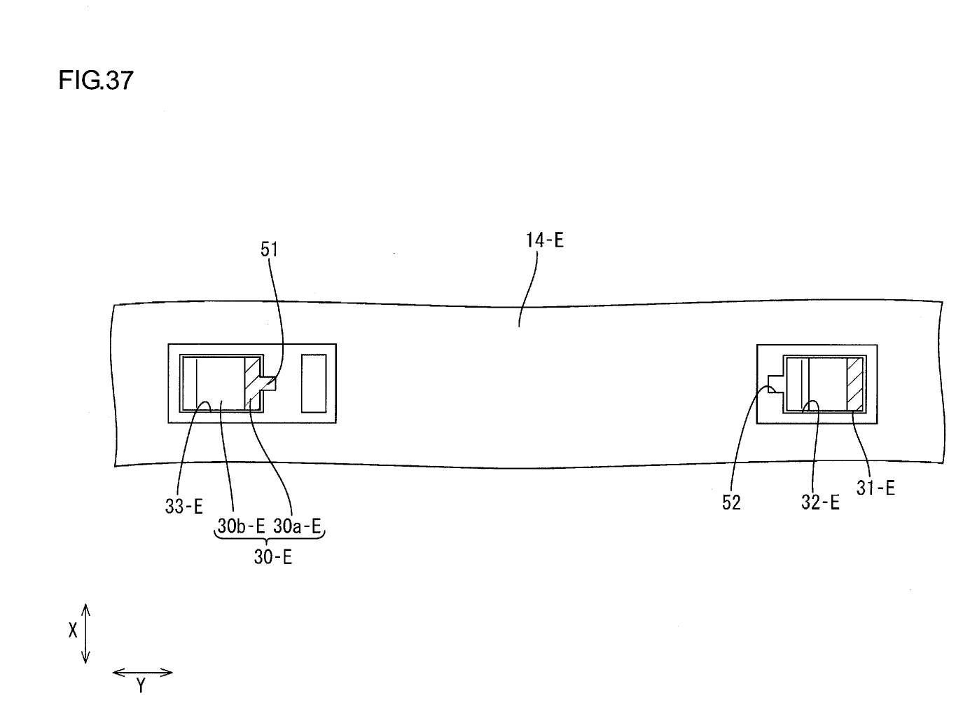

In mounting the lamp clip 18-E on the chassis 14-E, while the long-side direction of the main body 27-E is aligned with the short-side direction of the chassis 14-E, the mounting portions 30-E and 31-E are inserted in the mounting holes 32-E and 33-E located at the positions at which the chassis 14-E should be mounted. At this point, the lamp clip 18-E can take either a first state (FIGS. 33 and 34) or a second state (FIG. 36 and FIG. 37). In the first state, the first mounting portion 30-E and the second mounting portion 31-E are aligned in the first mounting hole 32-E and the second mounting hole 33-E, respectively. In the second state, the first mounting portion 30-E and the second mounting portion 31-E are aligned in the second mounting hole 33-E and the first mounting hole 32-E, respectively. The second state is obtained by rotation of the first state about the central position of the main body 27-E by 180 degrees. In the present embodiment, the reinforcement portion 51 fits in the reinforcement-portion insertion hole 52 only when the lamp clip 18-E is in the first state. The case in which the lamp clip 18-E is in the first state will first be described.

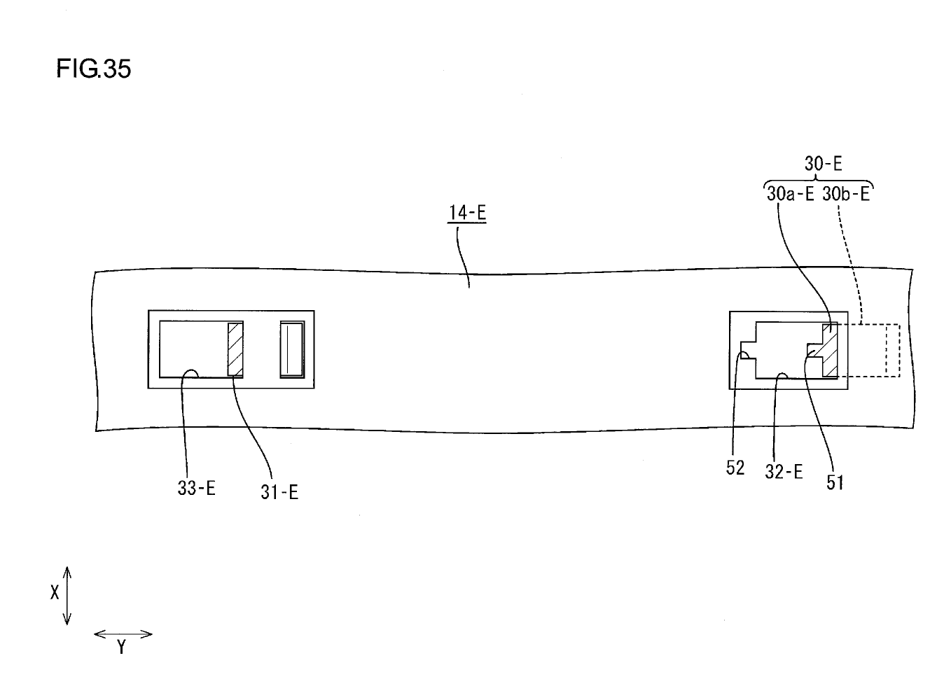

When the lamp clip 18-E is pushed into the chassis 14-E in the first state in which the first mounting portion 30-E is aligned in the first mounting hole 32-E while the second mounting portion 31-E is aligned in the second mounting hole 33-E, the reinforcement portion 51 does not fit in the reinforcement-portion insertion hole 52 as illustrated in FIGS. 33 and 34. Therefore, the reinforcement portion 51 is inserted in the reinforcement-portion insertion hole 52 without interfering in the peripheral edge portion of the first mounting hole 32-E, and the extending portions 30b-E and 31b-E of the mounting portions 30-E and 31-E reach the backside of the chassis 14-E through the mounting holes 32-E and 33-E. When the lamp clip 18-E is slid from the state above, the peripheral edge portions of the mounting holes 32-E and 33-E are retained while sandwiched between the extending portions 30b-E and 31b-E and the main body 27-E as illustrated in FIG. 35, thereby maintaining the lamp clip 18-E in the mounted state. At this point, the reinforcement portion 51 is provided in the first mounting hole 32-E.

On the other hand, when the lamp clip 18-E is in the second state that is reverse the first state, and the first mounting portion 30-E is aligned in the second mounting hole 33-E, the second mounting portion 31-E is aligned in the first mounting hole 32-E, the reinforcement portion 51 does not fit in the reinforcement-portion insertion hole 52. Accordingly, even if the lamp clip 18-E is pushed into the chassis 14-E, the reinforcement portion 51 interferes in and runs over the peripheral edge portion of the second mounting hole 33-E as illustrated in FIGS. 36 and 37, which controls the operation to push the lamp clip 18-E. At this point, the whole of the lamp clip 18-E is inclined with respect to the bottom plate of the chassis 14-E, the base portions 30a-E and 31a-E interfere in the circumferential surfaces of the mounting holes 32-E and 33-E even if the lamp clip 18-E is slid to the right illustrated in FIG. 36, which controls the slide operation. Therefore, the worker can easily recognize that the orientation of the lamp clip 18-E is in the false state that is different from the regular state. This enables the lamp clip 18-E to securely be mounted on the chassis 14-E in a given state.

There is possibly generated a third state (not illustrated) in mounting the lamp clip 18-E on the chassis 14-E. In the third state, the lamp clip 18-E is rotated by 180 degrees from the first state, the lamp clip 18-E deviates from the position at which the lamp clip 18-E should be mounted in the length direction of the main body 27-E, and the first mounting portion 30-E is aligned in the first mounting hole 32-E. Even in such cases, the reinforcement portion 51 does not fit in the reinforcement-portion insertion hole 52, and the reinforcement portion 51 interferes in the portion that is opposite to the reinforcement-portion insertion hole 52 in the peripheral edge portion of the first mounting hole 32-E, thereby controlling the mounting of the lamp clip 18-E.

As described above, according to the present embodiment, the reinforcement portion 51 is disposed out of a space 30S-E surrounded by the main body 27-E, the base portion 30a-E, and the extending portion 30b-E. Although, in the state in which the lamp clip 18-E is mounted on the chassis 14-E, the peripheral edge portion of the first mounting hole 32-E is retained while sandwiched between the extending portion 30b-E and the main body 27-E, the reinforcement portion 51 is disposed out of the space 30S-E surrounded by the main body 27-E, the base portion 30a-E, and the extending portion 30b-E. Therefore, an abutment area of the extending portion 30b-E on the peripheral edge portion of the first mounting hole 32-E can sufficiently be secured to obtain the high retaining force.

The reinforcement portion 51 is disposed out of the space 30S-E surrounded by the main body 27-E, the base portion 30a-E, and the extending portion 30b-E. On the other hand, the reinforcement-portion insertion hole 52 is provided in the chassis 14-E. Although the reinforcement portion 51 is inserted in the reinforcement-portion insertion hole 52 when the lamp clip 18-E is mounted on the chassis 14-E in a specific state, the reinforcement portion 51 does not fit in the reinforcement-portion insertion hole 52 when the lamp clip 18-E is in a state different from the specific state. Therefore, when the lamp clip 18-E is mounted on the chassis 14-E in the specific state, the reinforcement portion 51 is inserted in the reinforcement-portion insertion hole 52, thereby permitting the mounting. On the other hand, when the lamp clip 18-E is in the state different from the specific state, the reinforcement portion 51 does not fit in the reinforcement-portion insertion hole 52, and the mounting is controlled. Therefore, the lamp clip 18-E can securely be mounted on the chassis 14-E in the predetermined state.

A pair of the mounting portions 30-E and 31-E is provided in the main body 27-E, and the mounting portions 30-E and 31-E constitute the first mounting portion 30-E and the second mounting portion 31-E. On the other hand, a pair of the mounting holes 32-E and 33-E is provided in the chassis 14-E, and the mounting holes 32-E and 33-E constitute the first mounting hole 32-E corresponding to the first mounting portion 30-E and the second mounting hole 33-E corresponding to the second mounting portion 31-E. In at least one (first mounting portion 30-E) of the mounting portions 30-E and 31-E, the reinforcement portion 51 is provided out of the space 30S-E surrounded by the main body 27-E, the base portion 30a-E, and the extending portion 30b-E. The reinforcement-portion insertion hole 52 is provided in the chassis 14-E. Although the reinforcement portion 51 is inserted in the reinforcement-portion insertion hole 52 when the first mounting portion 30-E is aligned in the first mounting hole 32-E while the second mounting portion 31-E is aligned in the second mounting hole 33-E, the reinforcement portion 51 does not fit in the reinforcement-portion insertion hole 52 when the first mounting portion 30-E is aligned in the second mounting hole 33-E while the second mounting portion 31-E is aligned in the first mounting hole 32-E. Therefore, when the lamp clip 18-E is mounted on the chassis 14-E in the state in which the first mounting portion 30-E is aligned in the first mounting hole 32-E while the second mounting portion 31-E is aligned in the second mounting hole 33-E, the reinforcement portion 51 is inserted in the reinforcement-portion insertion hole 52, thereby permitting the mounting. On the other hand, when the first mounting portion 30-E is aligned in the second mounting hole 33-E while the second mounting portion 31-E is aligned in the first mounting hole 32-E, the reinforcement portion 51 does not fit in the reinforcement-portion insertion hole 52, and the reinforcement portion 51 cannot be inserted in the reinforcement-portion insertion hole 52. As a consequence, the mounting is controlled.

The reinforcement portion 51 continues to the main body 27-E and at least one of the base portion 30a-E and the extending portion 30b-E. Therefore, the reinforcement can be achieved between the first mounting portion 30-E and the main body 27-E. The stress concentration is easily generated between the first mounting portion 30-E and the main body 27-E compared with the region between the base portion 30a-E and extending portion 30b-E, which are of the constituents of the first mounting portion 30-E. The breakage of the first mounting portion 30-E is effectively reduced by reinforcing the region between the first mounting portion 30-E and the main body 27-E.

The reinforcement portion 51 continues to at least two portions, which continue to each other, of the main body 27-E, the base portion 30a-E, and the extending portion 30b-E. Thus, the reinforcement portion 51 continues directly to at least two portions, which continue to each other, of the main body 27-E, the base portion 30a-E, and the extending portion 30b-E, which allows the high reinforcement effect to be obtained to effectively reduce the breakage of the first mounting portion 30-E.

The reinforcement portion 51 continues to at least the base portion 30a-E and the main body 27-E. The stress concentration is easily generated particularly between the base portion 30a-E and the main body 27-E. Therefore, the reinforcement portion 51 continues directly to the base portion 30a-E and the main body 27-E. Therefore, the high reinforcement effect is obtained and the breakage of the first mounting portion 30-E can be effectively reduced.

### Seventh Embodiment

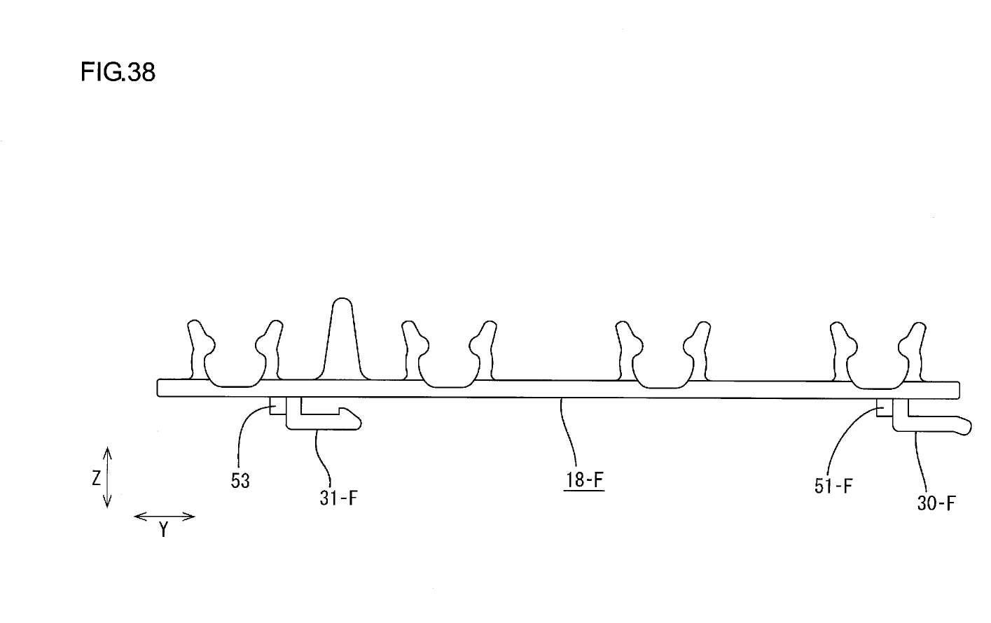

A seventh embodiment of the present invention will be described with reference to FIGS. 38 to 42. In the seventh embodiment, a reinforcement portion 53 is provided in the second mounting portion 31-F of the sixth embodiment. In the seventh embodiment, the region having the same name as the first embodiment is designated by the same numeral, a suffix “-F” is added to the ending of the numeral, and overlapping descriptions of the structure, action, and effect are omitted.

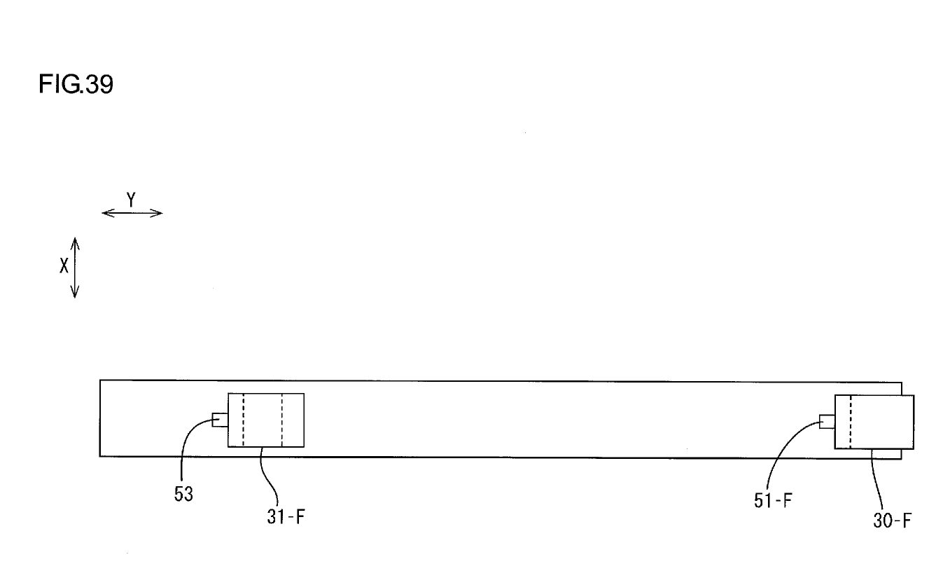

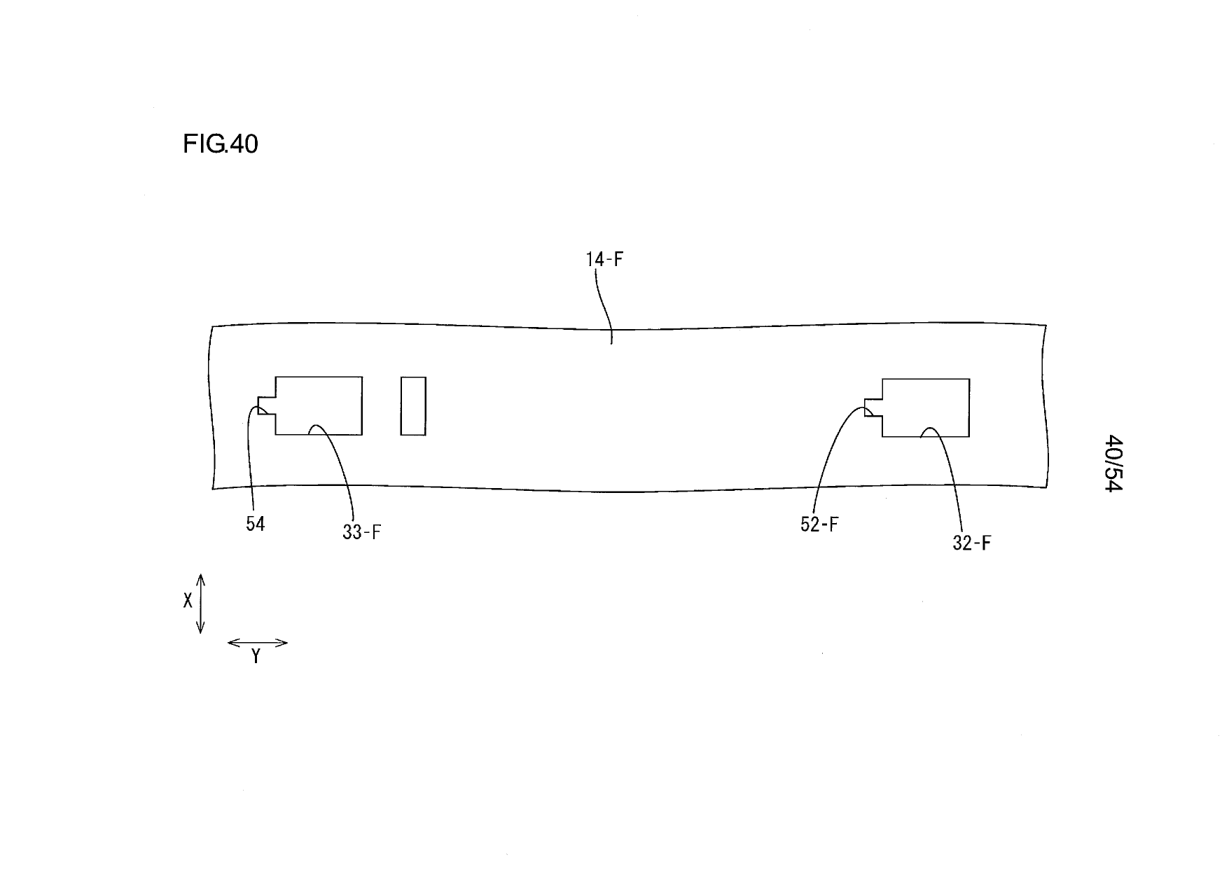

As illustrated in FIGS. 38 and 39, the reinforcement portion 53 similar to that on the side of a first mounting portion 30-F is provided in a second mounting portion 31-F. Because the reinforcement portion 53 has the configuration similar to that of the reinforcement portion 51-F of the first mounting portion 30-F illustrated in the sixth embodiment, the overlapping description is omitted. On the other hand, as illustrated in FIG. 40, a reinforcement-portion communication hole 54 similar to that on the side of a first mounting hole 32-F is provided in a peripheral edge portion of a second mounting hole 33-F in a chassis 14-F while opened to the second mounting hole 33-F. Because the reinforcement-portion communication hole 54 has the configuration similar to that of the insertion-portion communication hole 52-F of the first mounting hole 32-F illustrated in the sixth embodiment, the overlapping description is omitted.

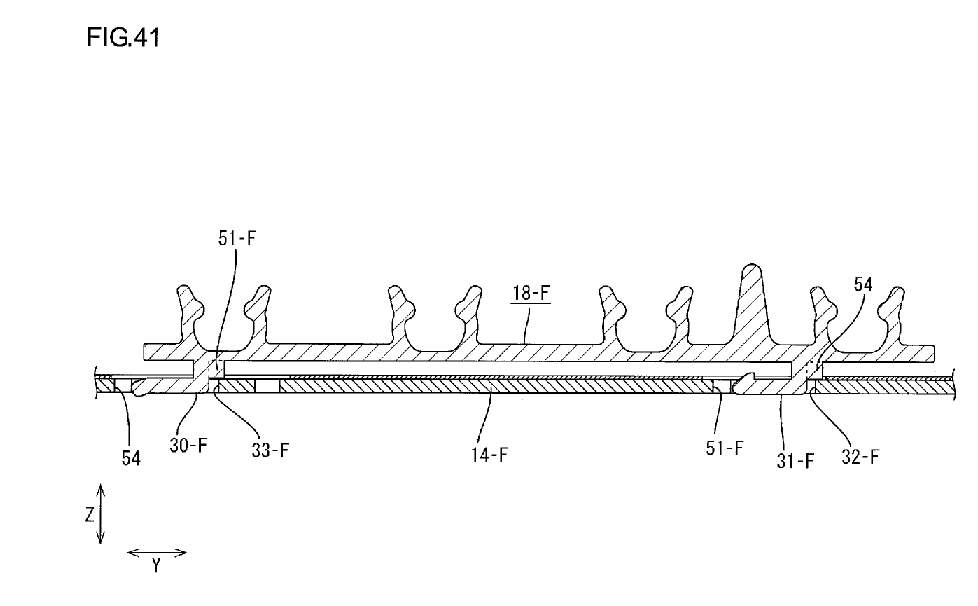

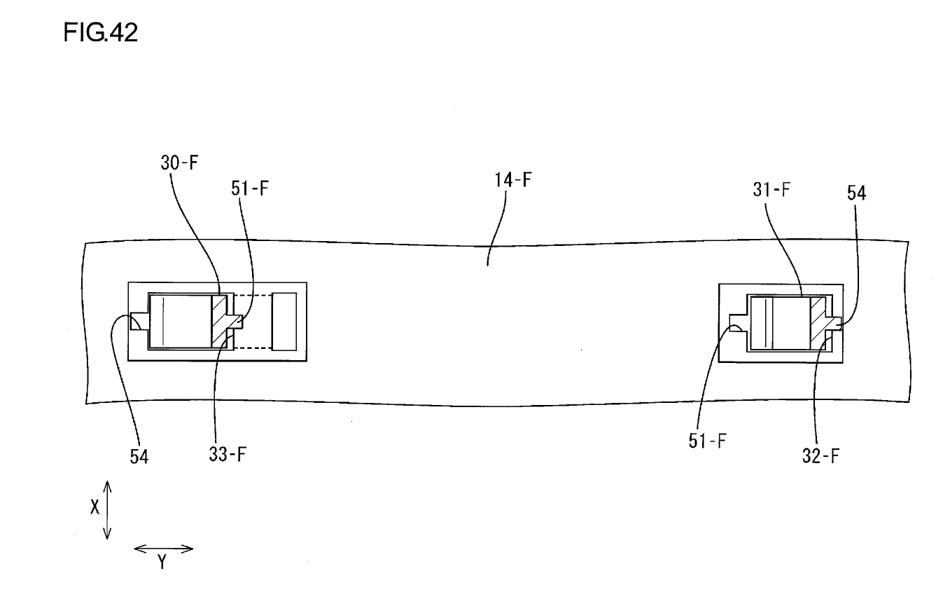

In mounting a lamp clip 18-F on the chassis 14-F, the lamp clip 18-F is set in the second state, the first mounting portion 30-F is aligned in the second mounting hole 33-F, and the second mounting portion 31-F is aligned in the first mounting hole 32-F. In such cases, the reinforcement portions 51-F and 53 do not fit in the corresponding reinforcement-portion insertion holes 52-F and 54. Accordingly, even if the lamp clip 18-F is pushed into the chassis 14-F, the reinforcement portion 51-F of the first mounting portion 30-F interferes in and runs over the portion of the peripheral edge portion of the second mounting hole 33-F that is opposite to the insertion-portion communication hole 54, and the reinforcement portion 53 of the second mounting portion 31-F interferes in and runs over the portion of the peripheral edge portion of the first mounting hole 32-F that is opposite to the insertion-portion communication hole 52-F, as illustrated in FIGS. 41 and 42. The operation to push the lamp clip 18-F is controlled by the reinforcement portions 51-F and 53 that are disposed at positions separated from each other in the slide direction. Therefore the lamp clip 18-F is restricted from being mounted in the orientation other than the predetermined orientation.

As described above, according to the present embodiment, the reinforcement portion 53 is also provided in the second mounting portion 31-F in addition to the first mounting portion 30-F, so that the reinforcement can be achieved for the second mounting portion 31-F and thus the breakage of the second mounting portion 31-F is reduced. Additionally, the reinforcement-portion insertion hole 54 is provided in the chassis 14-F. The reinforcement-portion insertion hole 54 permits the reinforcement portion 53 to be inserted therein, only when the lamp clip 18-F is in the specific state. This configuration makes it possible to more securely control the mounting of the lamp clip 18-F in the state different from the specific state.

### Eighth Embodiment

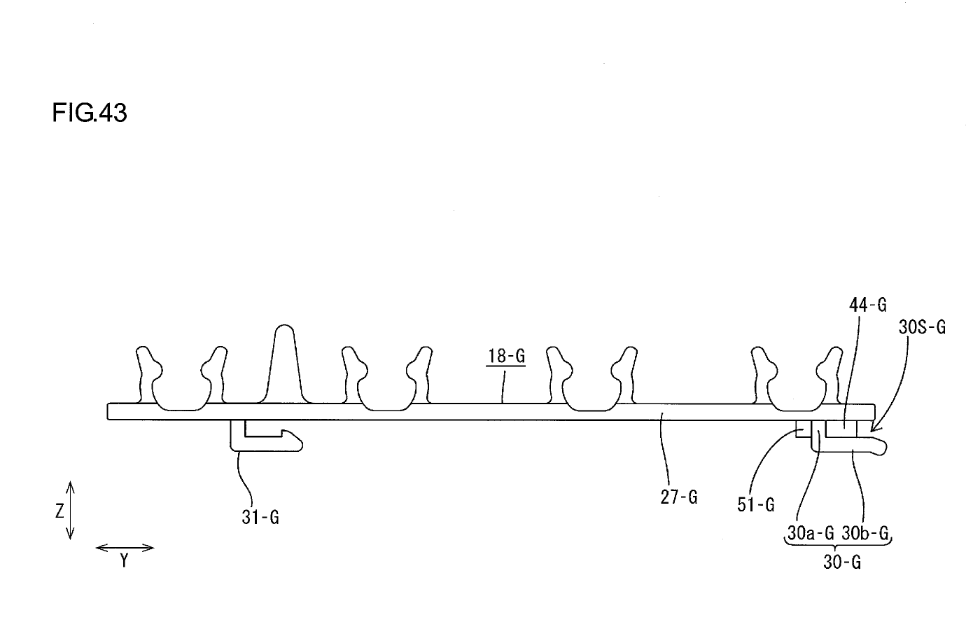

An eighth embodiment of the present invention will be described with reference to FIGS. 43 to 51. The eighth embodiment includes a reinforcement portion 44-G similar to that of the first embodiment and a reinforcement portion 51-G similar to that of the sixth embodiment. In the eighth embodiment, the parts having the same name as the first and sixth embodiments are indicated by the same symbols, a suffix “-G” is added to the ending of the symbols. The same structure, function and effect will not be described.

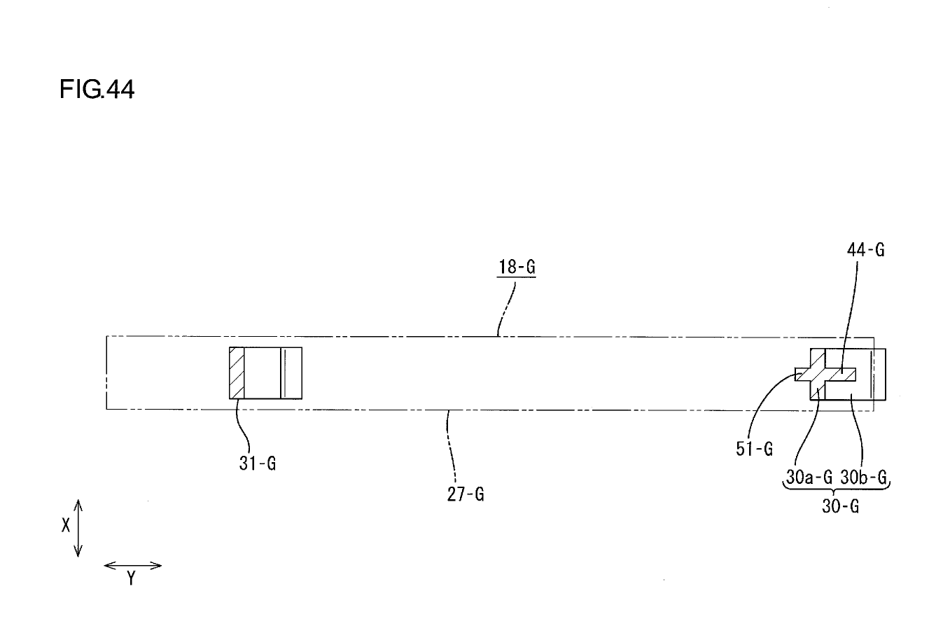

In a first mounting portion 30-G, as illustrated in FIGS. 43 and 44, the first reinforcement portion 44-G that continues to a main body 27-G, a base portion 30a-G, and a extending portion 30b-G is provided in a space 30S-G surrounded by the main body 27-G, the base portion 30a-G, and the extending portion 30b-G. Because the first reinforcement portion 44-G has the configuration similar to that of the reinforcement portion 44 illustrated in the first embodiment, the overlapping description is omitted. On the other hand, in the first mounting portion 30-G, a second reinforcement portion 51-G that does not continue to the extending portion 30b-G but continues to the base portion 30a-G and the main body 27-G is provided out of the space 30S-G surrounded by the main body 27-G, the base portion 30a-G, and the extending portion 30b-G. Because the second reinforcement portion 51-G has the configuration similar to that of the reinforcement portion 51 illustrated in the sixth embodiment, the overlapping description is omitted. The first reinforcement portion 44-G and the second reinforcement portion 51-G are disposed within the range where the first mounting portion 30-G is formed in the X-axis direction that is of the direction perpendicular to the slide direction with respect to a chassis 14-G and along the main body 27-G. Additionally, the first reinforcement portion 44-G and the second reinforcement portion 51-G are disposed at the positions sandwiching the base portion 30a-G therebetween, and are linearly disposed in the Y-axis direction that is of the slide direction.

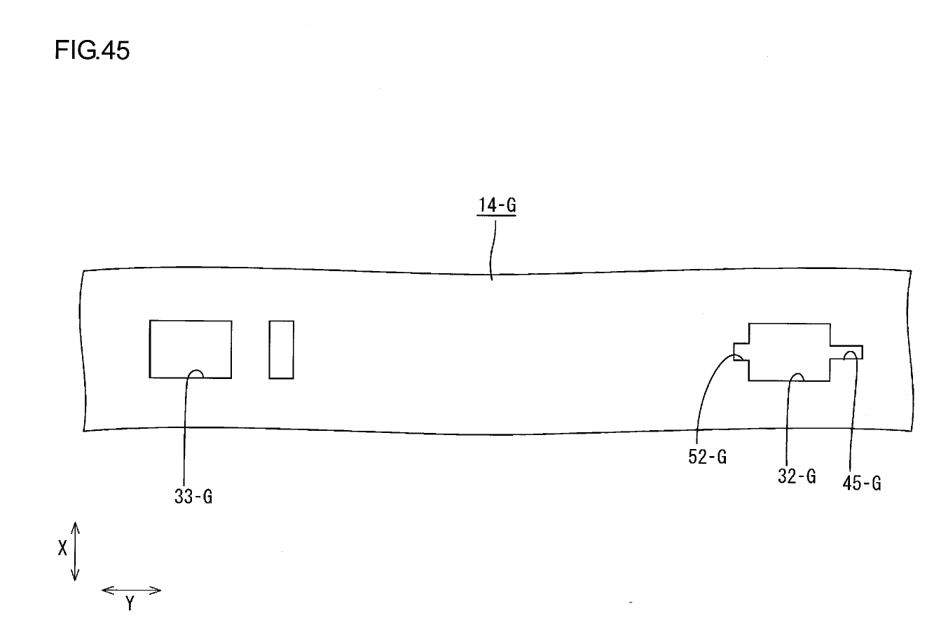

On the other hand, as illustrated in FIG. 45, a positioning hole 45-G in which the first reinforcement portion 44-G is inserted is provided in the portion (front-side portion in the slide direction associated with the mounting), of a peripheral edge portion of a first mounting hole 32-G in the chassis 14-G, that is retained while sandwiching between the extending portion 30b-G and the main body 27-G in the state in which the lamp clip 18-G is mounted, and the positioning hole 45-G is opened to the first mounting hole 32-G. Because the positioning hole 45-G has the configuration similar to that of the positioning hole 45 illustrated in the first embodiment, the overlapping description is omitted. On the other hand, a reinforcement-portion insertion hole 52-G in which the second reinforcement portion 51-G is inserted is provided in the portion (rear-side portion in the slide direction associated with the mounting) of a peripheral edge portion of a first mounting hole 32-G opposite to the portion that is retained while sandwiching between the extending portion 30b-G and the main body 27-G in the state in which the lamp clip 18-G is mounted, and the reinforcement-portion insertion hole 52-G is opened to the first mounting hole 32-G. Because the reinforcement-portion insertion hole 52-G has the configuration similar to that of the reinforcement-portion insertion hole 52 illustrated in the sixth embodiment, the overlapping description is omitted.

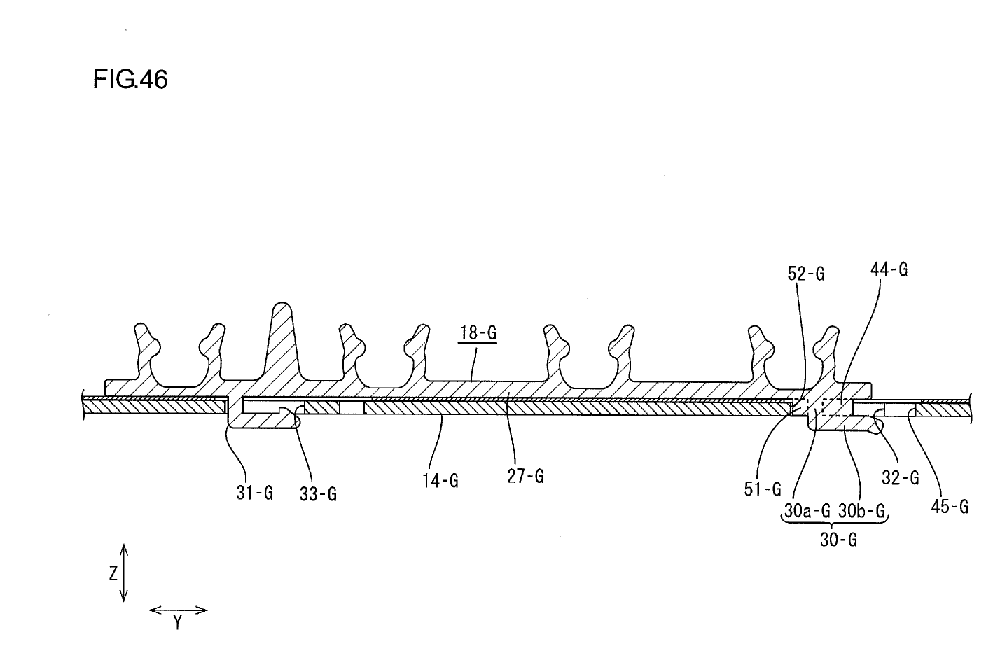

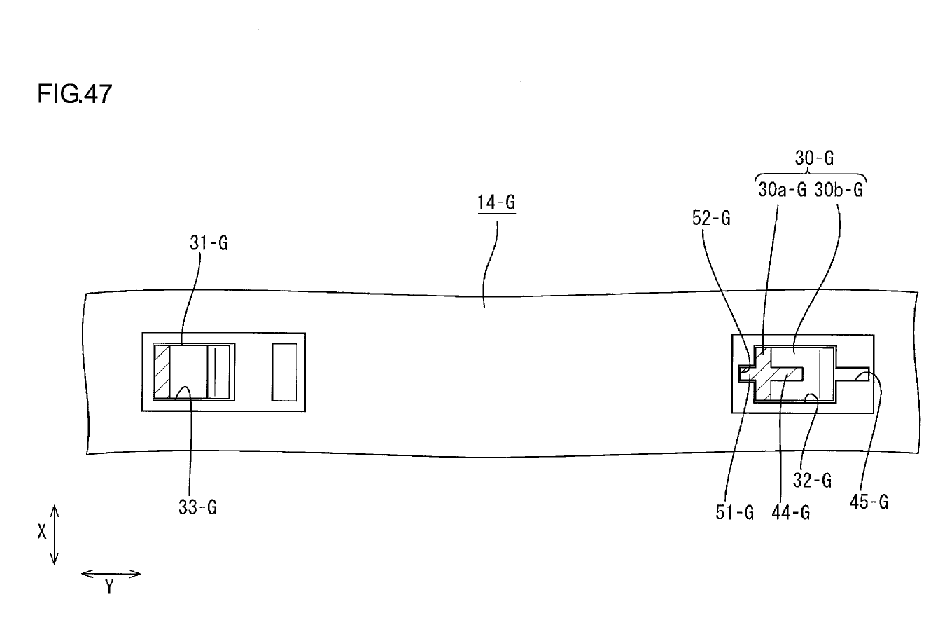

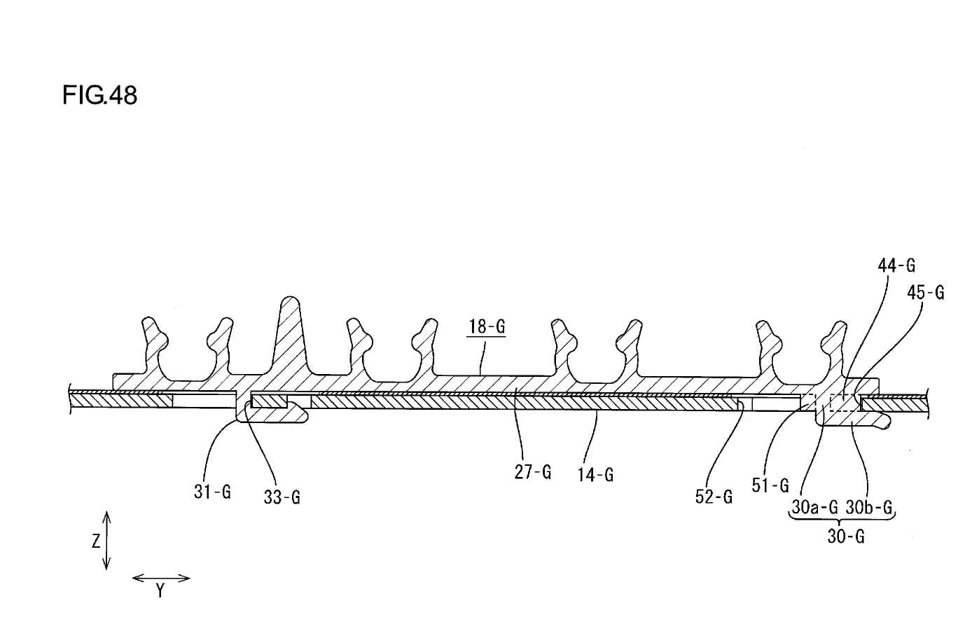

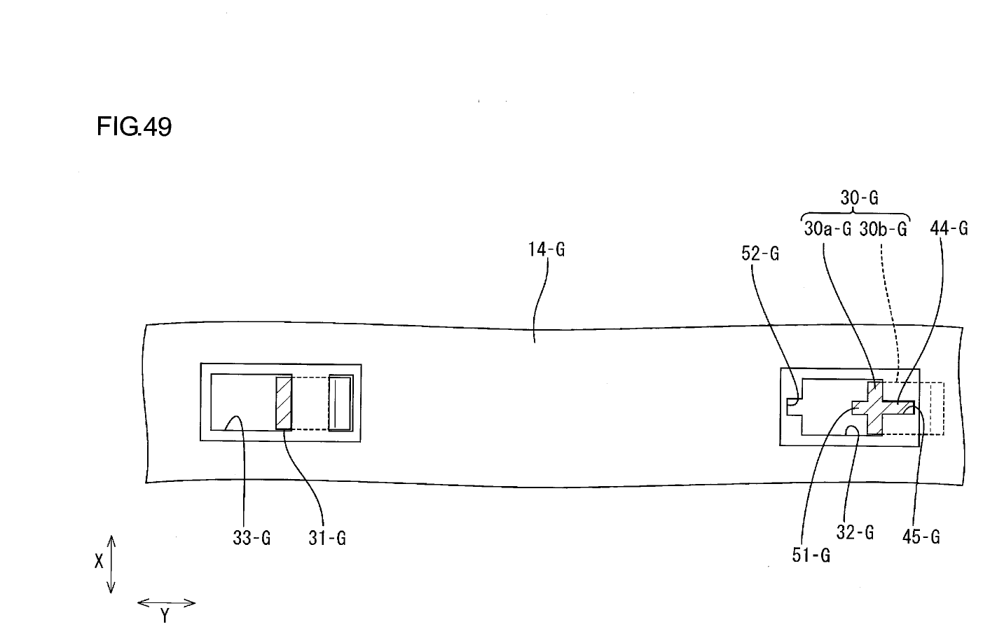

In mounting the lamp clip 18-G on the chassis 14-G, the lamp clip 18-G is set in the first state, the first mounting portion 30-G is aligned in the first mounting hole 32-G, and the second mounting portion 31-G is aligned in the second mounting hole 33-G. In such cases, the mounting portions 30-G and 31-G are inserted in the corresponding mounting holes 32-G and 33-G, and the second reinforcement portion 51-G is inserted in the reinforcement-portion insertion hole 52-G as illustrated in FIGS. 46 and 47. When the lamp clip 18-G is slid, the first reinforcement portion 44-G is inserted in the positioning hole 45-G to position the lamp clip 18-G in the direction intersecting the slide direction as illustrated in FIGS. 48 and 49. Even if the first mounting portion 30-G interferes in the chassis 14-G and the like through the process, the first mounting portion 30-G is reinforced by the reinforcement portions 44-G and 51-G that are linearly disposed along the slide direction. This effectively reduces the breakage of the first mounting portion 30-G.

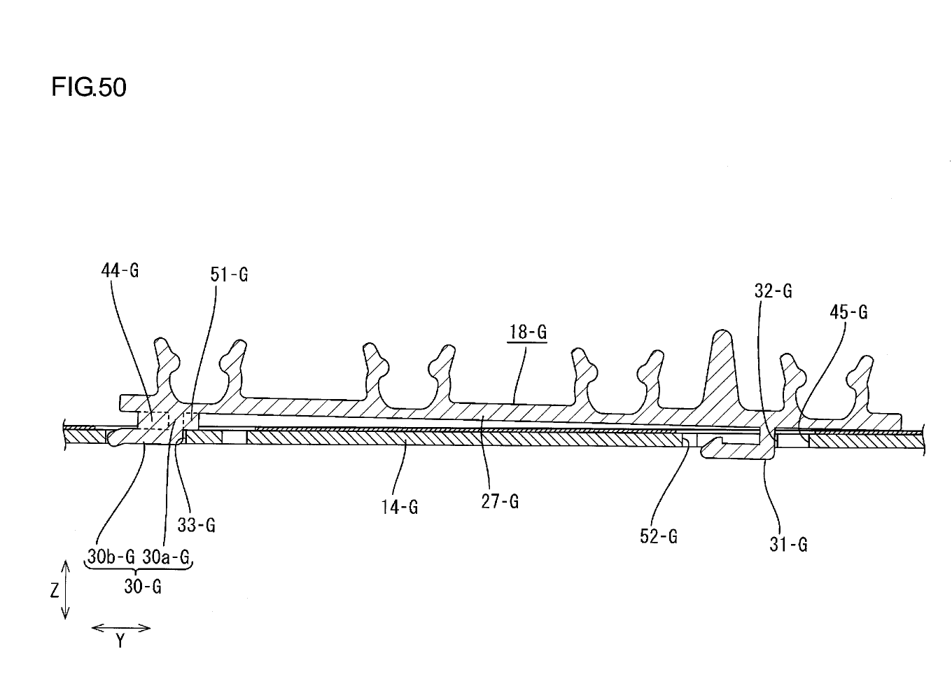

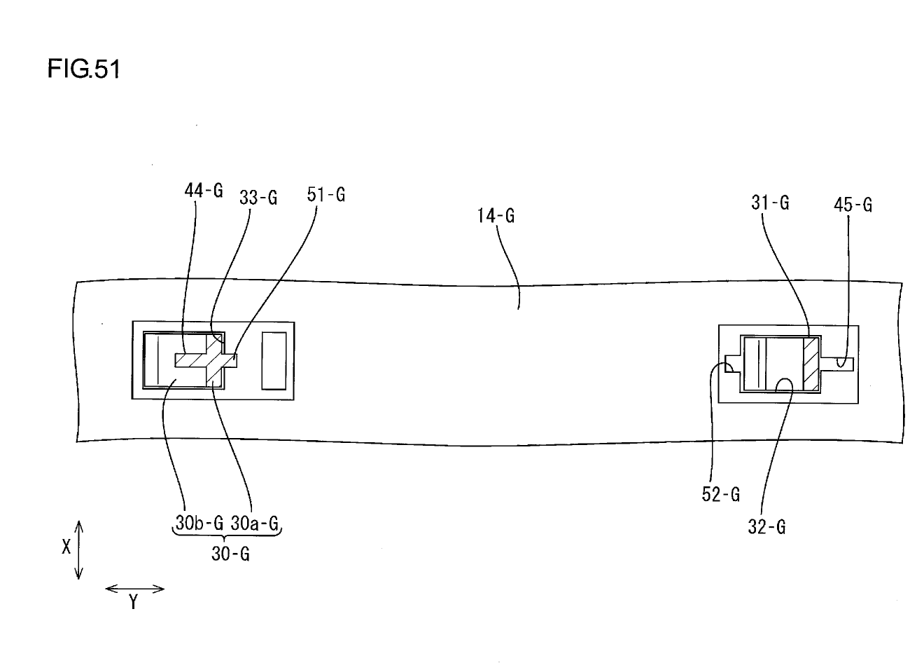

On the other hand, in mounting the lamp clip 18-G on the chassis 14-G, the lamp clip 18-G is set in the second state, the first mounting portion 30-G is aligned in the second mounting hole 33-G, and the second mounting portion 31-G is aligned in the first mounting hole 32-G. In such cases, as illustrated in FIGS. 50 and 51, the second reinforcement portion 51-G does not fit in the reinforcement-portion insertion hole 52-G, and the second reinforcement portion 51-G interferes in and runs over the peripheral edge portion of the second mounting hole 33-G. Therefore, the operation to push the lamp clip 18-G is controlled to avoid the situation in which the lamp clip 18-G is mounted in the state different from the predetermined state.

As described above, according to the present embodiment, the reinforcement portions 44-G and 51-G are disposed within the range where the first mounting portion 30-G is formed in the direction perpendicular to the slide direction with respect to the chassis 14-G and along the main body 27-G. Therefore, when a force acts on the first mounting portion 30-G according to the slide operation, the force can directly be received by the reinforcement portions 44-G and 51-G, so that the breakage of the first mounting portion 30-G is further effectively reduced. Additionally, because the reinforcement portions 44-G and 51-G are not projected out of the range where the first mounting portion 30-G is formed in the direction perpendicular to the slide direction and along the main body 27-G, this configuration is suitable to simplify the structure.

A pair of the reinforcement portions 44-G and 51-G is linearly disposed along the slide direction at the positions sandwiching the base portion 30a-G. Therefore, when the force acts on the first mounting portion 30-G according to the slide operation, the force can be received by a pair of the reinforcement portions 44-G and 51-G that is linearly disposed along the slide direction. Consequently, the breakage of the first mounting portion 30-G is further effectively reduced.

The reinforcement portions 44-G and 51-G are disposed in the center of the direction perpendicular to the slide direction and along the main body 27-G. Therefore, the force acting on the first mounting portion 30-G can be received in the balanced manner by the reinforcement portions 44-G and 51-G, and thus, the breakage of the first mounting portion 30-G is further effectively reduced.

### ANOTHER EMBODIMENT

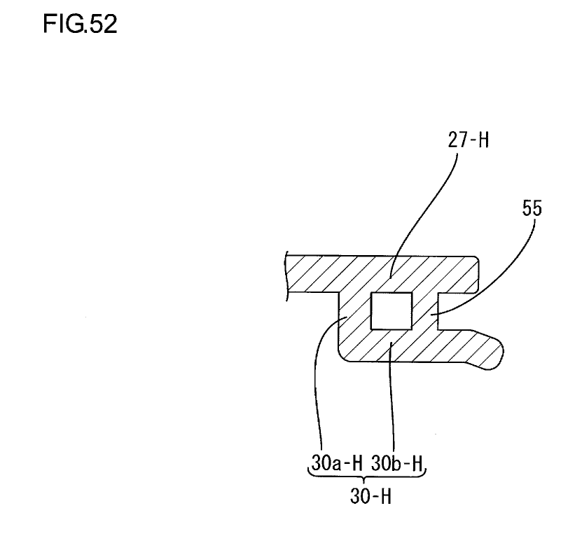

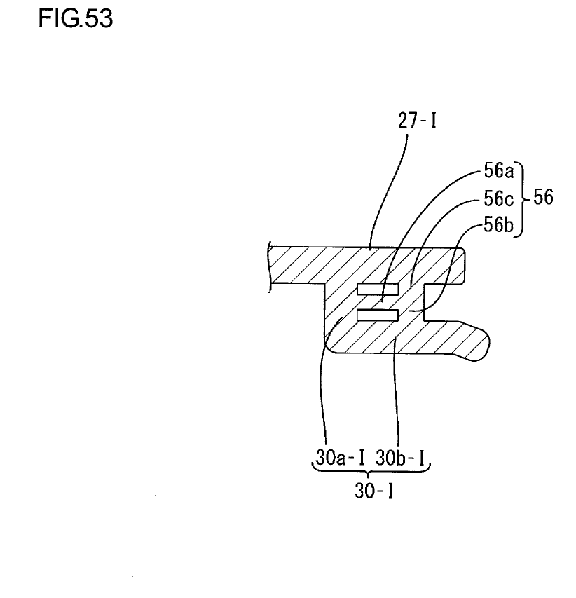

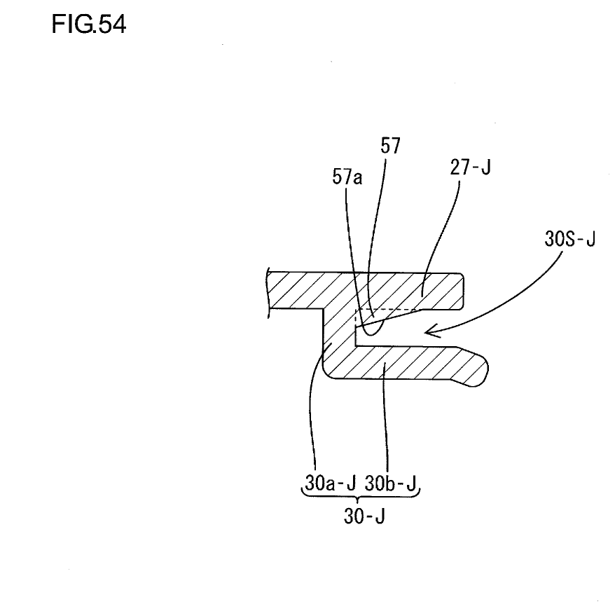

The present invention is not limited to the embodiment explained by the description and drawings, but, for example, the following embodiments are also included in the technical scope of the invention.
(1) In the first, third to sixth, and eighth embodiments, the reinforcement portion is provided in the first mounting portion, and the positioning hole and the reinforcement-portion insertion hole are provided in the peripheral edge portion of the first mounting hole corresponding to the reinforcement portion. The invention also includes the following configuration. That is, the reinforcement portion having the structure similar to that of the first, third to sixth, and eighth embodiments is provided in the second mounting portion, and the positioning hole and reinforcement-portion insertion hole, which have the structure similar to that of first, third to sixth, and eighth embodiments, are provided in the peripheral edge portion of the second mounting hole corresponding to the reinforcement portion. In that case, it is possible to form in the same structure the reinforcement portion (the positioning hole and reinforcement-portion insertion hole, which are provided in the peripheral edge portion of the first mounting hole) provided in the first mounting portion and the reinforcement portion (the positioning hole and reinforcement-portion insertion hole, which are provided in the peripheral edge portion of the second mounting hole) provided in the second mounting portion. Further, it is not always necessary to form in the same structure the reinforcement portion (the positioning hole and reinforcement-portion insertion hole, which are provided in the peripheral edge portion of the first mounting hole) provided in the first mounting portion and the reinforcement portion (the positioning hole and reinforcement-portion insertion hole, which are provided in the peripheral edge portion of the second mounting hole) provided in the second mounting portion, but the reinforcement portions having different structures may be provided.
(2) In addition to the embodiments described above, the structure of the reinforcement portion can appropriately be changed. Specific examples (3) to (11) will be described below.
(3) As illustrated in FIG. 52, a reinforcement portion 55 does not continue to an extending portion 30b-H constituting a first mounting portion 30-H, but continue to a base portion 30a-H and a main body 27-H. At this point, a positioning hole in which the reinforcement portion 55 is inserted during the mounting may be provided in the peripheral edge portion of the first mounting hole in the chassis (not illustrated). The similar reinforcement portion can be provided in the second mounting portion (not illustrated).
(4) Although, as illustrated in FIG. 53, a reinforcement portion 56 continues to a base portion 30a-I and a extending portion 30b-I of a first mounting portion 30-I and a main body 27-I, cuts may be generated among the regions 27-I, 30a-I, and 30b-I. That is, in the structure of the reinforcement portion 56, a portion 56a that continues to the base portion 30a-I, a portion 56b that continues to the extending portion 30b-I, and a portion 56c that continues to the main body 27-I are branched from one another, and gaps are provided among the regions 56a, 56b, and 56c. This structure is also included in the invention. At this point, a positioning hole in which the reinforcement portion 56 is inserted during the mounting may be provided in the peripheral edge portion of the first mounting hole in the chassis (not illustrated). The similar reinforcement portion can be provided in the second mounting portion (not illustrated).
(5) As illustrated in FIG. 54, in a modification of the fifth embodiment, a reinforcement portion 57 is disposed in a space 30S-J between a main body 27-J and a base portion 30a-J and a extending portion 30b-J of a first mounting portion 30-J, and the reinforcement portion 57 does not continue to the extending portion 30b-J but may continue to the base portion 30a-J and main body 27-J. A surface of the reinforcement portion 57 opposite to the extending portion 30b-J is formed by an inclined surface 57a, and a gap between the inclined surface 57a and the extending portion 30b-J decreases continuously and gradually toward the side of the base portion 30a-J. Even in this configuration, the peripheral edge portion of the first mounting hole in the chassis bites into the reinforcement portion 57 during the mounting the lamp clip (not illustrated) on the chassis (not illustrated), which allows the retaining force to be improved. The similar reinforcement portion can be provided in the second mounting portion (not illustrated).
(6) In the third embodiment described above, the side surface of the reinforcement portion is formed in the inclined surface. The invention may also encompass the side surface of the reinforcement portion, which is formed in the curved surface.
(7) In the fourth embodiment described above, the circumferential surface of the reinforcement portion is formed by the arc-curved surface. Alternatively, the circumferential surface of the reinforcement portion may be formed by the curved surface having other shapes such as an ellipsoidal shape and a waveform shape. The circumferential surface of the reinforcement portion may be formed by the inclined surface instead of the curved surface.
(8) In the fifth embodiment or the example (5) described above, the surface that is opposite to the main body or the projection in the reinforcement portion is formed by the inclined surface. The invention may also encompass the surface formed by the curved surface.
(9) In the eighth embodiment described above, the first reinforcement portion and the second reinforcement portion are linearly disposed along the slide direction at the positions sandwiching the base portion. The invention may also encompass a configuration, in which the first reinforcement portion and the second reinforcement portion are disposed at positions deviated from each other in the direction perpendicular to the slide direction with respect to the chassis and along the main body.
(10) In the embodiments described above, the reinforcement portion is disposed in the center of the mounting portion in the direction perpendicular to the slide direction with respect to the chassis and along the main body. The invention may also encompass the reinforcement portion disposed at the position deviated from the center of the mounting portion.
(11) In the embodiments described above, the reinforcement portion is disposed within the range where the mounting portion is formed in the direction perpendicular to the slide direction with respect to the chassis and along the main body. The invention may also encompass a configuration, in which the reinforcement portion is disposed out of the range where the mounting portion is formed in the direction perpendicular to the slide direction with respect to the chassis and along the main body. At this point, the mounting portion is disposed out of the space surrounded by the main body, the base portion, and the extending portion.
(12) Except the embodiments described above, the numbers of mounting portions and mounting holes can appropriately be changed. A configuration, in which only one or at least three mounting portions and only one or at least three mounting holes are provided, is also included in the invention.
(13) In the embodiments described above, the angle formed between the base portion of the mounting portion and the main body is the substantially right angle. Alternatively, the angle can arbitrarily be changed except the right angle.
(14) In the embodiments described above, the angle between the base portion and the extending portion, which constitute the mounting portion, is the substantially right angle. Alternatively, the angle can arbitrarily be changed except the right angle.
(15) In the embodiments described above, the extending portion constituting the mounting portion is formed in the cantilever shape. For example, the configuration having the extending portion that is formed in the flange shape spread from the base portion is also included in the invention. The shape of the mounting hole may also be changed so as to permit the passage of the extending portion.
(16) In the embodiments described above, the slide direction (movement direction) in detachably mounting the lamp clip is aligned with the long-side direction of the rectangular main body. The invention may also encompass a configuration in which the slide direction of the lamp clip is aligned with the short-side direction of the main body. Additionally, the invention may also encompass a configuration in which the slide direction of the lamp clip is set to the direction (oblique direction) intersecting the long-side direction and short-side direction of the main body.
(17) In the embodiments described above, the main body is formed in the rectangular shape. However, the shape of the main body can appropriately be changed. Specifically, the invention may also encompass the main body that is formed in a square shape when viewed from above, and the main body that is formed in a circular shape, an ellipsoidal shape, or polygonal shape except the quadrangular shape when viewed from above.
(18) In the embodiments described above, the cold-cathode tube is used as the light source. The invention may also encompass a configuration in which another kind of light source such as a hot-cathode tube is used.
(19) In the embodiments, the chassis is made of the sheet metal. Alternatively the chassis may be formed by resin molding.
(20) In the embodiments described above, the TFT is used as the switching element of the liquid crystal display device. Additionally, the invention can be applied to a liquid crystal display device in which a switching element (such as Thin Film Diode (TFD)) except the TFT is used, and can also be applied to a monochrome liquid crystal display device in addition to the color liquid crystal display device.
(21) In the embodiments described above, the liquid crystal display device in which the liquid crystal panel is used is illustrated as the display panel. The invention can also be applied to a display device in which another kind of display panel is used.
(22) In the embodiments described above, the television receiver including the tuner is illustrated. The invention can also be applied to a display device that does not include the tuner.

1. A lamp holder comprising:
a main body to be mounted to a mounting member;
a lamp gripping portion provided in the main body so as to grip a lamp; and
a mounting portion including a base portion that projects from the main body toward a side corresponding to a mounting member side and an extending portion that extends from the base portion in a direction along the main body, the mounting portion being configured to be inserted in the mounting hole provided in the mounting member such that an edge portion of the mounting hole is sandwiched between the extending portion and the main body when the lamp holder is slid in a direction along the main body; and
a reinforcement portion that continues to at least two of the main body, the base portion, and the extending portion.

2. The lamp holder according to claim 1, wherein the reinforcement portion continues to the main body and at least one of the base portion and the extending portion.

3. The lamp holder according to of claim 1, wherein the reinforcement portion continues to at least two portions of the main body, the base portion, and the extending portion, the at least two portions being connected to each other.

4. The lamp holder according to of claim 2, wherein the reinforcement portion continues to at least the base portion and the main body.

5. The lamp holder according to claim 3, wherein the reinforcement portion continues to at least the base portion and the extending portion.

6. The lamp holder according to claim 1, wherein the reinforcement portion continues to the main body, the base portion and the extending portion.

7. The lamp holder according to claim 3, wherein the reinforcement portion continues to target regions in a seamless manner.

8. The lamp holder according to claim 1, wherein the extending portion has a cantilever shape.

9. The lamp holder according to claim 8, wherein the reinforcement portion continues to at least the extending portion.

10. The lamp holder according to claim 1, wherein the extending portion extends outward from an outer end of the main body.

11. The lamp holder according to claim 1, wherein the reinforcement portion is disposed within a range where the mounting portion is formed in a direction perpendicular to a slide direction with respect to the mounting member and along the main body.

12. The lamp holder according to claim 11, wherein a pair of the reinforcement portions is linearly disposed along the slide direction at positions sandwiching the base portion.

13. The lamp holder according to claim 11, wherein the reinforcement portion is disposed in a center of the lamp holder in the direction perpendicular to the slide direction and along the main body.

14. The lamp holder according to claim 11, wherein the reinforcement portion is provided in a space surrounded by the main body, the base portion and the extending portion.

15. The lamp holder according to claim 11, wherein the reinforcement portion is provided outside a space defined by the main body, the base portion and the extending portion.

16. The lamp holder according to claim 1, wherein:
the reinforcement portion continues to the base portion and at least one of the main body and the extending portion; and
the reinforcement portion has a dimension in the direction perpendicular to a slide direction with respect to the mounting member and along the main body, the dimension increasing continuously and gradually toward the base portion side.

17. The lamp holder according to claim 1, wherein:
the reinforcement portion continues to at least the main body and the extending portion; and
the reinforcement portion has a rib jutting from a side surface and continues to the main body and the extending portion.

18. The lamp holder according to claim 1, wherein:
a pair of the mounting portions is provided on the main body, the pair including a first mounting portion and a second mounting portion; and
the extending portion of the first mounting portion has a guide portion, the guide portion projecting outward from the outer end of the main body with a gap increasing gradually toward a distal end between the guide portion and the main body;
the extending portion of the second mounting portion has a latching projection projecting toward the main body and to be held to a wall of a latching hole provided in the mounting member; and
the reinforcement portion continues to at least the first mounting portion.

19. An illuminating device comprising:
the lamp holder according to claim 1;
a lamp gripped by the lamp gripping portion; and
a mounting member having a mounting hole in which the mounting portion is inserted.

20. The illuminating device according to claim 19, wherein:
the edge portion of the mounting hole provided in an area of the mounting member sandwiched between the extending portion and the main body has a positioning hole continuing to the mounting hole; and
the reinforcement portion is inserted in the positioning hole as the lamp holder is mounted to the mounting member.

21. The illuminating device according to claim 20, wherein the reinforcement portion is formed such that a dimension in a direction perpendicular to a slide direction in which the lamp holder is slid on the mounting member and along the main body is larger than a width of the positioning hole that measures at a point where the positioning hole connects to the mounting hole.

22. The illuminating device according to claim 21, wherein the reinforcement portion is formed such that a dimension in the direction perpendicular to the slide direction and along the main body increases continuously and gradually toward the base portion side.

23. The illuminating device according to claim 21, wherein:
the edge portion of the mounting hole provided in an area of the mounting member sandwiched between the extending portion and the main body has a latching hole that continues to the positioning hole and separated from the mounting hole; and
the reinforcement portion includes a latching portion that is inserted in the latching hole as the lamp holder is mounted to the mounting member and held to a wall of the latching hole.

24. The illuminating device according to claim 19, wherein:
the reinforcement portion continues from the base portion to one of the main body and the extending portion, abuts on the edge portion of the mounting hole in the mounting member when the lamp holder is mounted and is formed such that a gap between the reinforcement portion and the other of the main body and the extending portion is smaller than a thickness of the mounting member.

25. The illuminating device according to claim 24, wherein the reinforcement portion is formed such that the distance between the reinforcement portion and the other of the main body and the extending portion decreases continuously and gradually toward the base portion side.

26. The illuminating device according to claim 19, wherein:
the reinforcement portion is provided outside a space defined by the main body, the base portion and the extending portion; and
the mounting member has a reinforcement-portion insertion hole in which the reinforcement portion fits when the lamp holder is placed in a predetermined orientation with respect to the mounting member but not fit when the lamp holder is placed in an orientation other than the predetermined orientation.

27. The illuminating device according to claim 19, wherein:
a pair of the mounting portions is provided in the main body portion;
the mounting portions constitute a first mounting portion and a second mounting portion;
a pair of the mounting holes is provided in the mounting member;
the mounting holes constitute a first mounting hole corresponding to the first mounting portion and a second mounting hole corresponding to the second mounting portion;
at least one of the mounting portions is reinforced with the reinforcement portion provided outside a space defined by the main body, the base portion and the extending portion; and
the mounting member has a reinforcement-portion insertion hole in which the reinforcement portion fits when the first mounting portion and the second mounting portion are aligned in the first mounting hole and the second mounting hole, respectively but not fit when the first mounting portion and the second mounting portion are aligned in the second mounting hole and the first mounting hole, respectively.

28. A display device comprising:
the illuminating device according to claim 19; and
a display panel that is disposed in front of the illuminating device.

29. The display device according to claim 28, wherein the display panel is a liquid crystal panel in which liquid crystal is sealed between a pair of substrates.

30. A television receiver comprising the display device according to claim 28.
